(19) United States
(12) Patent Application Publication
(10) Pub. No.: US 2024/0234853 A1
(43) Pub. Date: Jul. 11, 2024

(54) BATTERY COOLING SYSTEM

(71) Applicant: HONDA MOTOR CO., LTD., Tokyo (JP)

(72) Inventors: Daichi WATANABE, Saitama (JP); Yasuo YAMADA, Saitama (JP); Takahiro YASUE, Saitama (JP)

(73) Assignee: HONDA MOTOR CO., LTD., Tokyo (JP)

(21) Appl. No.: 18/400,829

(22) Filed: Dec. 29, 2023

(30) Foreign Application Priority Data
Jan. 6, 2023 (JP) 2023-001275

(51) Int. Cl. H01M 10/63; H01M 10/613; H01M 10/625; H01M 10/6556

(52) U.S. Cl. CPC H01M 10/63; H01M 10/613; H01M 10/625; H01M 10/6556; H01M 2220/20

(57) ABSTRACT

A battery cooling system includes a solid-state battery, a heat-exhausting device, a cooling circuit through which a refrigerant circulates between the solid-state battery and the heat-exhausting device, and a battery control device. The refrigerant absorbs heat from the solid-state battery. The heat-exhausting device exhausts heat absorbed from the solid-state battery. When a battery temperature of the solid-state battery exceeds an output limitation starting temperature, the battery control device controls an output current of the solid-state battery such that a heat generation amount of the solid-state battery, a heat absorption amount of the refrigerant from the solid-state battery, and a heat exhaust amount of the refrigerant in the heat-exhausting device are equal to each other, and controls the battery temperature such that the battery temperature is equal to or higher than the output limitation starting temperature, and is lower than an output permission upper-limit temperature of the solid-state battery.

### CROSS-REFERENCE TO RELATED APPLICATIONS

This application is based on and claims priority under 35 USC 119 from Japanese Patent Application No. 2023-001275 filed on Jan. 6, 2023, the entire content of which is incorporated herein by reference.

### TECHNICAL FIELD

The present disclosure relates to a battery cooling system for cooling a solid-state battery mounted on an electric vehicle or the like.

### BACKGROUND ART

In recent years, researches and developments have been conducted on a secondary battery which contributes to improvement in energy efficiency in order to allow more people to have access to affordable, reliable, sustainable and advanced energy. In recent years, in particular, researches and developments have been actively conducted on a solid-state battery capable of realizing high safety and high energy density.

Since the secondary battery has to be operated in a predetermined temperature range, a battery temperature control system for controlling a temperature of the secondary battery is known. For example, JP2012-252887A describes a battery temperature control system that maintains a temperature of a secondary battery near a target temperature by controlling a temperature control current supplied to a Peltier element. The battery temperature control system described in JP2012-252887A holds a map table in which a heat flow rate from an external environment of a secondary battery to the secondary battery is set corresponding to a differential temperature between a target temperature and an environmental temperature, determines the heat flow rate to the secondary battery by referring to the map table based on the differential temperature between the target temperature and the environmental temperature, and controls a temperature control current supplied to a Peltier element.

However, in a case of a solid-state battery, an output limitation starting temperature of the solid-state battery approaches an output permission upper-limit temperature of the solid-state battery such as a vehicle running-stop temperature according to an excessive temperature rise determination due to expansion of a service temperature range of the solid-state battery. Therefore, in the battery temperature control system described in JP2012-252887A, in a case where a temperature of the solid-state battery exceeds the output limitation starting temperature, there is a concern that the output permission upper-limit temperature may be reached. When the temperature of the solid-state battery reaches the output permission upper-limit temperature, it is necessary to strictly limit an output current of the solid-state battery. Therefore, in a case where the temperature of the solid-state battery exceeds the output limitation starting temperature, it is desirable to more strictly manage the temperature of the solid-state battery so as not to reach the output permission upper-limit temperature.

### SUMMARY OF INVENTION

The present disclosure provides a battery cooling system capable of maintaining an output of a solid-state battery while preventing a battery temperature of the solid-state battery from reaching an output permission upper-limit temperature, even in a case where the battery temperature of the solid-state battery exceeds an output limitation starting temperature. This further contributes to improvement in energy efficiency.

An aspect of the present disclosure relates to a battery cooling system including:
a solid-state battery;
a heat-exhausting device;
a cooling circuit through which a refrigerant circulates between the solid-state battery and the heat-exhausting device, and
a battery control device configured to control input-output power of the solid-state battery,
in which the refrigerant absorbs heat from the solid-state battery to cool the solid-state battery, and the heat-exhausting device exhausts heat absorbed from the solid-state battery, and
in a case where a battery temperature, which is a temperature of the solid-state battery, exceeds a predetermined output limitation starting temperature,
the battery control device
   controls an output current of the solid-state battery such that a heat generation amount of the solid-state battery, a heat absorption amount of the refrigerant from the solid-state battery, and a heat exhaust amount of the refrigerant in the heat-exhausting device are equal to each other, and
   controls the battery temperature such that the battery temperature is equal to or higher than the output limitation starting temperature, and is lower than a predetermined output permission upper-limit temperature which is an upper-limit temperature at which the solid-state battery is permitted to output power.

According to the present disclosure, even in a case where a battery temperature of a solid-state battery exceeds an output limitation starting temperature, the solid-state battery can be used while preventing the battery temperature of the solid-state battery from reaching an output permission upper-limit temperature.

### BRIEF DESCRIPTION OF DRAWINGS

Exemplary embodiment(s) of the present invention will be described in detail based on the following figures, wherein:

FIG. 1 is a block diagram showing a configuration of a battery cooling system according to a first embodiment of the present disclosure:

FIG. 2 is a flowchart (part 1) showing a first example of a control flow in a battery control device of the battery cooling system in FIG. 1;

FIG. 3 is a flowchart (part 2) showing the first example of the control flow in the battery control device of the battery cooling system in FIG. 1;

FIG. 4 is a flowchart (part 3) showing the first example of the control flow in the battery control device of the battery cooling system in FIG. 1;

FIG. 5 is a flowchart (part 4) showing the first example of the control flow in the battery control device of the battery cooling system in FIG. 1:

FIG. 6 is a flowchart (part 5) showing the first example of the control flow in the battery control device of the battery cooling system in FIG. 1;

FIG. 7 is a flowchart (part 6) showing the first example of the control flow in the battery control device of the battery cooling system in FIG. 1;

FIG. 8 is a diagram showing transition images of a battery temperature T_{BATT}, an output current I_{BATT}, a battery heat generation amount Q_{BATT}, a battery heat absorption amount Q_{A}, a heat-exhausting device heat exhaust amount Q_{EX} in a case where the battery temperature T_{BATT} exceeds a predetermined output limitation starting temperature T_{S} and the battery heat generation amount Q_{BATT}>the battery heat absorption amount Q_{A}>the heat-exhausting device heat exhaust amount Q_{EX} is satisfied when the control flows of FIGS. 2 to 4 are performed in the first example of the control flow in the battery control device of the battery cooling system in FIG. 1;

FIG. 9 is a diagram showing transition images of a battery temperature T_{BATT}, an output current I_{BATT}, a battery heat generation amount Q_{BATT}, a battery heat absorption amount Q_{A}, a heat-exhausting device heat exhaust amount Q_{EX} in a case where the battery temperature T_{BATT} falls below a first threshold temperature T₁ and the battery heat generation amount Q_{BATT}<the battery heat absorption amount Q_{A}<the heat-exhausting device heat exhaust amount Q_{EX} is satisfied when the control flows of FIGS. 5 to 7 are performed in the first example of the control flow in the battery control device of the battery cooling system in FIG. 1;

FIG. 10 is a flowchart (part 1) showing a second example of the control flow in the battery control device of the battery cooling system in FIG. 1;

FIG. 11 is a flowchart (part 2) showing the second example of the control flow in the battery control device of the battery cooling system in FIG. 1:

FIG. 12 is a block diagram showing a configuration of a battery cooling system according to a second embodiment of the present disclosure;

FIG. 13 is a flowchart (part 1) showing a first example of a control flow in a battery control device of the battery cooling system in FIG. 12:

FIG. 14 is a flowchart (part 2) showing the first example of the control flow in the battery control device of the battery cooling system in FIG. 12;

FIG. 15 is a flowchart (part 3) showing the first example of the control flow in the battery control device of the battery cooling system in FIG. 12;

FIG. 16 is a flowchart (part 4) showing the first example of the control flow in the battery control device of the battery cooling system in FIG. 12:

FIG. 17 is a flowchart (part 5) showing the first example of the control flow in the battery control device of the battery cooling system in FIG. 12;

FIG. 18 is a flowchart (part 6) showing the first example of the control flow in the battery control device of the battery cooling system in FIG. 12;

FIG. 19 is a flowchart (part 1) showing a second example of the control flow in the battery control device of the battery cooling system in FIG. 12; and

FIG. 20 is a flowchart (part 2) showing the second example of the control flow in the battery control device of the battery cooling system in FIG. 12.

### DESCRIPTION OF EMBODIMENTS

Hereinafter, embodiments of a battery cooling system of the present disclosure will be described with reference to the accompanying drawings. The drawings are viewed from directions of reference numerals.

### First Embodiment

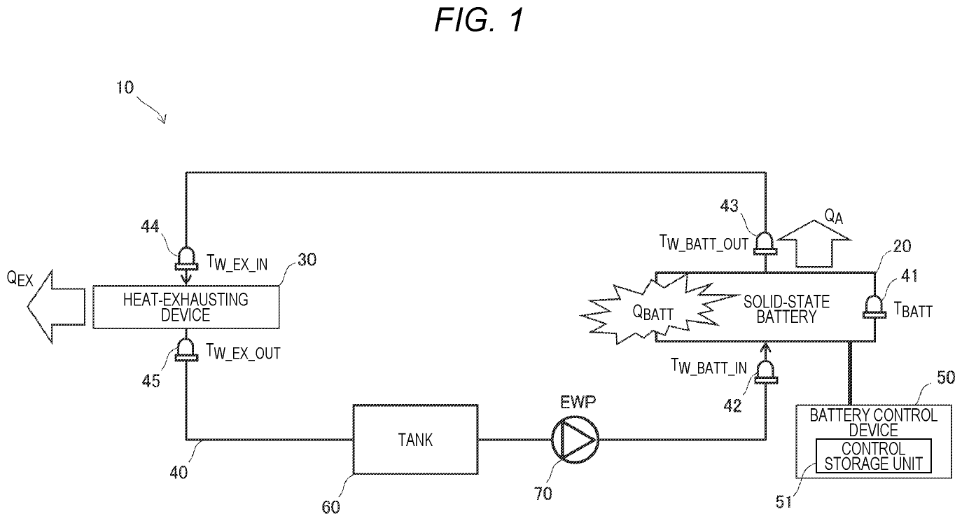

First, a battery cooling system according to a first embodiment of the present disclosure will be described with reference to FIGS. 1 to 11.

### <Configuration of Battery Cooling System>

As shown in FIG. 1, a battery cooling system 10 of the present embodiment is mounted on a vehicle. The battery cooling system 10 includes a solid-state battery 20, a heat-exhausting device 30, a cooling circuit 40 through which a refrigerant W circulates between the solid-state battery 20 and the heat-exhausting device 30, and a battery control device 50. The vehicle of the present embodiment is a vehicle that can be driven by electric power charged in the solid-state battery 20.

The cooling circuit 40 is a pipe formed such that the refrigerant W circulates between the solid-state battery 20 and the heat-exhausting device 30. In the present embodiment, the refrigerant W is cooling water.

The solid-state battery 20 is a secondary battery in which a solid material is used as at least a part of an electrolyte. The solid-state battery 20 is not limited to an all-solid-state battery using only a solid electrolyte in an electrolyte, and may be a semi-solid-state battery. The solid-state battery 20 may be, for example, a gel-polymer-type semi-solid-state battery in which an electrolytic solution is contained in a polymer gel, a clay-type semi-solid-state battery using a clay-like material in which an electrolytic solution is kneaded into a positive/negative electrode material, or a liquid-addition-type semi-solid-state battery in which a small amount of a liquid material having fluidity or a gel polymer having flexibility is added to a solid electrolyte.

The heat-exhausting device 30 is, for example, a heat exchanger such as a chiller or a radiator. The heat-exhausting device 30 exhausts heat of the refrigerant W introduced into the heat-exhausting device 30 via the cooling circuit 40 to the outside by heat exchange.

The battery control device 50 is a control device capable of controlling input-output power of the solid-state battery 20. The battery control device 50 includes a control storage unit 51 that stores various kinds of data.

The control storage unit 51 stores various kinds of information used when controlling the input-output power of the solid-state battery 20.

The battery cooling system 10 also includes a storage tank 60 that temporarily stores the refrigerant W, and a pressure pump 70 that pumps the refrigerant W. The pressure pump 70 is an electric water pump. The storage tank 60 and the pressure pump 70 are provided in the cooling circuit 40. In the cooling circuit 40, the storage tank 60 and the pressure pump 70 are both provided between the refrigerant W discharge side of the heat-exhausting device 30 and the refrigerant W introduction side of the solid-state battery 20. The storage tank 60 is provided on the refrigerant W discharge side of the heat-exhausting device 30, and the pressure pump 70 is provided on the refrigerant W introduction side of the solid-state battery 20.

Therefore, the refrigerant W circulating through the cooling circuit 40 is pumped from the pressure pump 70 and introduced into the solid-state battery 20, absorbs heat from the solid-state battery 20 to cool the solid-state battery 20, and then introduced into the heat-exhausting device 30. The refrigerant W is stored in the storage tank 60 after the heat-exhausting device 30 exhausts heat absorbed from the solid-state battery 20. The refrigerant W stored in the storage tank 60 is pumped again from the pressure pump 70.

In addition, the battery cooling system 10 includes a battery temperature sensor 41 that detects a battery temperature T_{BATT} [° C.] which is a temperature of the solid-state battery 20, a battery inlet refrigerant temperature sensor 42 that detects a battery inlet refrigerant temperature T_{W_BATT_IN} [° C.] which is a temperature of the refrigerant W introduced into the solid-state battery 20, a battery outlet refrigerant temperature sensor 43 that detects a battery outlet refrigerant temperature T_{W_BATT_OUT} which is a temperature of the refrigerant W discharged from the solid-state battery 20, a heat-exhausting device inlet refrigerant temperature sensor 44 that detects a heat-exhausting device inlet refrigerant temperature T_{W_EX_IN} which is a temperature of the refrigerant W introduced into the heat-exhausting device 30, and a heat-exhausting device outlet refrigerant temperature sensor 45 that detects a heat-exhausting device outlet refrigerant temperature T_{W_EX_OUT} which is the temperature of the refrigerant W discharged from the heat-exhausting device 30.

### <First Example of Control Flow in Battery Control Device>

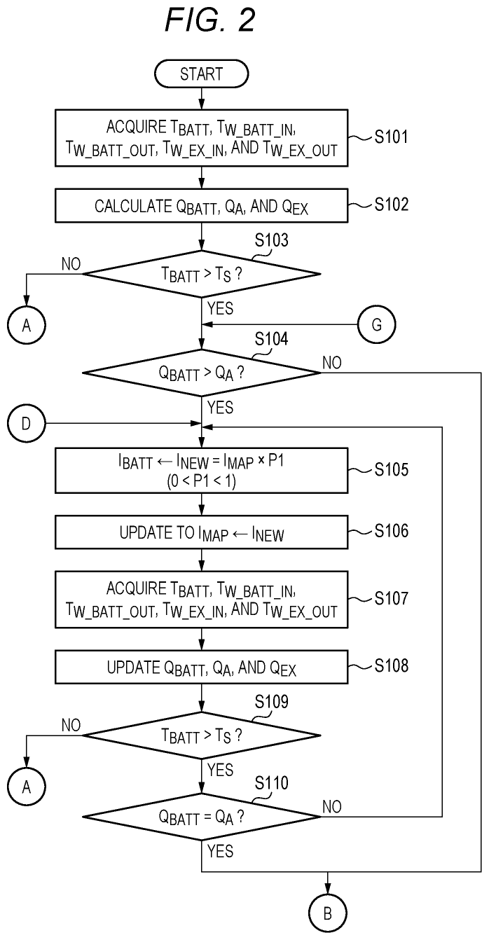

Next, a first example of a control flow of the input-output power of the solid-state battery 20 in the battery control device 50 will be described with reference to FIGS. 2 to 7.

As shown in FIG. 2, the battery control device 50 first acquires a battery temperature T_{BATT} [° C.], a battery inlet refrigerant temperature T_{W_BATT_IN} [° C.], a battery outlet refrigerant temperature T_{W_BATT_OUT} [° C.], a heat-exhausting device inlet refrigerant temperature T_{W_EX_IN} [° C.], and a heat-exhausting device outlet refrigerant temperature T_{W_EX_OUT} [° C.] (step S101). In the present embodiment, the battery temperature T_{BATT} [° C.], the battery inlet refrigerant temperature T_{W_BATT_IN} [° C.], the battery outlet refrigerant temperature T_{W_BATT_OUT} [° C.], the heat-exhausting device inlet refrigerant temperature T_{W_EX_IN} [° C.], and the heat-exhausting device outlet refrigerant temperature T_{W_EX_OUT} [° C.] are acquired by detection of the battery temperature sensor 41, the battery inlet refrigerant temperature sensor 42, the battery outlet refrigerant temperature sensor 43, the heat-exhausting device inlet refrigerant temperature sensor 44, and the heat-exhausting device outlet refrigerant temperature sensor 45.

Subsequently, the control proceeds to step S102, in which a battery heat generation amount Q_{BATT} [J] which is a heat generation amount of the solid-state battery 20, a battery heat absorption amount Q_{A} [J] which is a heat absorption amount of the refrigerant W from the solid-state battery 20, and a heat-exhausting device heat exhaust amount Q_{EX} [J] of the refrigerant W in the heat-exhausting device 30 are acquired by calculation.

The battery heat generation amount Q_{BATT} [J] is calculated using the following equation (1). In the equation (1), I_{BATT} [A] represents an actual output current value flowing through the solid-state battery 20, and R [Ω] represents a battery resistance value of the solid-state battery 20. The battery resistance value R is stored as a map in the control storage unit 51 of the battery control device 50.

$${Q}_{BATT} = {I}_{BATT}^{2} \times R \times Δ t \qquad ( 1 )$$

The battery heat absorption amount Q_{A} [J] is calculated based on the battery inlet refrigerant temperature T_{W_BATT_IN} [° C.], the battery outlet refrigerant temperature T_{W_BATT_OUT} [° C.], a mass flow rate qₘ [g/s] of the refrigerant W, and specific heat c_{L} [J/g·K] of the refrigerant W. Specifically, the battery heat absorption amount Q_{A} [J] is calculated using the following equation (2).

$${Q}_{A} = \{ {T}_{W\_BATT \_OUT} - {T}_{W\_BATT \_IN} ) \times {q}_{m} \times {c}_{L} \times Δ t \qquad ( 2 )$$

The mass flow rate qₘ [g/s] of the refrigerant W is calculated using the following equation (3). In the equation (3), q [L/s] represents a refrigerant flow rate of the refrigerant W. and ρ_{L} [g/L] represents a refrigerant density of the refrigerant W.

$${q}_{m} = q \times {ρ}_{L} \qquad ( 3 )$$

The heat-exhausting device heat exhaust amount Q_{EX} [J] is calculated based on the heat-exhausting device inlet refrigerant temperature T_{W_EX_IN} [° C.], the heat-exhausting device outlet refrigerant temperature T_{W_EX_OUT} [° C.], the mass flow rate qₘ [g/s] of the refrigerant W. and the specific heat cr. [J/g·K] of the refrigerant W. Specifically, the heat-exhausting device heat exhaust amount Q_{EX} [J] is calculated using the following equation (4).

$${Q}_{EX} = ( {T}_{W\_EX \_OUT} - {T}_{W\_EX \_IN} ) \times {q}_{m} \times {c}_{L} \times Δ t \qquad ( 4 )$$

The mass flow rate qₘ [g/s] of the refrigerant W is calculated using the above-described equation (3).

As described above, the battery heat absorption amount Q_{A} is calculated based on the battery inlet refrigerant temperature T_{W_BATT_IN}, the battery outlet refrigerant temperature T_{W_BATT_OUT}, the mass flow rate qₘ of the refrigerant W, and the specific heat c_{L} of the refrigerant W. The heat-exhausting device heat exhaust amount Q_{EX} is calculated based on the heat-exhausting device inlet refrigerant temperature T_{W_EX_IN}, the heat-exhausting device outlet refrigerant temperature T_{W_EX_OUT}, the mass flow rate qₘ of the refrigerant W. and the specific heat c_{L} of the refrigerant W.

Accordingly, by detecting the temperature of the refrigerant W at each position in the cooling circuit 40, the battery heat absorption amount Q_{A} and the heat-exhausting device heat exhaust amount Q_{EX} can be accurately acquired by calculation with a simple method.

Subsequently, the control proceeds to step S103, in which it is determined whether the battery temperature T_{BATT} acquired in step S101 exceeds a preset output limitation starting temperature T_{S} [° C.]. If the battery temperature T_{BATT} exceeds the output limitation starting temperature T_{S} (step S103: YES), the control proceeds to step S104. If the battery temperature T_{BATT} does not exceed the output limitation starting temperature T_{S}, that is, the battery temperature T_{BATT} is equal to or lower than the output limitation starting temperature T_{S} (step S103: NO), the control proceeds to step S400 to be described later.

In step S104, it is determined whether the battery heat generation amount Q_{BATT} calculated in step S102 is larger than the battery heat absorption amount Q_{A}. If the battery heat generation amount Q_{BATT} is larger than the battery heat absorption amount Q_{A} (step S104: YES), the control proceeds to step S105. If the battery heat generation amount Q_{BATT} is not larger than the battery heat absorption amount Q_{A}, that is, the battery heat generation amount Q_{BATT} is equal to or smaller than the battery heat absorption amount Q_{A} (step S104: NO), the control proceeds to step S201.

In step S105, a new permitted current value I_{NEW} [A] is calculated based on a permitted current value I_{MAP} [A] that has been permitted for the solid-state battery 20 in the related art, and an output current I_{BATT} [A] of the solid-state battery 20 is controlled to become the new permitted current value I_{NEW} [A]. The new permitted current value I_{NEW} [A] is calculated using the following equation (5).

$${I}_{NEW} = {I}_{MAP} \times P 1 \qquad ( 5 )$$

Note that P1 is a predetermined value that satisfies 0<P1<1.

Subsequently, the control proceeds to step S106, in which the permitted current value I_{MAP} is updated to the new permitted current value I_{NEW} calculated in step S105 and stored in the control storage unit 51.

Subsequently, the control proceeds to step S107, in which the battery temperature T_{BATT}, the battery inlet refrigerant temperature T_{W_BATT_IN}, the battery outlet refrigerant temperature T_{W_BATT_OUT}, the heat-exhausting device inlet refrigerant temperature T_{W_EX_IN}, and the heat-exhausting device outlet refrigerant temperature T_{W_EX_OUT} are acquired again.

Subsequently, the control proceeds to step S108, in which based on the battery temperature T_{BATT}, the battery inlet refrigerant temperature T_{W_BATT_IN}, the battery outlet refrigerant temperature T_{W_BATT_OUT}, the heat-exhausting device inlet refrigerant temperature T_{W_EX_IN}, and the heat-exhausting device outlet refrigerant temperature T_{W_EX_OUT}, which are acquired in step S107, the battery heat generation amount Q_{BATT}, the battery heat absorption amount Q_{A}, and the heat-exhausting device heat exhaust amount Q_{EX} are acquired by calculation, and the battery heat generation amount Q_{BATT}, the battery heat absorption amount Q_{A}, and the heat-exhausting device heat exhaust amount Q_{EX} are updated and stored in the control storage unit 51.

Subsequently, the control proceeds to step S109, in which it is determined whether the battery temperature T_{BATT} acquired in step S107 exceeds the preset output limitation starting temperature T_{S}. If the battery temperature T_{BATT} exceeds the output limitation starting temperature T_{S} (step S109: YES), the control proceeds to step S110. If the battery temperature T_{BATT} does not exceed the output limitation starting temperature T_{S}, that is, the battery temperature T_{BATT} is equal to or lower than the output limitation starting temperature T_{S} (step S109: NO), the control proceeds to step S400 to be described later.

In step S110, it is determined whether the battery heat generation amount Q_{BATT} calculated in step S108 is equal to the battery heat absorption amount Q_{A}. If the battery heat generation amount Q_{BATT} calculated in step S108 is not equal to the battery heat absorption amount Q_{A} (step S110: NO), the control returns to step S105 to repeat steps S105 to S110. If the battery heat generation amount Q_{BATT} calculated in step S108 is equal to the battery heat absorption amount Q_{A} (step S110: YES), the control proceeds to step S201.

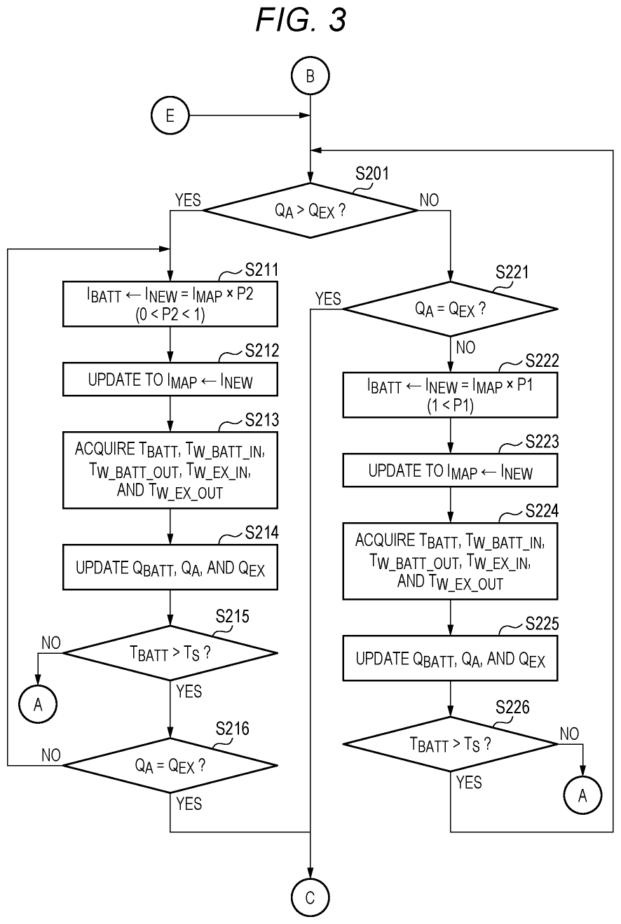

As shown in FIG. 3, in step S201, it is determined whether the battery heat absorption amount Q_{A} is larger than the heat-exhausting device heat exhaust amount Q_{EX} based on the latest battery heat generation amount Q_{BATT}, the latest battery heat absorption amount Q_{A}, and the latest heat-exhausting device heat exhaust amount Q_{EX} acquired by calculation in step S102 or step S108. If the battery heat absorption amount Q_{A} is larger than the heat-exhausting device heat exhaust amount Q_{EX} (step S201: YES), the control proceeds to step S211. If the battery heat absorption amount Q_{A} is not larger than the heat-exhausting device heat exhaust amount Q_{EX}, that is, the battery heat absorption amount Q_{A} is equal to or smaller than the heat-exhausting device heat exhaust amount Q_{EX} (step S201: NO), the control proceeds to step S221.

In step S211, a new permitted current value I_{NEW} is calculated based on a permitted current value I_{MAP} that has been permitted for the solid-state battery 20 in the related art, and an output current I_{BATT} of the solid-state battery 20 is controlled to become the new permitted current value I_{NEW}. The new permitted current value I_{NEW} is calculated using the following equation (6).

$${I}_{NEW} = {I}_{MAP} \times P 2 \qquad ( 6 )$$

Note that P2 is a predetermined value that satisfies 0<P2<1.

Subsequently, the control proceeds to step S212, in which the permitted current value I_{MAP} is updated to the NEW permitted current value I_{new} calculated in step S211 and stored in the control storage unit 51.

Subsequently, the control proceeds to step S213, in which the battery temperature T_{BATT}, the battery inlet refrigerant temperature T_{W_BATT_IN}, the battery outlet refrigerant temperature T_{W_BATT_OUT}, the heat-exhausting device inlet refrigerant temperature T_{W_EX_IN}, and the heat-exhausting device outlet refrigerant temperature T_{W_EX_OUT} are acquired again.

Subsequently, the control proceeds to step S214, in which based on the battery temperature T_{BATT}, the battery inlet refrigerant temperature T_{W_BATT_IN}, the battery outlet refrigerant temperature T_{W_BATT_OUT}, the heat-exhausting device inlet refrigerant temperature T_{W_EX_IN}, and the heat-exhausting device outlet refrigerant temperature T_{W_EX_OUT}, which are acquired in step S213, the battery heat generation amount Q_{BATT}, the battery heat absorption amount Q_{A}, and the heat-exhausting device heat exhaust amount Q_{EX} are acquired by calculation, and the battery heat generation amount Q_{BATT}, the battery heat absorption amount Q_{A}, and the heat-exhausting device heat exhaust amount Q_{EX} are updated and stored in the control storage unit 51.

Subsequently, the control proceeds to step S215, in which it is determined whether the battery temperature T_{BATT} acquired in step S213 exceeds the output limitation starting temperature T_{S}. If the battery temperature T_{BATT} exceeds the output limitation starting temperature T_{S} (step S215: YES), the control proceeds to step S216. If the battery temperature T_{BATT} does not exceed the output limitation starting temperature T_{S}, that is, the battery temperature T_{BATT} is equal to or lower than the output limitation starting temperature T_{S} (step S215: NO), the control proceeds to step S400 to be described later.

In step S216, it is determined whether the battery heat absorption amount Q_{A} calculated in step S214 is equal to the heat-exhausting device heat exhaust amount Q_{EX}. If the battery heat absorption amount Q_{A} is not equal to the heat-exhausting device heat exhaust amount Q_{EX} (step S216: NO), the control returns to step S211 to repeat steps S211 to S216. If the battery heat absorption amount Q_{A} calculated in step S214 is equal to the heat-exhausting device heat exhaust amount Q_{EX} (step S216: YES), the control proceeds to step S301.

On the other hand, in step S221, it is determined whether the battery heat absorption amount Q_{A} is equal to the heat-exhausting device heat exhaust amount Q_{EX} based on the latest battery heat generation amount Q_{BATT}, the latest battery heat absorption amount Q_{A}, and the latest heat-exhausting device heat exhaust amount Q_{EX} acquired by calculation in step S102 or step S108. If the battery heat absorption amount Q_{A} is equal to the heat-exhausting device heat exhaust amount Q_{EX} (step S221: YES), the control proceeds to step S301, and if the battery heat absorption amount Q_{A} is not equal to the heat-exhausting device heat exhaust amount Q_{EX} (step S221: NO), the control proceeds to step S222. In a case where it is determined in step S221 that the battery heat absorption amount Q_{A} is not equal to the heat-exhausting device heat exhaust amount Q_{EX} (step S221: NO), the following conditions are satisfied that the battery heat absorption amount Q_{A} is equal to or smaller than the heat-exhausting device heat exhaust amount Q_{EX} (step S201: NO), and the battery heat absorption amount Q_{A} is not equal to the heat-exhausting device heat exhaust amount Q_{EX} (step S221: NO). Therefore, the battery heat absorption amount Q_{A} is smaller than the heat-exhausting device heat exhaust amount Q_{EX}.

In step S222, a new permitted current value I_{NEW} is calculated based on a permitted current value I_{MAP} that has been permitted for the solid-state battery 20 in the related art, and an output current I_{BATT} of the solid-state battery 20 is controlled to become the new permitted current value I_{NEW}. The new permitted current value I_{NEW} is calculated using the following equation (7).

$${I}_{NEW} = {I}_{MAP} \times P 1 \qquad ( 7 )$$

Note that P1 is a predetermined value that satisfies 1<P1.

Subsequently, the control proceeds to step S223, in which the permitted current value I_{MAP} is updated to the new permitted current value I_{NEW} calculated in step S222 and stored in the control storage unit 51.

Subsequently, the control proceeds to step S224, in which the battery temperature T_{BATT}, the battery inlet refrigerant temperature T_{W_BATT_IN}, the battery outlet refrigerant temperature T_{W_BATT_OUT}, the heat-exhausting device inlet refrigerant temperature T_{W_EX_IN}, and the heat-exhausting device outlet refrigerant temperature T_{W_EX_OUT} are acquired again.

Subsequently, the control proceeds to step S225, in which based on the battery temperature T_{BATT}, the battery inlet refrigerant temperature T_{W_BATT_IN}, the battery outlet refrigerant temperature T_{W_BATT_OUT}, the heat-exhausting device inlet refrigerant temperature T_{W_EX_IN}, and the heat-exhausting device outlet refrigerant temperature T_{W_EX_OUT}, which are acquired in step S224, the battery heat generation amount Q_{BATT}, the battery heat absorption amount Q_{A}, and the heat-exhausting device heat exhaust amount Q_{EX} are acquired by calculation, and the battery heat generation amount Q_{BATT}, the battery heat absorption amount Q_{A}, and the heat-exhausting device heat exhaust amount Q_{EX} are updated and stored in the control storage unit 51.

Subsequently, the control proceeds to step S226, in which it is determined whether the battery temperature T_{BATT} acquired in step S224 exceeds the output limitation starting temperature T_{S}. If the battery temperature T_{BATT} exceeds the output limitation starting temperature T_{S} (step S226: YES), the control returns to step S201, and the processing of step S201 and the subsequent steps is repeated until the battery heat absorption amount Q_{A} becomes equal to the heat-exhausting device heat exhaust amount Q_{EX}. In step S226, if the battery temperature T_{BATT} does not exceed the output limitation starting temperature T_{S}, that is, the battery temperature T_{BATT} is equal to or lower than the output limitation starting temperature T_{S} (step S226: NO), the control proceeds to step S400 to be described later.

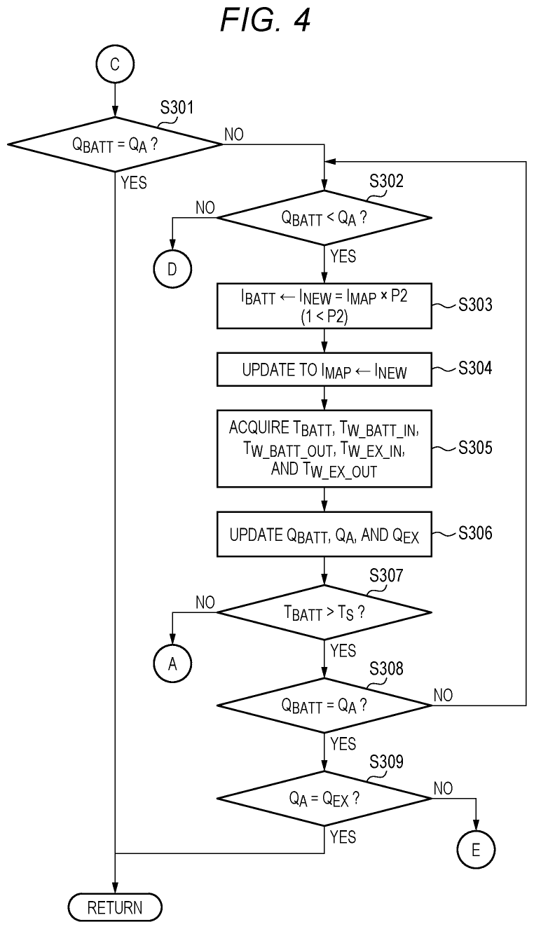

As shown in FIG. 4, in step S301, it is determined whether the battery heat generation amount Q_{BATT} is equal to the battery heat absorption amount Q_{A} based on the latest battery heat generation amount Q_{BATT}, the latest battery heat absorption amount Q_{A}, and the latest heat-exhausting device heat exhaust amount Q_{EX}, which are stored in the control storage unit 51 and acquired by calculation in any of step S102, S108, S214, and S225.

In step S301, if the battery heat generation amount Q_{BATT} is equal to the battery heat absorption amount Q_{A} (step S301: YES), a series of controls ends. The control returns to the start, and the battery control device 50 repeats the series of controls.

In a case where the battery heat generation amount Q_{BATT} is equal to the battery heat absorption amount Q_{A} in step S301 (step S301: YES), with respect to the latest battery heat generation amount Q_{BATT}, the latest battery heat absorption amount Q_{A}, and the latest heat-exhausting device heat exhaust amount Q_{EX}, which are stored in the control storage unit 51 and acquired by calculation in any of step S102, S108, S214, and S225, the following conditions are satisfied that the battery heat absorption amount Q_{A} is equal to the heat-exhausting device heat exhaust amount Q_{EX} (step S216: YES, step S221: YES), and the battery heat generation amount Q_{BATT} is equal to the battery heat absorption amount Q_{A} (step S301: YES). Therefore, the battery heat generation amount Q_{BATT}, the battery heat absorption amount Q_{A}, and the heat-exhausting device heat exhaust amount Q_{EX} are equal to each other.

On the other hand, in step S301, if the battery heat generation amount Q_{BATT} is not equal to the battery heat absorption amount Q_{A} (step S301: NO), the control proceeds to step S302.

In step S302, it is determined whether the battery heat generation amount Q_{BATT} is smaller than the battery heat absorption amount Q_{A} based on the latest battery heat generation amount Q_{BATT}, the latest battery heat absorption amount Q_{A}, and the latest heat-exhausting device heat exhaust amount Q_{EX}, which are stored in the control storage unit 51 and acquired by calculation in any of step S102, S108, S214, and S225. If the battery heat generation amount Q_{BATT} is smaller than the battery heat absorption amount Q_{A} (step S302: YES), the control proceeds to step S303, and if the battery heat generation amount Q_{BATT} is not smaller than the battery heat absorption amount Q_{A} (step S302: NO), the control returns to step S105. In a case where it is determined in step S302 that the battery heat generation amount Q_{BATT} is not smaller than the battery heat absorption amount Q_{A} (step S302: NO), the following conditions are satisfied that the battery heat generation amount Q_{BATT} is not equal to the battery heat absorption amount Q_{A} (step S301: NO) and the battery heat generation amount Q_{BATT} is not smaller than the battery heat absorption amount Q_{A} (step S302: NO). Therefore, the battery heat generation amount Q_{BATT} is larger than the battery heat absorption amount Q_{A}.

In step S303, a new permitted current value I_{NEW} is calculated based on a permitted current value I_{MAP} that has been permitted for the solid-state battery 20 in the related art, and an output current I_{BATT} of the solid-state battery 20 is controlled to become the new permitted current value I_{NEW}. The new permitted current value I_{NEW} is calculated using the following equation (8).

$${I}_{NEW} = {I}_{MAP} \times P 2 \qquad ( 8 )$$

Note that P2 is a predetermined value that satisfies 1<P2.

Subsequently, the control proceeds to step S304, in which the permitted current value I_{MAP} is updated to the new permitted current value I_{NEW} calculated in step S303 and stored in the control storage unit 51.

Subsequently, the control proceeds to step S305, in which the battery temperature T_{BATT}, the battery inlet refrigerant temperature T_{W_BATT_IN}, the battery outlet refrigerant temperature T_{W_BATT_OUT}, the heat-exhausting device inlet refrigerant temperature T_{W_EX_IN}, and the heat-exhausting device outlet refrigerant temperature T_{W_EX_OUT} are acquired again.

Subsequently, the control proceeds to step S306, in which based on the battery temperature T_{BATT}, the battery inlet refrigerant temperature T_{W_BATT_IN}, the battery outlet refrigerant temperature T_{W_BATT_OUT}, the heat-exhausting device inlet refrigerant temperature T_{W_EX_IN}, and the heat-exhausting device outlet refrigerant temperature T_{W_EX_OUT}, which are acquired in step S305, the battery heat generation amount Q_{BATT}, the battery heat absorption amount Q_{A}, and the heat-exhausting device heat exhaust amount Q_{EX} are acquired by calculation, and the battery heat generation amount Q_{BATT}, the battery heat absorption amount Q_{A}, and the heat-exhausting device heat exhaust amount Q_{EX} are updated and stored in the control storage unit 51.

Subsequently, the control proceeds to step S307, in which it is determined whether the battery temperature T_{BATT} acquired in step S305 exceeds the output limitation starting temperature T_{S}. If the battery temperature T_{BATT} exceeds the output limitation starting temperature T_{S} (step S307: YES), the control proceeds to step S308. If the battery temperature T_{BATT} does not exceed the output limitation starting temperature T_{S}, that is, the battery temperature T_{BATT} is equal to or lower than the output limitation starting temperature T_{S} (step S307: NO), the control proceeds to step S400 to be described later.

In step S308, it is determined whether the battery heat generation amount Q_{BATT} calculated in step S306 is equal to the battery heat absorption amount Q_{A}. If the battery heat generation amount Q_{BATT} is not equal to the battery heat absorption amount Q_{A} (step S308: NO), the control returns to step S302 to repeat steps S302 to S308. If the battery heat generation amount Q_{BATT} calculated in step S306 is equal to the battery heat absorption amount Q_{A} (step S308: YES), the control proceeds to step S309.

In step S309, it is determined whether the battery heat absorption amount Q_{A} calculated in step S306 is equal to the heat-exhausting device heat exhaust amount Q_{EX}. If the battery heat absorption amount Q_{A} is not equal to the heat-exhausting device heat exhaust amount Q_{EX} (step S309: NO), the control returns to step S201.

In step S309, when the battery heat absorption amount Q_{A} is equal to the heat-exhausting device heat exhaust amount Q_{EX} (step S309: YES), the series of controls ends. The control returns to the start, and the battery control device 50 repeats the series of controls.

In a case where the battery heat absorption amount Q_{A} is equal to the heat-exhausting device heat exhaust amount Q_{EX} (step S309: YES) in step S309, with respect to the battery heat generation amount Q_{BATT}, the battery heat absorption amount Q_{A}, and the heat-exhausting device heat exhaust amount Q_{EX} calculated in step S306, the following conditions are satisfied that the battery heat generation amount Q_{BATT} is equal to the battery heat absorption amount Q_{A} (step S308: YES), and the battery heat absorption amount Q_{A} is equal to the heat-exhausting device heat exhaust amount Q_{EX} (step S309: YES). Therefore, the battery heat generation amount Q_{BATT}, the battery heat absorption amount Q_{A}, and the heat-exhausting device heat exhaust amount Q_{EX} are equal to each other.

As described above, in the series of controls, when the battery temperature T_{BATT} exceeds the predetermined output limitation starting temperature T_{S}, the battery control device 50 controls the output current I_{BATT} of the solid-state battery 20 such that the battery heat generation amount Q_{BATT}, the battery heat absorption amount Q_{A}, and the heat-exhausting device heat exhaust amount Q_{EX} become equal to each other.

When the battery heat generation amount Q_{BATT}, the battery heat absorption amount Q_{A}, and the heat-exhausting device heat exhaust amount Q_{EX} become equal to each other, the battery temperature T_{BATT} is kept constant without increasing or decreasing. In this way, the battery control device 50 controls the battery temperature T_{BATT} to be equal to or higher than the output limitation starting temperature T_{S} and lower than a predetermined output permission upper-limit temperature T_{LIM} [° C.] which is an upper-limit temperature at which the solid-state battery 20 is permitted to output power. An output permission upper-limit temperature T_{LIM} is set in advance according to battery characteristics of the solid-state battery 20, and is stored in the control storage unit 51.

Accordingly, even in a case where the battery temperature T_{BATT} of the solid-state battery 20 exceeds the output limitation starting temperature T_{S}, the solid-state battery 20 can be used while the battery temperature T_{BATT} of the solid-state battery 20 is prevented from reaching the output permission upper-limit temperature T_{LIM}. Therefore, it is possible to prevent the output from the solid-state battery 20 from being suddenly limited, and to maintain stable output from the solid-state battery 20.

In the series of controls described above, in a case where the battery heat generation amount Q_{BATT} is larger than the battery heat absorption amount Q_{A} when the battery temperature T_{BATT} of the solid-state battery 20 is equal to or higher than the output limitation starting temperature T_{S}, the output current I_{BATT} of the solid-state battery 20 is limited to the new permitted current value I_{NEW}. Thereafter, the battery heat generation amount Q_{BATT}, the battery heat absorption amount Q_{A}, and the heat-exhausting device heat exhaust amount Q_{EX} are updated, and based on the updated battery heat generation amount Q_{BATT}, the updated battery heat absorption amount Q_{A}, and the updated heat-exhausting device heat exhaust amount Q_{EX}, the output current I_{BATT} and the permitted current value I_{MAP} of the solid-state battery 20 are subjected to feedback control such that the battery heat generation amount Q_{BATT}, the battery heat absorption amount Q_{A}, and the heat-exhausting device heat exhaust amount Q_{EX} become equal to each other.

Accordingly, the output current I_{BATT} of the solid-state battery 20 can be subjected to feedback control in accordance with the battery heat generation amount Q_{BATT}, the battery heat absorption amount Q_{A}, and the heat-exhausting device heat exhaust amount Q_{EX} in an actual use environment. Therefore, in the actual use environment, the output current I_{BATT} of the solid-state battery 20 can be controlled such that the battery heat generation amount Q_{BATT}, the battery heat absorption amount Q_{A}, and the heat-exhausting device heat exhaust amount Q_{EX} become equal to each other, and the battery temperature T_{BATT} can be kept constant.

On the other hand, as described above, in step S103, S109, S215, S226, and S307, if the battery temperature T_{BATT} does not exceed the output limitation starting temperature T_{S} [° C.], that is, the battery temperature T_{BATT} is equal to or lower than the output limitation starting temperature T_{S} [° C.], the control proceeds to step S400.

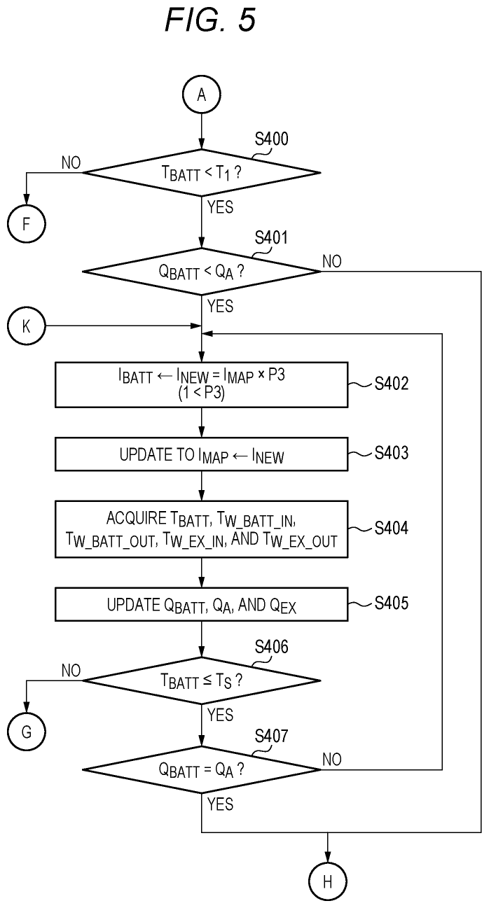

As shown in FIG. 5, in step S400, it is determined whether the battery temperature T_{BATT} is lower than a predetermined first threshold temperature T₁ [° C.]. The predetermined first threshold temperature T₁ is set to a temperature lower than the output limitation starting temperature T_{S}, and is stored in the control storage unit 51 in advance. If the battery temperature T_{BATT} is lower than the first threshold temperature T₁ (step S400: YES), the control proceeds to step S401. If the battery temperature T_{BATT} is not lower than the first threshold temperature T₁, that is, the battery temperature T_{BATT} is equal to or higher than the first threshold temperature T₁ (step S400: NO), the series of controls ends. The control returns to the start, and the battery control device 50 repeats the series of controls.

In step S401, it is determined whether the battery heat generation amount Q_{BATT} stored in the control storage unit 51 is smaller than the battery heat absorption amount Q_{A}. If the battery heat generation amount Q_{BATT} is smaller than the battery heat absorption amount Q_{A} (step S401: YES), the control proceeds to step S402. If the battery heat generation amount Q_{BATT} is not smaller than the battery heat absorption amount Q_{A}, that is, the battery heat generation amount Q_{BATT} is equal to or larger than the battery heat absorption amount Q_{A} (step S401: NO), the control proceeds to step S501.

In step S402, a new permitted current value I_{NEW} is calculated based on a permitted current value I_{NEW} that has been permitted for the solid-state battery 20 in the related art, and an output current I_{BATT} of the solid-state battery 20 is controlled to become the new permitted current value I_{NEW}. The new permitted current value I_{NEW} is calculated using the following equation (9).

$${I}_{NEW} = {I}_{MAP} \times P 3 \qquad ( 9 )$$

Note that P3 is a predetermined value that satisfies 1<P3.

Subsequently, the control proceeds to step S403, in which the permitted current value I_{MAP} is updated to the new permitted current value I_{NEW} calculated in step S402 and stored in the control storage unit 51.

Subsequently, the control proceeds to step S404, in which the battery temperature T_{BATT}, the battery inlet refrigerant temperature T_{W_BATT_IN}, the battery outlet refrigerant temperature T_{W_BATT_OUT}, the heat-exhausting device inlet refrigerant temperature T_{W_EX_IN}, and the heat-exhausting device outlet refrigerant temperature T_{W_EX_OUT} are acquired again.

Subsequently, the control proceeds to step S405, in which based on the battery temperature T_{BATT}, the battery inlet refrigerant temperature T_{W_EX_IN}, the battery outlet refrigerant temperature T_{W_BATT_OUT}, the heat-exhausting device inlet refrigerant temperature T_{W_EX_IN}, and the heat-exhausting device outlet refrigerant temperature T_{W_EX_OUT}, which are acquired in step S404, the battery heat generation amount Q_{BATT}, the battery heat absorption amount Q_{A}, and the heat-exhausting device heat exhaust amount Q_{EX} are acquired by calculation, and the battery heat generation amount Q_{BATT}, the battery heat absorption amount Q_{A}, and the heat-exhausting device heat exhaust amount Q_{EX} are updated and stored in the control storage unit 51.

Subsequently, the control proceeds to step S406, in which it is determined whether the battery temperature T_{BATT} acquired in step S404 is equal to or lower than the preset output limitation starting temperature T_{S}. If the battery temperature T_{BATT} is equal to or lower than the output limitation starting temperature T_{S} (step S406. YES), the control proceeds to step S407. If the battery temperature T_{BATT} is not equal to or lower than the output limitation starting temperature T_{S}, that is, the battery temperature T_{BATT} exceeds the output limitation starting temperature T_{S} (step S406. NO), the control proceeds to step S104 described above.

In step S407, it is determined whether the battery heat generation amount Q_{BATT} calculated in step S405 is equal to the battery heat absorption amount Q_{A}. If the battery heat generation amount Q_{BATT} calculated in step S405 is not equal to the battery heat absorption amount Q_{A} (step S405: NO), the control returns to step S402 to repeat steps S402 to S407. If the battery heat generation amount Q_{BATT} calculated in step S405 is equal to the battery heat absorption amount Q_{A} (step S407: YES), the control proceeds to step S501.

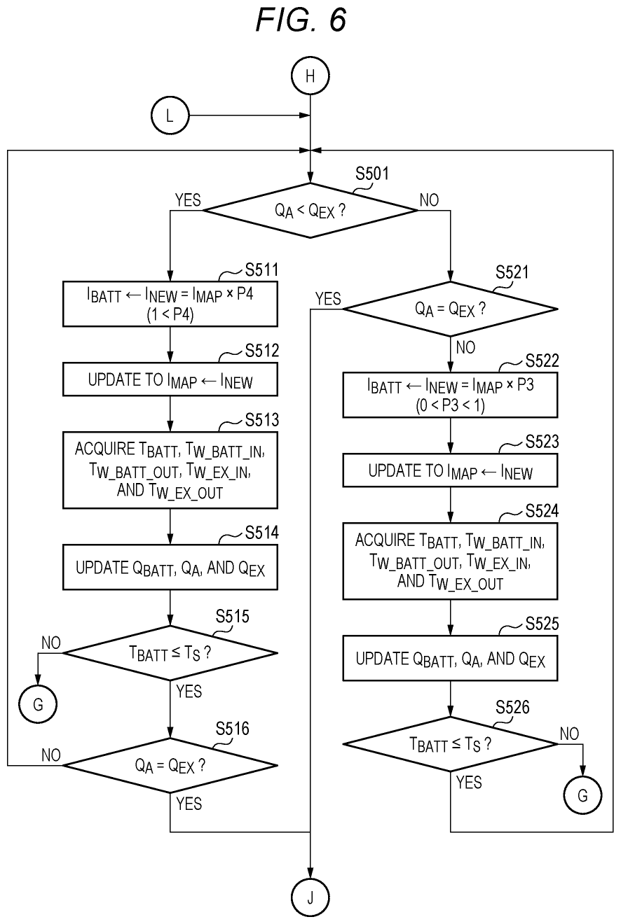

As shown in FIG. 6, in step S501, it is determined whether the battery heat absorption amount Q_{A} is smaller than the heat-exhausting device heat exhaust amount Q_{EX} based on the latest battery heat generation amount Q_{BATT}, the latest battery heat absorption amount Q_{A}, and the latest heat-exhausting device heat exhaust amount Q_{EX} which are stored in the control storage unit 51. If the battery heat absorption amount Q_{A} is smaller than the heat-exhausting device heat exhaust amount Q_{EX} (step S501: YES), the control proceeds to step S51. If the battery heat absorption amount Q_{A} is not smaller than the heat-exhausting device heat exhaust amount Q_{EX}, that is, the battery heat absorption amount Q_{A} is equal to or larger than the heat-exhausting device heat exhaust amount Q_{EX} (step S501: NO), the control proceeds to step S521.

In step S511, a new permitted current value I_{NEW} is calculated based on a permitted current value I_{MAP} that has been permitted for the solid-state battery 20 in the related art, and an output current I_{BATT} of the solid-state battery 20 is controlled to become the new permitted current value I_{NEW}. The new permitted current value I_{NEW} is calculated using the following equation (10).

$${I}_{NEW} = {I}_{MAP} \times P 4 \qquad ( 10 )$$

Note that P4 is a predetermined value that satisfies 1<P4.

Subsequently, the control proceeds to step S512, in which the permitted current value I_{MAP} is updated to the new permitted current value I_{NEW} calculated in step S511 and stored in the control storage unit 51.

Subsequently, the control proceeds to step S513, in which the battery temperature T_{BATT}, the battery inlet refrigerant temperature T_{W_BATT_IN}, the battery outlet refrigerant temperature T_{W_BATT_OUT}, the heat-exhausting device inlet refrigerant temperature T_{W_EX_IN}, and the heat-exhausting device outlet refrigerant temperature T_{W_EX_OUT} are acquired again.

Subsequently, the control proceeds to step S514, in which based on the battery temperature T_{BATT}, the battery inlet refrigerant temperature T_{W_BATT_IN}, the battery outlet refrigerant temperature T_{W_BATT_OUT}, the heat-exhausting device inlet refrigerant temperature T_{W_EX_IN}, and the heat-exhausting device outlet refrigerant temperature T_{W_EX_OUT}, which are acquired in step S513, the battery heat generation amount Q_{BATT}, the battery heat absorption amount Q_{A}, and the heat-exhausting device heat exhaust amount Q_{EX} are acquired by calculation, and the battery heat generation amount Q_{BATT}, the battery heat absorption amount Q_{A}, and the heat-exhausting device heat exhaust amount Q_{EX} are updated and stored in the control storage unit 51.

Subsequently, the control proceeds to step S515, in which it is determined whether the battery temperature T_{BATT} acquired in step S513 is equal to or lower than the output limitation starting temperature T_{S}. If the battery temperature T_{BATT} is equal to or lower than the output limitation starting temperature Tₛ (step S515: YES), the control proceeds to step S516. If the battery temperature T_{BATT} is not equal to or lower than the output limitation starting temperature Tₛ, that is, the battery temperature T_{BATT} exceeds the output limitation starting temperature Tₛ (step S515: NO), the control proceeds to step S104 described above.

In step S516, it is determined whether the battery heat absorption amount Q_{A} calculated in step S514 is equal to the heat-exhausting device heat exhaust amount Q_{EX}. If the battery heat absorption amount Q_{A} is not equal to the heat-exhausting device heat exhaust amount Q_{EX} (step S516: NO), the control returns to step S501 to repeat the processing of step S501 and the subsequent steps. If the battery heat absorption amount Q % calculated in step S514 is equal to the heat-exhausting device heat exhaust amount Q_{EX} (step S516: YES), the control proceeds to step S601.

On the other hand, in step S521, it is determined whether the battery heat absorption amount Q_{A} is equal to the heat-exhausting device heat exhaust amount Q_{EX} based on the latest battery heat generation amount Q_{BATT}, the latest battery heat absorption amount Q_{A}, and the latest heat-exhausting device heat exhaust amount Q_{EX} which are stored in the control storage unit 51. If the battery heat absorption amount Q_{A} is equal to the heat-exhausting device heat exhaust amount Q_{EX} (step S521: YES), the control proceeds to step S601, and if the battery heat absorption amount Q_{A} is not equal to the heat-exhausting device heat exhaust amount Q_{EX} (step S521: NO), the control proceeds to step S522. In a case where it is determined in step S521 that the battery heat absorption amount Q_{A} is not equal to the heat-exhausting device heat exhaust amount Q_{EX} (step S521: NO), the following conditions are satisfied that the battery heat absorption amount Q_{A} is equal to or larger than the heat-exhausting device heat exhaust amount Q_{EX} (step S501: NO), and the battery heat absorption amount Q_{A} is not equal to the heat-exhausting device heat exhaust amount Q_{EX} (step S521: NO). Therefore, the battery heat absorption amount Q_{A} is larger than the heat-exhausting device heat exhaust amount Q_{EX}.

In step S522, a new permitted current value I_{NEW} is calculated based on a permitted current value I_{MAP} that has been permitted for the solid-state battery 20 in the related art, and an output current I_{BATT} of the solid-state battery 20 is controlled to become the new permitted current value I_{NEW}. The new permitted current value I_{NEW} is calculated using the following equation (11).

$${I}_{NEW} = {I}_{MAP} \times P 3 \qquad ( 11 )$$

Note that P3 is a predetermined value that satisfies 0<P3<1.

Subsequently, the control proceeds to step S523, in which the permitted current value I_{MAP} is updated to the new permitted current value I_{NEW} calculated in step S522 and stored in the control storage unit 51.

Subsequently, the control proceeds to step S524, in which the battery temperature T_{BATT}, the battery inlet refrigerant temperature T_{W_BATT_IN}, the battery outlet refrigerant temperature T_{W_BATT_OUT}, the heat-exhausting device inlet refrigerant temperature T_{W_EX_IN}, and the heat-exhausting device outlet refrigerant temperature T_{W_EX_OUT} are acquired again.

Subsequently, the control proceeds to step S525, in which based on the battery temperature T_{B}AT, the battery inlet refrigerant temperature T_{W_BATT_IN}, the battery outlet refrigerant temperature T_{W_BATT_OUT}, the heat-exhausting device inlet refrigerant temperature T_{W_EX_IN}, and the heat-exhausting device outlet refrigerant temperature T_{W_EX_OUT}, which are acquired in step S524, the battery heat generation amount Q_{BATT}, the battery heat absorption amount Q_{A}, and the heat-exhausting device heat exhaust amount Q_{EX} are acquired by calculation, and the battery heat generation amount Q_{BATT}, the battery heat absorption amount Q_{A}, and the heat-exhausting device heat exhaust amount Q_{EX} are updated and stored in the control storage unit 51.

Subsequently, the control proceeds to step S526, in which it is determined whether the battery temperature T_{BATT} acquired in step S524 is equal to or lower than the output limitation starting temperature Tₛ. If the battery temperature T_{BATT} is equal to or lower than the output limitation starting temperature T_{S} (step S526: YES), the control returns to step S501, and the processing of step S501 and the subsequent steps is repeated until the battery heat absorption amount Q_{A} becomes equal to the heat-exhausting device heat exhaust amount Q_{EX}. In step S526, if the battery temperature T_{BATT} is not equal to or lower than the output limitation starting temperature T_{S}, that is, the battery temperature T_{BATT} exceeds the output limitation starting temperature T_{S} (step S526: NO), the control proceeds to step S104 described above.

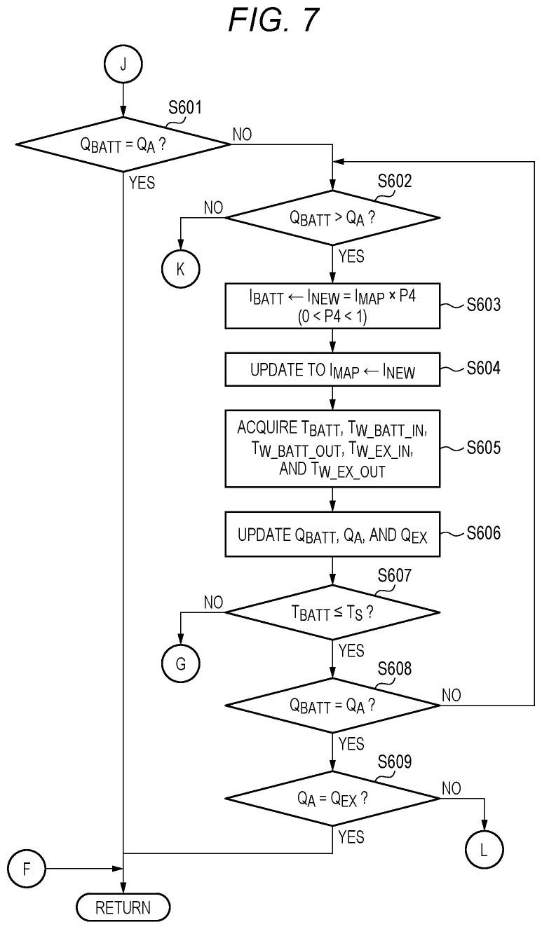

As shown in FIG. 7, in step S601, it is determined whether the battery heat generation amount Q_{BATT} is equal to the battery heat absorption amount Q_{A} based on the latest battery heat generation amount Q_{BATT}, the latest battery heat absorption amount Q_{A}, and the latest heat-exhausting device heat exhaust amount Q_{EX} which are stored in the control storage unit 51.

In step S601, if the battery heat generation amount Q_{BATT} is equal to the battery heat absorption amount Q_{A} (step S601: YES), a series of controls ends. The control returns to the start, and the battery control device 50 repeats the series of controls.

In a case where the battery heat generation amount Q_{BATT} is equal to the battery heat absorption amount Q_{A} in step S601 (step S601: YES), with respect to the latest battery heat generation amount Q_{BATT}, the latest battery heat absorption amount Q_{A}, and the latest heat-exhausting device heat exhaust amount Q_{EX}, which are stored in the control storage unit 51 and acquired by calculation in any of step S102. S405. S514, and S525, the following conditions are satisfied that the battery heat absorption amount Q_{A} is equal to the heat-exhausting device heat exhaust amount Q_{EX} (step S516: YES, step S521: YES), and the battery heat generation amount Q_{BATT} is equal to the battery heat absorption amount Q_{A} (step S601: YES). Therefore, the battery heat generation amount Q_{BATT}, the battery heat absorption amount Q_{A}, and the heat-exhausting device heat exhaust amount Q_{EX} are equal to each other.

On the other hand, in step S601, if the battery heat generation amount Q_{BATT} is not equal to the battery heat absorption amount Q_{A} (step S601: NO), the control proceeds to step S602.

In step S602, it is determined whether the battery heat generation amount Q_{BATT} is larger than the battery heat absorption amount Q_{A} based on the latest battery heat generation amount Q_{BATT}, the latest battery heat absorption amount Q_{A}, and the latest heat-exhausting device heat exhaust amount Q_{EX}, which are stored in the control storage unit 51 and acquired by calculation in any of step S102, S405, S514, and S525. If the battery heat generation amount Q_{BATT} is larger than the battery heat absorption amount Q_{A} (step S602: YES), the control proceeds to step S603, and if the battery heat generation amount Q_{BATT} is not larger than the battery heat absorption amount Q_{A} (step S602: NO), the control returns to step S402. In a case where it is determined in step S602 that the battery heat generation amount Q_{BATT} is not larger than the battery heat absorption amount Q_{A} (step S602: NO), the following conditions are satisfied that the battery heat generation amount Q_{BATT} is not equal to the battery heat absorption amount Q_{A} (step S601: NO) and the battery heat generation amount Q_{BATT} is not larger than the battery heat absorption amount Q_{A} (step S602: NO). Therefore, the battery heat generation amount Q_{BATT} is smaller than the battery heat absorption amount Q_{A}.

In step S603, a new permitted current value I_{NEW} is calculated based on a permitted current value I_{MAP} that has been permitted for the solid-state battery 20 in the related art, and an output current I_{BATT} of the solid-state battery 20 is controlled to become the new permitted current value I_{NEW}. The new permitted current value I_{NEW} is calculated using the following equation (12).

$${I}_{NEW} = {I}_{MAP} \times P 4 \qquad ( 12 )$$

Note that P4 is a predetermined value that satisfies 0<P4<1.

Subsequently, the control proceeds to step S604, in which the permitted current value I_{MAP} is updated to the new permitted current value I_{NEW} calculated in step S603 and stored in the control storage unit 51.

Subsequently, the control proceeds to step S605, in which the battery temperature T_{BATT}, the battery inlet refrigerant temperature T_{W_BATT_IN}, the battery outlet refrigerant temperature T_{W_BATT_OUT}, the heat-exhausting device inlet refrigerant temperature T_{W_EX_IN}, and the heat-exhausting device outlet refrigerant temperature T_{W_EX_OUT} are acquired again.

Subsequently, the control proceeds to step S606, in which based on the battery temperature T_{BATT}, the battery inlet refrigerant temperature T_{W_BATT_IN}, the battery outlet refrigerant temperature T_{W_BATT_OUT}, the heat-exhausting device inlet refrigerant temperature T_{W_EX_IN}, and the heat-exhausting device outlet refrigerant temperature T_{W_EX_OUT}, which are acquired in step S605, the battery heat generation amount Q_{BATT}, the battery heat absorption amount Q_{A}, and the heat-exhausting device heat exhaust amount Q_{EX} are acquired by calculation, and the battery heat generation amount Q_{BATT}, the battery heat absorption amount Q_{A}, and the heat-exhausting device heat exhaust amount Q_{EX} are updated and stored in the control storage unit 51.

Subsequently, the control proceeds to step S607, in which it is determined whether the battery temperature T_{BATT} acquired in step S605 is equal to or lower than the output limitation starting temperature T_{S}. If the battery temperature T_{BATT} is equal to or lower than the output limitation starting temperature T_{S} (step S607: YES), the control proceeds to step S608. If the battery temperature T_{BATT} is not equal to or lower than the output limitation starting temperature T_{S}, that is, the battery temperature T_{BATT} exceeds the output limitation starting temperature T_{S} (step S607: NO), the control proceeds to step S104 described above.

In step S608, it is determined whether the battery heat generation amount Q_{BATT} calculated in step S606 is equal to the battery heat absorption amount Q_{A}. If the battery heat generation amount Q_{BATT} is not equal to the battery heat absorption amount Q_{A} (step S608: NO), the control returns to step S602 to repeat steps S602 to S608. If the battery heat generation amount Q_{BATT} calculated in step S606 is equal to the battery heat absorption amount Q_{A} (step S608: YES), the control proceeds to step S609.

In step S609, it is determined whether the battery heat absorption amount Q_{A} calculated in step S606 is equal to the heat-exhausting device heat exhaust amount Q_{EX}. If the battery heat absorption amount Q_{A} is not equal to the heat-exhausting device heat exhaust amount Q_{EX} (step S609: NO), the control returns to step S501.

In step S609, when the battery heat absorption amount Q_{A} is equal to the heat-exhausting device heat exhaust amount Q_{EX} (step S609: YES), the series of controls ends. The control returns to the start, and the battery control device 50 repeats the series of controls.

In a case where the battery heat absorption amount Q_{A} is equal to the heat-exhausting device heat exhaust amount Q_{EX} (step S609: YES) in step S609, with respect to the battery heat generation amount Q_{BATT}, the battery heat absorption amount Q_{A}, and the heat-exhausting device heat exhaust amount Q_{EX} calculated in step S606, the following conditions are satisfied that the battery heat generation amount Q_{BATT} is equal to the battery heat absorption amount Q_{A} (step S608: YES), and the battery heat absorption amount Q_{A} is equal to the heat-exhausting device heat exhaust amount Q_{EX} (step S609: YES). Therefore, the battery heat generation amount Q_{BATT}, the battery heat absorption amount Q_{A}, and the heat-exhausting device heat exhaust amount Q_{EX} are equal to each other.

As described above, in the series of controls, when the battery temperature T_{BATT} is lower than the first threshold temperature T₁ and the battery heat generation amount Q_{BATT} is smaller than the heat-exhausting device heat exhaust amount Q_{EX}, the battery control device 50 performs control to increase the output current I_{BATT} of the solid-state battery 20 such that the battery heat generation amount Q_{BATT}, the battery heat absorption amount Q_{A}, and the heat-exhausting device heat exhaust amount Q_{EX} become equal to each other.

When the battery heat generation amount Q_{BATT}, the battery heat absorption amount Q_{A}, and the heat-exhausting device heat exhaust amount Q_{EX} become equal to each other, the battery temperature T_{BATT} is kept constant without increasing or decreasing.

Accordingly, when the battery temperature T_{BATT} is lower than the first threshold temperature T₁ and the battery heat generation amount Q_{BATT} is smaller than the heat-exhausting device heat exhaust amount Q_{EX}, the output current I_{BATT} of the solid-state battery 20 can be increased while maintaining the battery temperature T_{BATT} at a constant temperature to effectively utilize output performance of the solid-state battery 20. For example, in a case where the vehicle on which the battery cooling system 10 is mounted is a hybrid vehicle that includes an engine and can travel by using both power of the engine and electric power of the solid-state battery 20 as a drive source, a load on the engine can be reduced and fuel efficiency will be improved by utilizing the increased output current I_{BATT} of the solid-state battery 20 as a drive source. In addition, the increased output current I_{BATT} of the solid-state battery 20 may be charged into a low-voltage battery for an accessory mounted on the vehicle, or may be utilized as operating power of an air conditioner mounted on the vehicle.

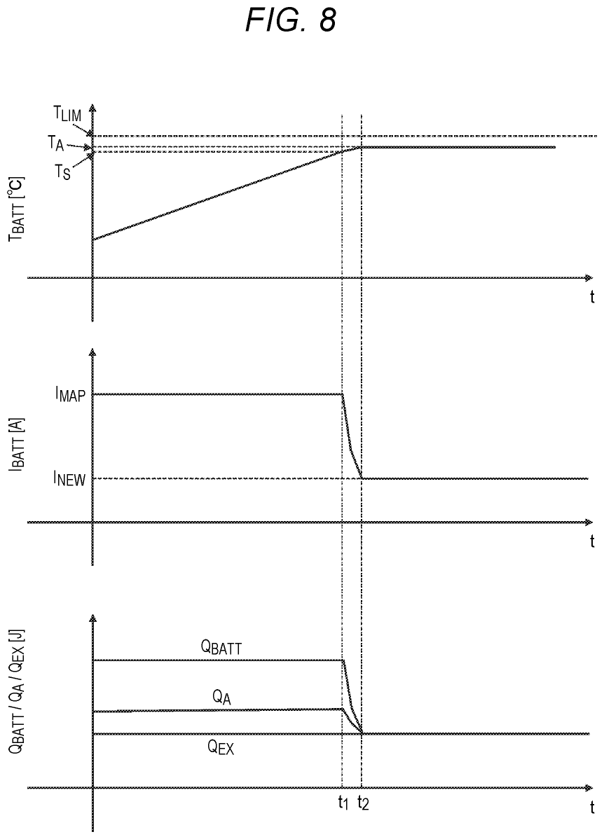

Here, in the series of controls, transition images of the battery temperature T_{BATT}, the output current I_{BATT}, the battery heat generation amount Q_{BATT}, the battery heat absorption amount Q_{A}, the heat-exhausting device heat exhaust amount Q_{EX} when the battery temperature T_{BATT} exceeds the predetermined output limitation starting temperature T_{S} and the battery heat generation amount Q_{BATT}>the battery heat absorption amount Q_{A}>the heat-exhausting device heat exhaust amount Q_{EX} is satisfied will be described with reference to FIG. 8. The heat generation amount shown in the drawing s is an assumption of a heat generation amount per unit time.

When the battery temperature T_{BATT} increases and reaches the output limitation starting temperature T_{S} at time t₁, the output current I_{BATT} is limited from the permitted current value I_{MAP}, which has been permitted for the solid-state battery 20 in the related art, to a new permitted current value I_{NEW} [A] at which the battery heat generation amount Q_{BATT}=the battery heat absorption amount Q_{A}=the heat-exhausting device heat exhaust amount Q_{EX}.

While limiting the output current I_{BATT} to reduce the battery heat generation amount Q_{BATT}, the feedback control of the output current I_{BATT} of the solid-state battery 20 is continued such that the battery heat generation amount Q_{BATT}=the battery heat absorption amount Q_{A}=the heat-exhausting device heat exhaust amount Q_{EX}.

The battery heat absorption amount Q_{A} is reduced by limiting the output current I_{BATT}, thereby realizing the battery heat absorption amount Q_{A}=the heat-exhausting device heat exhaust amount Q_{EX}.

Accordingly, at time t₂, the battery heat generation amount Q_{BATT}=the battery heat absorption amount Q_{A}=the heat-exhausting device heat exhaust amount Q_{EX}. When the battery heat generation amount Q_{BATT}=the battery heat absorption amount Q_{A}=the heat-exhausting device heat exhaust amount Q_{EX}, the battery temperature T_{BATT} is kept constant at a predetermined temperature Tₐ without increasing or decreasing after time t₂. In this way, the battery temperature T_{BATT} is controlled to be lower than a predetermined output permission upper-limit temperature T_{LIM} [C] which is an upper-limit temperature at which the solid-state battery 20 is permitted to output power.

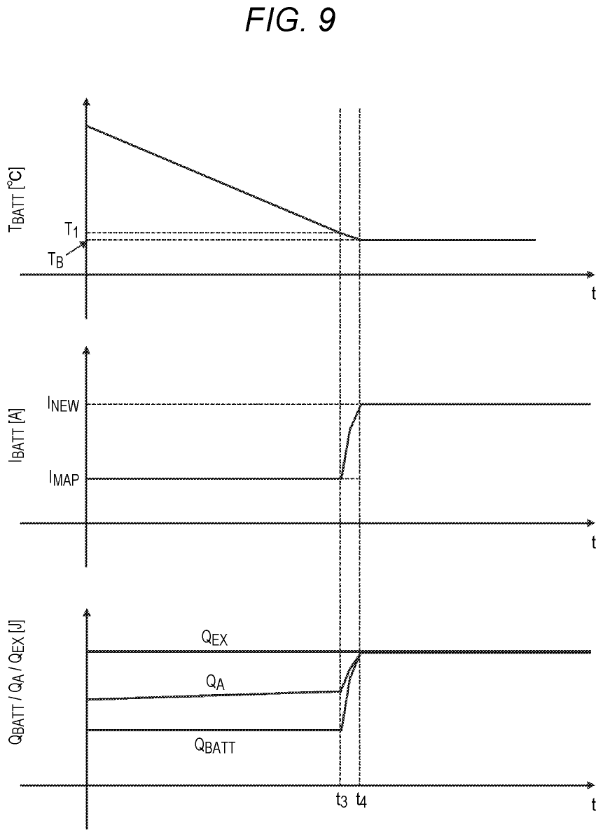

Next, in the series of controls, transition images of the battery temperature T_{BATT}, the output current I_{BATT}, the battery heat generation amount Q_{BATT}, the battery heat absorption amount Q_{A}, and the heat-exhausting device heat exhaust amount Q_{EX} when the battery temperature T_{BATT} is lower than the first threshold temperature T₁ and the battery heat generation amount Q_{BATT}<the battery heat absorption amount Q_{A}<the heat-exhausting device heat exhaust amount Q_{EX} is satisfied are described with reference to FIG. 9. The heat generation amount shown in the drawing s is an assumption of a heat generation amount per unit time.

When the battery temperature T_{BATT} decreases and reaches the first threshold temperature T₁ at time t₃, the output current I_{BATT} is increased from the permitted current value I_{MAP} which has been permitted for the solid-state battery 20 in the related art, to a new permitted current value I_{NEW} [A] at which the battery heat generation amount Q_{BATT}=the battery heat absorption amount Q_{A}=the heat-exhausting device heat exhaust amount Q_{EX}.

While increasing the output current I_{BATT} to increase the battery heat generation amount Q_{BATT}, the feedback control of the output current I_{BATT} of the solid-state battery 20 is continued such that the battery heat generation amount Q_{BATT}=the battery heat absorption amount Q_{A}=the heat-exhausting device heat exhaust amount Q_{EX}.

The battery heat absorption amount Q_{A} is increased by increasing the output current I_{BATT}, thereby realizing the battery heat absorption amount Q_{A}=the heat-exhausting device heat exhaust amount Q_{EX}.

Accordingly, at time t_{A}, the battery heat generation amount Q_{BATT}=the battery heat absorption amount Q_{A}=the heat-exhausting device heat exhaust amount Q_{EX}. When the battery heat generation amount Q_{BATT}=the battery heat absorption amount Q_{A}=the heat-exhausting device heat exhaust amount Q_{EX}, the battery temperature T_{BATT} is kept constant at a predetermined temperature T_{b} without increasing or decreasing after time t₄.

### <Second Example of Control Flow in Battery Control Device>

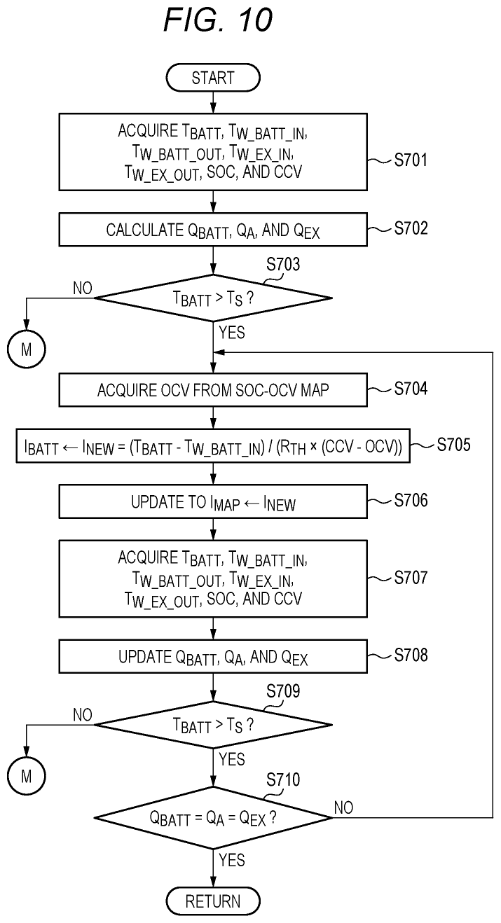

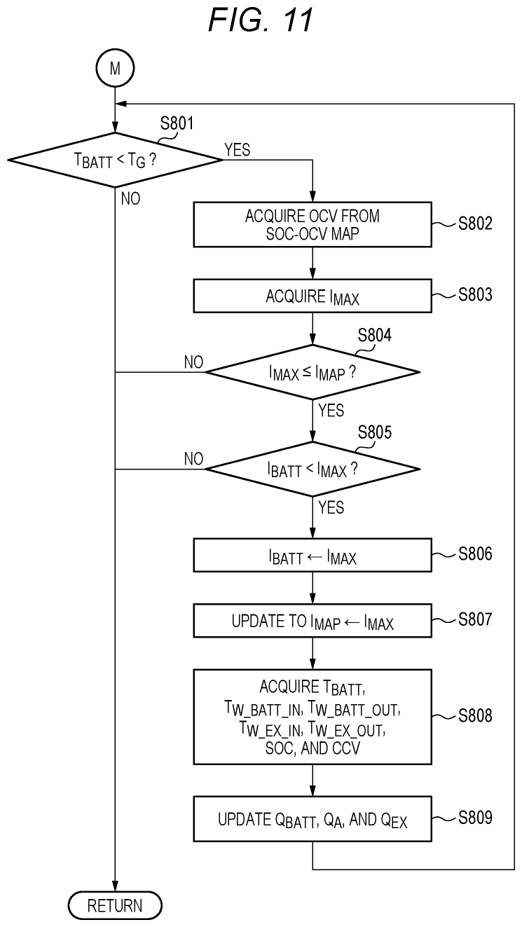

Next, a second example of a control flow of the input-output power of the solid-state battery 20 in the battery control device 50 will be described with reference to FIGS. 10 and 11.

As shown in FIG. 10, the battery control device 50 first acquires a battery temperature T_{BATT}, a battery inlet refrigerant temperature T_{W_BATT_IN}, a battery outlet refrigerant temperature T_{W_BATT_OUT}, a heat-exhausting device inlet refrigerant temperature T_{W_EX_IN}, a heat-exhausting device outlet refrigerant temperature T_{W_EX_OUT}, a remaining battery capacity SOC [%] of the solid-state battery 20, and a battery voltage CCV [V] of the solid-state battery 20 (step S701). In the present embodiment, the battery temperature T_{BATT}, the battery inlet refrigerant temperature T_{W_BATT_IN}, the battery outlet refrigerant temperature T_{W_BATT_OUT}, the heat-exhausting device inlet refrigerant temperature T_{W_EX_IN}, and the heat-exhausting device outlet refrigerant temperature T_{W_BATT_OUT} are acquired by detection of the battery temperature sensor 41, the battery inlet refrigerant temperature sensor 42, the battery outlet refrigerant temperature sensor 43, the heat-exhausting device inlet refrigerant temperature sensor 44, and the heat-exhausting device outlet refrigerant temperature sensor 45. The battery voltage CCV is acquired by, for example, detection by a voltage sensor (not shown) provided in the solid-state battery 20. The remaining battery capacity SOC is acquired by calculation based on the acquired battery voltage CCV, for example.

Subsequently, the control proceeds to step S702, in which a battery heat generation amount Q_{BATT} which is a heat generation amount of the solid-state battery 20, a battery heat absorption amount Q_{A} which is a heat absorption amount of the refrigerant W from the solid-state battery 20, and a heat-exhausting device heat exhaust amount Q_{EX} of the refrigerant W in the heat-exhausting device 30 are acquired by calculation.

The battery heat generation amount Q_{BATT} is calculated using the following equation (13). In the equation (13). I_{BATT} represents an actual output current value flowing through the solid-state battery 20, and OCV represents a battery open-circuit voltage of the solid-state battery 20. The battery open-circuit voltage OCV is a value that changes according to the remaining battery capacity SOC, and is stored in the control storage unit 51 of the battery control device 50 as an SOC-OCV map.

$${Q}_{BATT} = {I}_{BATT} \times ( CCV - OCV ) \times Δ t \qquad ( 13 )$$

The battery heat absorption amount Q_{A} is calculated using the above-described equation (2), similarly to the above-described first example of the control flow in the battery control device.

The heat-exhausting device heat exhaust amount Q_{EX} is calculated using the above-described equation (4) as in the above-described first example of the control flow in the battery control device.

Subsequently, the control proceeds to step S703, in which it is determined whether the battery temperature T_{BATT} acquired in step S701 exceeds a preset output limitation starting temperature T_{S} [° C.]. If the battery temperature T_{BATT} exceeds the output limitation starting temperature T_{S} (step S703: YES), the control proceeds to step S704. If the battery temperature T_{BATT} does not exceed the output limitation starting temperature T_{S}, that is, the battery temperature T_{BATT} is equal to or lower than the output limitation starting temperature T_{S} (step S703: NO), the control proceeds to step S801 to be described later.

In step S704, the battery open-circuit voltage OCV is acquired based on the latest remaining battery capacity SOC stored in the control storage unit 51 and the SOC-OCV map.

The control proceeds to step S705, in which a new permitted current value I_{NEW} at which the battery heat generation amount Q_{BATT} is equal to the battery heat absorption amount Q_{A} is calculated, and the output current I_{BATT} of the solid-state battery 20 is controlled to become the new permitted current value I_{NEW}.

Here, the following equation (14) is established from a relationship between the temperature and the thermal resistance.

$${Q}_{A} / Δ t \times {R}_{TH} = {T}_{BATT} - {T}_{W \_ BATT \_ IN} \qquad ( 14 )$$

R_{TH} [K/W] is a thermal resistance value between the solid-state battery 20 and the refrigerant W. The thermal resistance value R_{TH} is stored in the control storage unit 51 in advance.

From the equations (13) and (14), the new permitted current value I_{NEW} at which Q_{BATT}=Q_{A} is calculated by the following equation (15).

$${Q}_{BATT} = {Q}_{A} ↔ {I}_{NEW} \times ( C C V - OCV ) \times Δ t = ( {T}_{BATT} - {T}_{W \_ BATT \_ IN} ) \times Δ t / {R}_{TH} ↔ {I}_{NEW} = ( {T}_{BATT} - {T}_{W \_ BATT \_ IN} ) / ( {R}_{TH} \times ( CCV - OCV ) ) \qquad ( 15 )$$

Subsequently, the control proceeds to step S706, in which the permitted current value I_{MAP} is updated to the new permitted current value I_{NEW} calculated in step S705 and stored in the control storage unit 51.

Subsequently, the control proceeds to step S707, the battery temperature T_{BATT}, the battery inlet refrigerant temperature T_{W_BATT_IN}, the battery outlet refrigerant temperature T_{W_BATT_OUT}, the heat-exhausting device inlet refrigerant temperature T_{W_EX_IN}, the heat-exhausting device outlet refrigerant temperature T_{W_EX_OUT}, the remaining battery capacity SOC of the solid-state battery 20, and the battery voltage CCV of the solid-state battery 20 are acquired again.

Subsequently, the control proceeds to step S708, in which based on the battery temperature T_{BATT}, the battery inlet refrigerant temperature T_{W_BATT_IN}, the battery outlet refrigerant temperature T_{W_BATT_OUT}, the heat-exhausting device inlet refrigerant temperature T_{W_EX_IN}, the heat-exhausting device outlet refrigerant temperature T_{W_EX_OUT}, the remaining battery capacity SOC of the solid-state battery 20, and the battery voltage CCV of the solid-state battery 20, which are acquired in step S707, the battery heat generation amount Q_{BATT}, the battery heat absorption amount Q_{A}, and the heat-exhausting device heat exhaust amount Q_{EX} are acquired by calculation, and the battery heat generation amount Q_{BATT}, the battery heat absorption amount Q_{A}, and the heat-exhausting device heat exhaust amount Q_{EX} are updated and stored in the control storage unit 51.

Subsequently, the control proceeds to step S709, in which it is determined whether the battery temperature T_{BATT} acquired in step S707 exceeds the preset output limitation starting temperature T_{S}. If the battery temperature T_{BATT} exceeds the output limitation starting temperature T_{S} (step S709: YES), the control proceeds to step S710. If the battery temperature T_{BATT} does not exceed the output limitation starting temperature T_{S} [° C.], that is, the battery temperature T_{BATT} is equal to or lower than the output limitation starting temperature T_{S} (step S709: NO), the control proceeds to step S801 to be described later.

In step S710, it is determined whether the battery heat generation amount Q_{BATT}, the battery heat absorption amount Q_{A}, and the heat-exhausting device heat exhaust amount Q_{EX} are equal to each other. If the battery heat generation amount Q_{BATT}, the battery heat absorption amount Q_{A}, and the heat-exhausting device heat exhaust amount Q_{EX} are not equal to each other (step S710: NO), the control returns to step S704, and steps S704 to S710 are repeated. If the battery heat generation amount Q_{BATT}, the battery heat absorption amount Q_{A}, and the heat-exhausting device heat exhaust amount Q_{EX} are equal to each other (step S710: YES), the series of controls ends. The control returns to the start, and the battery control device 50 repeats the series of controls.

As described above, in the series of controls, when the battery temperature T_{BATT} exceeds the predetermined output limitation starting temperature T_{S}, the battery control device 50 controls the output current I_{BATT} of the solid-state battery 20 such that the battery heat generation amount Q_{BATT}, the battery heat absorption amount Q_{A}, and the heat-exhausting device heat exhaust amount Q_{EX} become equal to each other.

When the battery heat generation amount Q_{BATT}, the battery heat absorption amount Q_{A}, and the heat-exhausting device heat exhaust amount Q_{EX} become equal to each other, the battery temperature T_{BATT} is kept constant without increasing or decreasing. In this way, the battery control device 50 controls the battery temperature T_{BATT} to be equal to or higher than the output limitation starting temperature T_{S} and lower than a predetermined output permission upper-limit temperature T_{LIM} [° C.] which is an upper-limit temperature at which the solid-state battery 20 is permitted to output power. An output permission upper-limit temperature T_{LIM} is set in advance according to battery characteristics of the solid-state battery 20, and is stored in the control storage unit 51.

Accordingly, even in a case where the battery temperature T_{BATT} of the solid-state battery 20 exceeds the output limitation starting temperature T_{S}, the solid-state battery 20 can be used while the battery temperature T_{BATT} of the solid-state battery 20 is prevented from reaching the output permission upper-limit temperature T_{LIM}. Therefore, it is possible to prevent the output from the solid-state battery 20 from being suddenly limited, and to maintain stable output from the solid-state battery 20.

In addition, in the series of controls, the thermal resistance value R_{TH} between the solid-state battery 20 and the refrigerant W is stored in the control storage unit 51, and the battery control device 50 calculates, based on the thermal resistance value R_{TH}, a new permitted current value I_{NEW} of the solid-state battery 20 at which the battery heat generation amount Q_{BATT} and the battery heat absorption amount Q_{A} are equal to each other, and controls the output current I_{BATT} of the solid-state battery 20 to become the new permitted current value I_{NEW}.

Accordingly, it is possible to control the output current T_{BATT} of the solid-state battery 20 such that the battery heat generation amount Q_{BATT}, the battery heat absorption amount Q_{A}, and the heat-exhausting device heat exhaust amount Q_{EX} are equal to each other in a short time while preventing hunting of the output current I_{BATT} of the solid-state battery 20.

On the other hand, as described above, in steps S703 and S709, if the battery temperature T_{BATT} does not exceed the output limitation starting temperature T_{S}, that is, the battery temperature T_{BATT} is equal to or lower than the output limitation starting temperature T_{S}, the control proceeds to step S801.

As shown in FIG. 11, in step S801, it is determined whether the battery temperature T_{BATT} is lower than a control target temperature T_{G} [° C.]. The control target temperature T_{G} is a predetermined temperature equal to or lower than the output limitation starting temperature T_{S}, and is stored in the control storage unit 51 in advance. The control target temperature T_{G} may be the same temperature as the output limitation starting temperature T_{S}.

In step S801, if the battery temperature T_{BATT} is not lower than the control target temperature T_{G}, that is, the battery temperature T_{BATT} is equal to or higher than the control target temperature T_{G} [° C.] (step S801: NO), the series of controls ends. The control returns to the start, and the battery control device 50 repeats the series of controls.

In step S801, if the battery temperature T_{BATT} is lower than the control target temperature T_{G} (step S801: YES), the control proceeds to step S802.

In step S802, the battery open-circuit voltage OCV is acquired from the SOC-OCV map based on the latest remaining battery capacity SOC stored in the control storage unit 51.

The control proceeds to step S803, in which a maximum allowable current value I_{MAX} [A] is acquired by calculation. The maximum allowable current value I_{MAX} is a current value required to increase the battery temperature T_{BATT} to the control target temperature T_{G}.

When the amount of heat added to the solid-state battery 20 necessary to increase the battery temperature T_{BATT} to the control target temperature T_{G} is defined as a maximum allowable battery heat amount Q_{BATT_MAX} [J], the following equation (16) is established.

$${Q}_{BATT \_ M AX} - {Q}_{A} = {C}_{BATT} \times ( {T}_{G} - {T}_{BATT} ) \qquad ( 16 )$$

C_{BATT} [J/K] is the battery heat capacity of the solid-state battery 20 and is stored in the control storage unit 51 in advance.

From equations (16), (13), and (14), the following equation (17) is established. Thus, in step S803, the maximum allowable current value I_{MAX} satisfying the equation (17) is acquired by calculation.

$${I}_{MA X} \times ( CCV - OCV ) \times Δ t = {C}_{BATT} \times ( {T}_{G} - {T}_{BATT} ) + ( {T}_{BATT} - {T}_{W\_ BATT \_ IN} ) \times Δ t / {R}_{TH} \qquad ( 17 )$$

Subsequently, the control proceeds to step S804, in which it is determined whether the maximum allowable current value I_{MAX} acquired in step S803 is equal to or smaller than the permitted current value I_{MAP} stored in the control storage unit 51. If the maximum allowable current value I_{MAX} acquired in step S803 is equal to or smaller than the permitted current value I_{MAP} stored in the control storage unit 51 (step S804: YES), the control proceeds to step S805. If the maximum allowable current value I_{MAX} acquired in step S803 is larger than the permitted current value I_{MAP} stored in the control storage unit 51 (step S804: NO), the series of controls ends. The control returns to the start, and the battery control device 50 repeats the series of controls.

In step S805, it is determined whether the output current I_{BATT} of the solid-state battery 20 is smaller than the maximum allowable current value I_{MAX} acquired in step S803. If the output current I_{BATT} of the solid-state battery 20 is smaller than the maximum allowable current value I_{MAX} acquired in step S803 (step S805: YES), the control proceeds to step S806. If the output current I_{BATT} of the solid-state battery 20 is not smaller than the maximum allowable current value I_{MAX} acquired in step S803, that is, the output current I_{BATT} of the solid-state battery 20 is equal to or larger than the maximum allowable current value I_{MAX} acquired in step S803 (step S805: NO), the series of controls ends. The control returns to the start, and the battery control device 50 repeats the series of controls.

In step S806, the output current I_{BATT} of the solid-state battery 20 is controlled to be the maximum allowable current value I_{MAX}.

Subsequently, the control proceeds to step S807, in which the permitted current value I_{MAP} is updated to the maximum allowable current value I_{MAX} calculated in step S803 and stored in the control storage unit 51.

Subsequently, the control proceeds to step S808, the battery temperature T_{BATT}, the battery inlet refrigerant temperature T_{W_BATT_IN}, the battery outlet refrigerant temperature T_{W_BATT_OUT}, the heat-exhausting device inlet refrigerant temperature T_{W_EX_IN}, the heat-exhausting device outlet refrigerant temperature T_{W_EX_OUT}, the remaining battery capacity SOC of the solid-state battery 20, and the battery voltage CCV of the solid-state battery 20 are acquired again.

Subsequently, the control proceeds to step S809, in which based on the battery temperature T_{BATT}, the battery inlet refrigerant temperature T_{W_BATT_IN}, the battery outlet refrigerant temperature T_{W_BATT_OUT}, the heat-exhausting device inlet refrigerant temperature T_{W_EX_IN}, the heat-exhausting device outlet refrigerant temperature T_{W_EX_OUT}, the remaining battery capacity SOC of the solid-state battery 20, and the battery voltage CCV of the solid-state battery 20, which are acquired in step S808, the battery heat generation amount Q_{BATT}, the battery heat absorption amount Q_{A}, and the heat-exhausting device heat exhaust amount Q_{EX} are acquired by calculation, and the battery heat generation amount Q_{BATT}, the battery heat absorption amount Q_{A}, and the heat-exhausting device heat exhaust amount Q_{EX} are updated and stored in the control storage unit 51.

The control returns to S801, and when the battery temperature T_{BATT} is lower than the control target temperature T_{G}, steps S801 to S809 are repeated until the battery temperature T_{BATT} reaches the control target temperature T_{G}.

As described above, when the battery temperature T_{BATT} is lower than the control target temperature T_{G} and the output current I_{BATT} of the solid-state battery 20 is smaller than the maximum allowable current value I_{MAX} [A] that is a current value required to increase the battery temperature T_{BATT} to the control target temperature T_{G}, the battery control device 50 performs control to increase the output current I_{BATT} of the solid-state battery 20. However, in the present embodiment, when the maximum allowable current value I_{MAX} is larger than the permitted current value I_{MAP} stored in the control storage unit 51, the permitted current value MAP stored in the control storage unit 51 is prioritized. In this way, “control to increase the output current” means that there is control to increase the output current, and other control related to the output current may be used together. For example, when the maximum allowable current value I_{MAX} is larger than the permitted current value I_{MAP}, the permitted current value I_{MAP} may be prioritized and the output current may not increase.

The control can be referred to as output current release control of the solid-state battery 20 according to the cooling capacity of the solid-state battery 20 of the battery cooling system 10. Accordingly, when the battery temperature T_{BATT} is lower than the control target temperature T_{G}, the output current I_{BATT} of the solid-state battery 20 is increased in accordance with the cooling capacity of the solid-state battery 20 in the battery cooling system 10, so that the output performance of the solid-state battery 20 can be effectively utilized. For example, in a case where the vehicle on which the battery cooling system 10 is mounted is a hybrid vehicle that includes an engine and can travel by using both power of the engine and electric power of the solid-state battery 20 as a drive source, a load on the engine can be reduced and fuel efficiency will be improved by utilizing the increased output current I_{BATT} of the solid-state battery 20 as a drive source. In addition, the increased output current I_{BATT} of the solid-state battery 20 may be charged into a low-voltage battery for an accessory mounted on the vehicle, or may be utilized as operating power of an air conditioner mounted on the vehicle.

### Second Embodiment

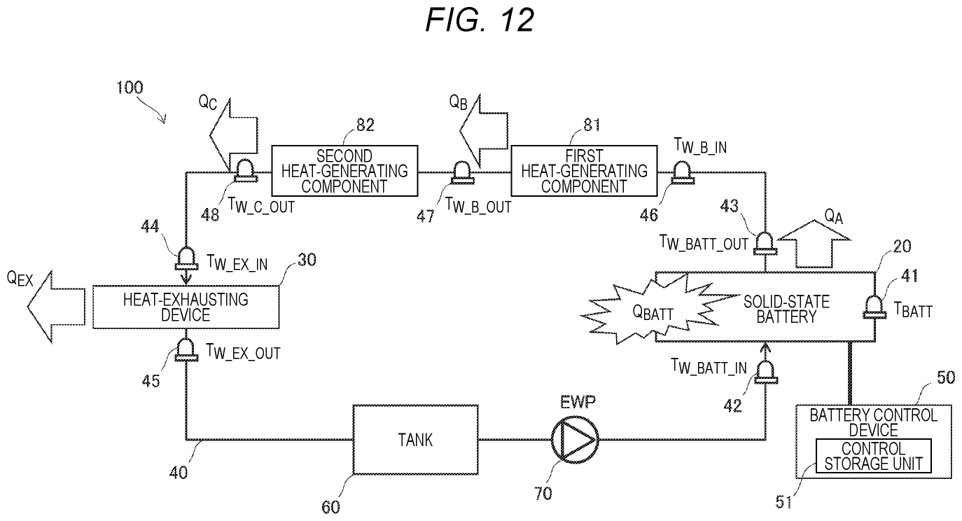

Next, a battery cooling system 100 according to a second embodiment of the present disclosure will be described with reference to FIGS. 12 to 20. In the following description, the same components as those of the battery cooling system 10 of the first embodiment are denoted by the same reference numerals, and the description thereof will be omitted or simplified, and the differences from the battery cooling system 10 of the first embodiment will be described in detail.

### <Configuration of Battery Cooling System>

As shown in FIG. 12, the battery cooling system 100 of the second embodiment further includes a first heat-generating component 81 and a second heat-generating component 82 in addition to the solid-state battery 20, the heat-exhausting device 30, the cooling circuit 40, and the battery control device 50 of the battery cooling system 10 of the first embodiment. The first heat-generating component 81 and the second heat-generating component 82 are heat-generating components other than the solid-state battery 20 and the heat-exhausting device 30. The cooling circuit 40 is formed such that the refrigerant W circulates through the solid-state battery 20, the heat-exhausting device 30, the first heat-generating component 81, and the second heat-generating component 82.

The first heat-generating component 81 and the second heat-generating component 82 are provided in the cooling circuit 40. The first heat-generating component 81 and the second heat-generating component 82 are both provided between the refrigerant W discharge side of the solid-state battery 20 and the refrigerant W introduction side of the heat-exhausting device 30 in the cooling circuit 40. The first heat-generating component 81 is provided on the refrigerant W discharge side (upstream side) of the solid-state battery 20, and the second heat-generating component 82 is provided on the refrigerant W introduction side (downstream side) of the heat-exhausting device 30.

The first heat-generating component 81 is, for example, a DC-DC converter that increases or decreases input-output power of the solid-state battery 20, a charger that receives power from an external power supply, or the like.

The second heat-generating component 82 is, for example, a power control unit (PCU) having an inverter that controls input-output power of a drive motor mounted on the vehicle.

The battery cooling system 100 further includes, in addition to the battery temperature sensor 41, the battery inlet refrigerant temperature sensor 42, the battery outlet refrigerant temperature sensor 43, the heat-exhausting device inlet refrigerant temperature sensor 44, and the heat-exhausting device outlet refrigerant temperature sensor 45, a first heat-generating component inlet refrigerant temperature sensor 46 that detects a first heat-generating component inlet refrigerant temperature T_{W_B_IN} [° C.] which is a temperature of the refrigerant W introduced into the first heat-generating component 81, a first heat-generating component outlet refrigerant temperature sensor 47 that detects a first heat-generating component outlet refrigerant temperature T_{W_B_OUT} [° C.] which is a temperature of the refrigerant W discharged from the first heat-generating component 81 and introduced into the second heat-generating component 82, and a second heat-generating component outlet refrigerant temperature sensor 48 that detects a second heat-generating component outlet refrigerant temperature T_{W_C_OUT} [° C.] which is a temperature of the refrigerant W discharged from the second heat-generating component 82.

### <First Example of Control Flow in Battery Control Device>

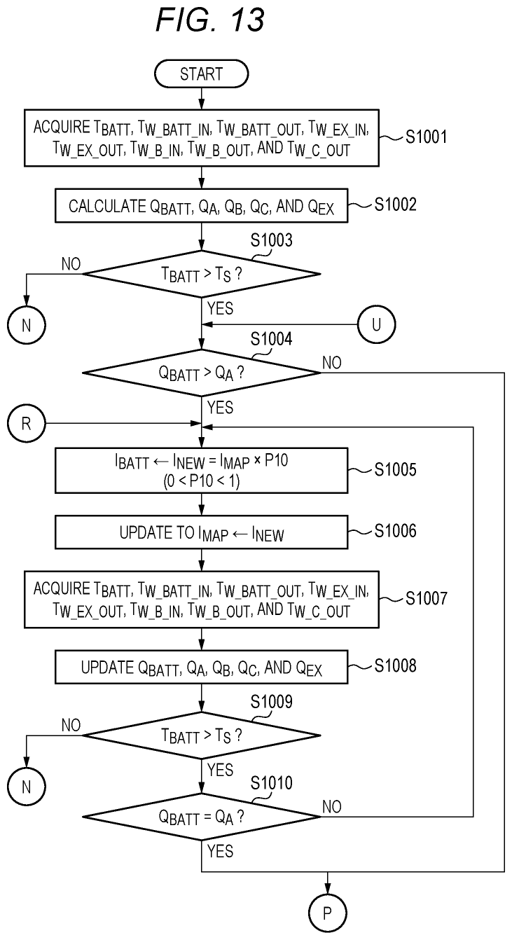

Next, a first example of a control flow of the input-output power of the solid-state battery 20 in the battery control device 50 will be described with reference to FIGS. 13 to 18.

As shown in FIG. 13, the battery control device 50 first acquires a battery temperature T_{BATT} [° C.], a battery inlet refrigerant temperature T_{W_BATT_IN} [° C.], a battery outlet refrigerant temperature T_{W_BATT_OUT} [° C.], a heat-exhausting device inlet refrigerant temperature T_{W_EX_IN} [° C.], a heat-exhausting device outlet refrigerant temperature T_{W_EX_OUT} [° C.], a first heat-generating component inlet refrigerant temperature T_{W_B_IN} [° C.], a first heat-generating component outlet refrigerant temperature T_{W_B_OUT} [° C.], and a second heat-generating component outlet refrigerant temperature T_{W_C_OUT} [° C.] (step S1001). In the present embodiment, the battery temperature T_{BATT}, the battery inlet refrigerant temperature T_{W_BATT_IN}, the battery outlet refrigerant temperature T_{W_BATT_OUT}, the heat-exhausting device inlet refrigerant temperature T_{W_EX_IN}, the heat-exhausting device outlet refrigerant temperature T_{W_EX_OUT}, the first heat-generating component inlet refrigerant temperature T_{W_B_IN}, the first heat-generating component outlet refrigerant temperature T_{W_B_OUT}, and the second heat-generating component outlet refrigerant temperature T_{W_C_OUT} are acquired by detection of the battery temperature sensor 41, the battery inlet refrigerant temperature sensor 42, the battery outlet refrigerant temperature sensor 43, the heat-exhausting device inlet refrigerant temperature sensor 44, the heat-exhausting device outlet refrigerant temperature sensor 45, the first heat-generating component inlet refrigerant temperature sensor 46, the first heat-generating component outlet refrigerant temperature sensor 47, and the second heat-generating component outlet refrigerant temperature sensor 48.

Subsequently, the control proceeds to step S1002, in which a battery heat generation amount Q_{BATT} [J] which is a heat generation amount of the solid-state battery 20, a battery heat absorption amount Q_{A} [J] which is a heat absorption amount of the refrigerant W from the solid-state battery 20, a first heat-generating component heat absorption amount Q_{B} [J] which is a heat absorption amount of the refrigerant W from the first heat-generating component 81, a second heat-generating component heat absorption amount Q_{C} [J] which is a heat absorption amount of the refrigerant W from the second heat-generating component 82, and a heat-exhausting device heat exhaust amount Q_{EX} [J] of the refrigerant W in the heat-exhausting device 30 are acquired by calculation.

The battery heat generation amount Q_{BATT} is calculated using the above-described equation (1) as in the first example of the control flow of the battery control device according to the first embodiment.

The battery heat absorption amount Q_{A} is calculated using the above-described equation (2) as in the first example of the control flow of the battery control device according to the first embodiment.

The first heat-generating component heat absorption amount Q_{B} is calculated based on the first heat-generating component inlet refrigerant temperature T_{W_B_IN}, the first heat-generating component outlet refrigerant temperature T_{W_B_OUT}, a mass flow rate qₘ [g/s] of the refrigerant W, and a specific heat c_{L} [J/g·K] of the refrigerant W. Specifically, the first heat-generating component heat absorption amount Q_{B} is calculated using the following equation (18).

$${Q}_{B} = ( {T}_{W \_ B \_ OUT} - {T}_{W \_ B \_ IN} ) \times {q}_{m} \times {c}_{L} \times Δ t \qquad ( 18 )$$

The mass flow rate qₘ [g/s] of the refrigerant W is calculated using the above-described equation (3) as in the first example of the control flow in the battery control device according to the first embodiment.

The second heat-generating component heat absorption amount Q_{C} is calculated based on the first heat-generating component outlet refrigerant temperature T_{W_B_OUT}, the second heat-generating component outlet refrigerant temperature T_{W_C_OUT}, a mass flow rate qₘ [g/s] of the refrigerant W, and a specific heat c_{L} [J/g·K] of the refrigerant W. Specifically, the second heat-generating component heat absorption amount Q_{C} is calculated using the following equation (19).

$${Q}_{B} = ( {T}_{W \_ C \_ OUT} - {T}_{W \_ B \_ OUT} ) \times {q}_{m} \times {c}_{L} \times Δ t \qquad ( 19 )$$

The mass flow rate qₘ [g/s] of the refrigerant W is calculated using the above-described equation (3) as in the first example of the control flow in the battery control device according to the first embodiment.

The heat-exhausting device heat exhaust amount Q_{EX} is calculated using the above-described equation (4) as in the first example of the control flow of the battery control device according to the first embodiment.

As described above, the battery heat absorption amount Q_{A} is calculated based on the battery inlet refrigerant temperature T_{W_BATT_IN}, the battery outlet refrigerant temperature T_{W_BATT_OUT}, the mass flow rate qₘ [g/s] of the refrigerant W, and the specific heat c_{L} [J/g·K] of the refrigerant W. The first heat-generating component heat absorption amount Q_{B} is calculated based on the first heat-generating component outlet refrigerant temperature T_{W_B_OUT}, the second heat-generating component outlet refrigerant temperature T_{W_C_OUT}, the mass flow rate qₘ [g/s] of the refrigerant W, and the specific heat c_{L} [J/g·K] of the refrigerant W. The second heat-generating component heat absorption amount Q_{C} is calculated based on the first heat-generating component outlet refrigerant temperature T_{W_B_OUT}, the second heat-generating component outlet refrigerant temperature T_{W_C_OUT}, the mass flow rate qₘ [g/s] of the refrigerant W, and the specific heat c_{L} [J/g·K] of the refrigerant W. The heat-exhausting device heat exhaust amount Q_{EX} is calculated based on the heat-exhausting device inlet refrigerant temperature T_{W_EX_IN}, the heat-exhausting device outlet refrigerant temperature T_{W_EX_OUT}, the mass flow rate qₘ [g/s] of the refrigerant W. and the specific heat c_{L} [J/g·K] of the refrigerant W.

Accordingly, by detecting the temperature of the refrigerant W at each position in the cooling circuit 40, the battery heat absorption amount Q_{A}, the first heat-generating component heat absorption amount Q_{B}, the second heat-generating component heat absorption amount Q_{C}, and the heat-exhausting device heat exhaust amount Q_{EX} can be accurately acquired by calculation with a simple method.

Subsequently, the control proceeds to step S1003, in which it is determined whether the battery temperature T_{BATT} acquired in step S1001 exceeds a preset output limitation starting temperature Tₛ [° C.] If the battery temperature T_{BATT} exceeds the output limitation starting temperature Tₛ (step S1003: YES), the control proceeds to step S1004. If the battery temperature T_{BATT} does not exceed the output limitation starting temperature Tₛ, that is, the battery temperature T_{BATT} is equal to or lower than the output limitation starting temperature Tₛ (step S1003: NO), the control proceeds to step S4000 to be described later.

In step S1004, it is determined whether the battery heat generation amount Q_{BATT} calculated in step S1002 is larger than the battery heat absorption amount Q_{A}. If the battery heat generation amount Q_{BATT} is larger than the battery heat absorption amount Q_{A} (step S1004: YES), the control proceeds to step S1005. If the battery heat generation amount Q_{BATT} is not larger than the battery heat absorption amount Q_{A}, that is, the battery heat generation amount Q_{BATT} is equal to or smaller than the battery heat absorption amount Q_{A} (step S1004: NO), the control proceeds to step S2001.

In step S1005, anew permitted current value I_{NEW} [A] is calculated based on a permitted current value I_{MAP} [A] that has been permitted for the solid-state battery 20 in the related art, and an output current I_{BATT} [A] of the solid-state battery 20 is controlled to become the new permitted current value I_{NEW} [A]. The new permitted current value I_{NEW} is calculated using the following equation (20).

$${I}_{NEW} = {I}_{MAP} \times P 10 \qquad ( 20 )$$

Note that P10 is a predetermined value that satisfies 0<P10<1.

Subsequently, the control proceeds to step S1006, in which the permitted current value I_{MAP} is updated to the new permitted current value I_{NEW} calculated in step S1005 and stored in the control storage unit 51.

Subsequently, the control proceeds to step S1007, the battery temperature T_{BATT}, the battery inlet refrigerant temperature T_{W_BATT_IN}, the battery outlet refrigerant temperature T_{W_BATT_OUT}, the heat-exhausting device inlet refrigerant temperature T_{W_EX_IN}, the heat-exhausting device outlet refrigerant temperature T_{W_EX_OUT}, the first heat-generating component inlet refrigerant temperature T_{W_B_IN}, the first heat-generating component outlet refrigerant temperature T_{W_B_OUT}, and the second heat-generating component outlet refrigerant temperature T_{W_C_OUT} are acquired again.

Subsequently, the control proceeds to step S1008, in which based on the battery temperature T_{BATT}, the battery inlet refrigerant temperature T_{W_BATT_IN}, the battery outlet refrigerant temperature T_{W_BATT_OUT}, the heat-exhausting device inlet refrigerant temperature T_{W_EX_IN}, the heat-exhausting device outlet refrigerant temperature T_{W_EX_OUT}, the first heat-generating component inlet refrigerant temperature T_{W_B_IN}, the first heat-generating component outlet refrigerant temperature T_{W_B_OUT}, and the second heat-generating component outlet refrigerant temperature T_{W_C_OUT}, which are acquired in step S1007, the battery heat generation amount Q_{BATT}, the battery heat absorption amount Q_{A}, the first heat-generating component heat absorption amount Q_{B}, the second heat-generating component heat absorption amount Q_{C}, and the heat-exhausting device heat exhaust amount Q_{EX} are acquired by calculation, and the battery heat generation amount Q_{BATT}, the battery heat absorption amount Q_{A}, the first heat-generating component heat absorption amount Q_{B}, the second heat-generating component heat absorption amount Q_{C}, and the heat-exhausting device heat exhaust amount Q_{EX} are updated and stored in the control storage unit 51.

Subsequently, the control proceeds to step S1009, in which it is determined whether the battery temperature T_{BATT} acquired in step S1007 exceeds the preset output limitation starting temperature T_{S}. If the battery temperature T_{BATT} exceeds the output limitation starting temperature Tₛ (step S1009: YES), the control proceeds to step S1010. If the battery temperature T_{BATT} does not exceed the output limitation starting temperature Tₛ, that is, the battery temperature T_{BATT} is equal to or lower than the output limitation starting temperature Tₛ (step S1009: NO), the control proceeds to step S4000 to be described later.

In step S1010, it is determined whether the battery heat generation amount Q_{BATT} calculated in step S1008 is equal to the battery heat absorption amount Q_{A}. If the battery heat generation amount Q_{BATT} calculated in step S1008 is not equal to the battery heat absorption amount Q_{A} (step S1010: NO), the control returns to step S1005 to repeat steps S1005 to S1010. If the battery heat generation amount Q_{BATT} calculated in step S1008 is equal to the battery heat absorption amount Q_{A} (step S1010: YES), the control proceeds to step S2001.

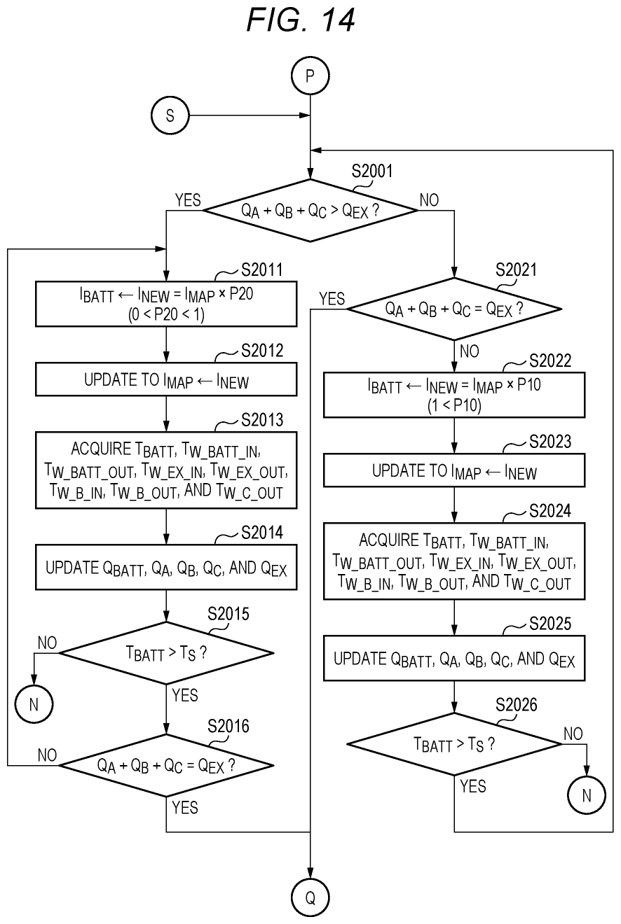

As shown in FIG. 14, in step S2001, based on the latest battery heat generation amount Q_{BATT}, the latest battery heat absorption amount Q_{A}, the latest first heat-generating component heat absorption amount Q_{B}, the latest second heat-generating component heat absorption amount Q_{C}, and the latest heat-exhausting device heat exhaust amount Q_{EX}, which are acquired by calculation in step S1002 or step S1008, it is determined whether a sum of the battery heat absorption amount Q_{A}, the first heat-generating component heat absorption amount Q_{B}, and the second heat-generating component heat absorption amount Q_{C} is larger than the heat-exhausting device heat exhaust amount Q_{EX}. If the sum of the battery heat absorption amount Q_{A}, the first heat-generating component heat absorption amount Q_{B}, and the second heat-generating component heat absorption amount Q_{C} is larger than the heat-exhausting device heat exhaust amount Q_{EX} (step S2001: YES), the control proceeds to step S2011. If the sum of the battery heat absorption amount Q_{A}, the first heat-generating component heat absorption amount QR, and the second heat-generating component heat absorption amount Q_{C} is not larger than the heat-exhausting device heat exhaust amount Q_{EX}, that is, the battery heat generation amount Q_{BATT} is equal to or smaller than the heat-exhausting device heat exhaust amount Q_{EX} (step S2001: NO), the control proceeds to step S2021.

In step S2011, a new permitted current value I_{NEW} is calculated based on a permitted current value I_{MAP} that has been permitted for the solid-state battery 20 in the related art, and an output current I_{BATT} of the solid-state battery 20 is controlled to become the new permitted current value I_{NEW}. The new permitted current value I_{NEW} is calculated using the following equation (21).

$${I}_{NEW} = {I}_{MAP} \times P 20 \qquad ( 21 )$$

Note that P20 is a predetermined value that satisfies 0<P20<1.

Subsequently, the control proceeds to step S2012, in which the permitted current value I_{MAP} is updated to the new permitted current value I_{NEW} calculated in step S2011 and stored in the control storage unit 51.

Subsequently, the control proceeds to step S2013, the battery temperature T_{BATT}, the battery inlet refrigerant temperature T_{W_BATT_IN}, the battery outlet refrigerant temperature T_{W_BATT_OUT}, the heat-exhausting device inlet refrigerant temperature T_{W_EX_IN}, the heat-exhausting device outlet refrigerant temperature T_{W_EX_OUT}, the first heat-generating component inlet refrigerant temperature T_{W_B_IN}, the first heat-generating component outlet refrigerant temperature T_{W_B_OUT}, and the second heat-generating component outlet refrigerant temperature T_{W_C_OUT} are acquired again.

Subsequently, the control proceeds to step S2014, in which based on the battery temperature T_{BATT}, the battery inlet refrigerant temperature T_{W_BATT_IN}, the battery outlet refrigerant temperature T_{W_BATT_OUT}, the heat-exhausting device inlet refrigerant temperature T_{W_BATT_IN}, the heat-exhausting device outlet refrigerant temperature T_{W_EX_OUT}, the first heat-generating component inlet refrigerant temperature T_{W_B_IN}, the first heat-generating component outlet refrigerant temperature T_{W_B_OUT}, and the second heat-generating component outlet refrigerant temperature T_{W_C_OUT}, which are acquired in step S2013, the battery heat generation amount Q_{BATT}, the battery heat absorption amount Q_{A}, the first heat-generating component heat absorption amount Q_{B}, the second heat-generating component heat absorption amount Q_{C}, and the heat-exhausting device heat exhaust amount Q_{EX} are acquired by calculation, and the battery heat generation amount Q_{BATT}, the battery heat absorption amount Q_{A}, the first heat-generating component heat absorption amount Q_{B}, the second heat-generating component heat absorption amount Q_{C}, and the heat-exhausting device heat exhaust amount Q_{EX} are updated and stored in the control storage unit 51.

Subsequently, the control proceeds to step S2015, in which it is determined whether the battery temperature T_{BATT} acquired in step S2013 exceeds the output limitation starting temperature Tₛ. If the battery temperature T_{BATT} exceeds the output limitation starting temperature T_{S} (step S2015: YES), the control proceeds to step S2016. If the battery temperature T_{BATT} does not exceed the output limitation starting temperature T_{S}, that is, the battery temperature T_{BATT} is equal to or lower than the output limitation starting temperature T_{S} (step S2015: NO), the control proceeds to step S4000 to be described later.

In step S2016, it is determined whether the sum of the battery heat absorption amount Q_{A}, the first heat-generating component heat absorption amount Q_{B}, and the second heat-generating component heat absorption amount Q_{C}, which are calculated in step S2014, is equal to the heat-exhausting device heat exhaust amount Q_{EX}. If the sum of the battery heat absorption amount Q_{A}, the first heat-generating component heat absorption amount Q_{B}, and the second heat-generating component heat absorption amount Q_{C} is not equal to the heat-exhausting device heat exhaust amount Q_{EX} (step S2016: NO), the control returns to step S2011 to repeat steps S2011 to step S2016. If the sum of the battery heat absorption amount Q_{A}, the first heat-generating component heat absorption amount Q_{B}, and the second heat-generating component heat absorption amount Q_{C}, which are calculated in step S2014, is equal to the heat-exhausting device heat exhaust amount Q_{EX} (step S2016: YES), the control proceeds to step S3001.

On the other hand, in step S2021, based on the latest battery heat generation amount Q_{BATT}, the latest battery heat absorption amount Q_{A}, the latest first heat-generating component heat absorption amount Q_{B}, the latest second heat-generating component heat absorption amount Q_{C}, and the latest heat-exhausting device heat exhaust amount Q_{EX}, which are acquired by calculation in step S1002 or step S1008 and stored in the control storage unit 51, it is determined whether the sum of the battery heat absorption amount Q_{A}, the first heat-generating component heat absorption amount Q_{B}, and the second heat-generating component heat absorption amount Q_{C} is equal to the heat-exhausting device heat exhaust amount Q_{EX}. If the sum of the battery heat absorption amount Q_{A}, the first heat-generating component heat absorption amount Q_{B}, and the second heat-generating component heat absorption amount Q_{C} is equal to the heat-exhausting device heat exhaust amount Q_{EX} (step S2021: YES), the control proceeds to step S3001. If the sum of the battery heat absorption amount Q_{A}, the first heat-generating component heat absorption amount Q_{B}, and the second heat-generating component heat absorption amount Q_{C} is not equal to the heat-exhausting device heat exhaust amount Q_{EX} (step S2021: NO), the control proceeds to step S2022. In step S2021, in a case where it is determined that the sum of the battery heat absorption amount Q_{A}, the first heat-generating component heat absorption amount Q_{B}, and the second heat-generating component heat absorption amount Q_{C} is not equal to the heat-exhausting device heat exhaust amount Q_{EX} (step S2021. NO), the following conditions are satisfied that the sum of the battery heat absorption amount Q_{A}, the first heat-generating component heat absorption amount QR, and the second heat-generating component heat absorption amount Q_{C} is equal to or smaller than the heat-exhausting device heat exhaust amount Q_{EX} (step S2001: NO), and the sum of the battery heat absorption amount Q_{A}, the first heat-generating component heat absorption amount Q_{B}, and the second heat-generating component heat absorption amount Q_{C} is not equal to the heat-exhausting device heat exhaust amount Q_{EX} (step S2021: NO). Therefore, the sum of the battery heat absorption amount Q_{A}, the first heat-generating component heat absorption amount QR, and the second heat-generating component heat absorption amount Q_{C} is smaller than the heat-exhausting device heat exhaust amount Q_{EX}.

In step S2022, a new permitted current value I_{NEW} is calculated based on a permitted current value I_{MAP} that has been permitted for the solid-state battery 20 in the related art, and an output current T_{BATT} of the solid-state battery 20 is controlled to become the new permitted current value I_{NEW}. The new permitted current value I_{NEW} is calculated using the following equation (22).

$${I}_{NEW} = {I}_{MAP} \times P 10 \qquad ( 22 )$$

Note that P10 is a predetermined value that satisfies 1<P10.

Subsequently, the control proceeds to step S2023, in which the permitted current value I_{MAP} is updated to the new permitted current value I_{NEW} calculated in step S2022 and stored in the control storage unit 51.

Subsequently, the control proceeds to step S2024, the battery temperature T_{BATT}, the battery inlet refrigerant temperature T_{W_BATT_IN}, the battery outlet refrigerant temperature T_{W_BATT_OUT}, the heat-exhausting device inlet refrigerant temperature T_{W_EX_IN}, the heat-exhausting device outlet refrigerant temperature T_{W_EX_OUT}, the first heat-generating component inlet refrigerant temperature T_{W_B_IN}, the first heat-generating component outlet refrigerant temperature T_{W_B_OUT}, and the second heat-generating component outlet refrigerant temperature T_{W_C_OUT} are acquired again.

Subsequently, the control proceeds to step S2025, in which based on the battery temperature T_{BATT}, the battery inlet refrigerant temperature T_{W_BATT_IN}, the battery outlet refrigerant temperature T_{W_BATT_OUT}, the heat-exhausting device inlet refrigerant temperature T_{W_EX_IN}, the heat-exhausting device outlet refrigerant temperature T_{W_EX_OUT}, the first heat-generating component inlet refrigerant temperature T_{W_B_IN}, the first heat-generating component outlet refrigerant temperature T_{W_B_OUT}, and the second heat-generating component outlet refrigerant temperature T_{W_C_OUT}, which are acquired in step S2024, the battery heat generation amount Q_{BATT}, the battery heat absorption amount Q_{A}, the first heat-generating component heat absorption amount Q_{B}, the second heat-generating component heat absorption amount Q_{C}, and the heat-exhausting device heat exhaust amount Q_{EX} are acquired by calculation, and the battery heat generation amount Q_{BATT}, the battery heat absorption amount Q_{A}, the first heat-generating component heat absorption amount Q_{B}, the second heat-generating component heat absorption amount Q_{C}, and the heat-exhausting device heat exhaust amount Q_{EX} are updated and stored in the control storage unit 51.

Subsequently, the control proceeds to step S2026, in which it is determined whether the battery temperature T_{BATT} acquired in step S2024 exceeds the output limitation starting temperature T_{S}. If the battery temperature T_{BATT} exceeds the output limitation starting temperature T_{S} (step S2026: YES), the control returns to step S2001, and the processing of step S2001 and the subsequent steps is repeated until the sum of the battery heat absorption amount Q_{A}, the first heat-generating component heat absorption amount Q_{B}, and the second heat-generating component heat absorption amount Q_{C} is equal to the heat-exhausting device heat exhaust amount Q_{EX}. In step S2026, if the battery temperature T_{BATT} does not exceed the output limitation starting temperature T_{S}, that is, the battery temperature T_{BATT} is equal to or lower than the output limitation starting temperature T_{S} (step S2026: NO), the control proceeds to step S4000 to be described later.

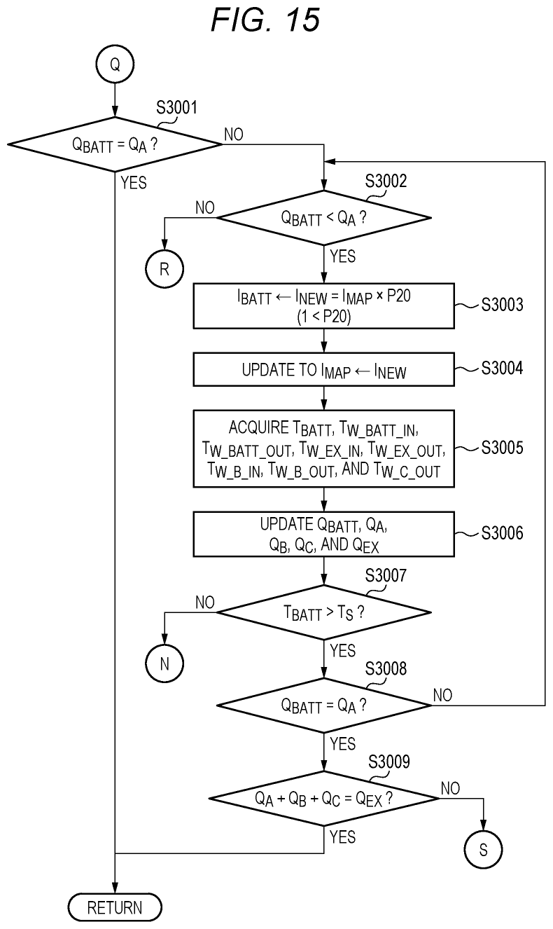

As shown in FIG. 15, in step S3001, it is determined whether the battery heat generation amount Q_{BATT} is equal to the battery heat absorption amount Q_{A} based on the latest battery heat generation amount Q_{BATT}, the latest battery heat absorption amount Q_{A}, the latest first heat-generating component heat absorption amount Q_{B}, the latest second heat-generating component heat absorption amount Q_{C}, and the latest heat-exhausting device heat exhaust amount Q_{EX}, which are stored in the control storage unit 51 and acquired by calculation in any of step S1002, S1008, S2014, and S2025.

In step S3001, if the battery heat generation amount Q_{BATT} is equal to the battery heat absorption amount Q_{A} (step S3001: YES), a series of controls ends. The control returns to the start, and the battery control device 50 repeats the series of controls.

In a case where the battery heat generation amount Q_{BATT} is equal to the battery heat absorption amount Q_{A} in step S3001 (step S3001: YES), with respect to the latest battery heat generation amount Q_{BATT}, the latest battery heat absorption amount Q_{A}, the latest first heat-generating component heat absorption amount Q_{B}, the latest second heat-generating component heat absorption amount Q_{C}, and the latest heat-exhausting device heat exhaust amount Q_{EX}, which are stored in the control storage unit 51 and acquired by calculation in any of step S1002, S1008, S2014, and S2025, the following conditions are satisfied that the sum of the battery heat absorption amount Q_{A}, the first heat-generating component heat absorption amount Q_{B}, and the second heat-generating component heat absorption amount Q_{C} is equal to the heat-exhausting device heat exhaust amount Q_{EX} (step S2016: YES, step S2021: YES), and the battery heat generation amount Q_{BATT} is equal to the battery heat absorption amount Q_{A} (step S3001: YES).

On the other hand, in step S3001, if the battery heat generation amount Q_{BATT} is not equal to the battery heat absorption amount Q_{A} (step S3001: NO), the control proceeds to step S3002.

In step S3002, it is determined whether the battery heat generation amount Q_{BATT} is smaller than the battery heat absorption amount Q_{A} based on the latest battery heat generation amount Q_{BATT}, the latest battery heat absorption amount Q_{A}, the latest first heat-generating component heat absorption amount Q_{B}, the latest second heat-generating component heat absorption amount Q_{C}, and the latest heat-exhausting device heat exhaust amount Q_{EX}, which are stored in the control storage unit 51 and acquired by calculation in any of step S1002, S1008, S2014, and S2025. If the battery heat generation amount Q_{BATT} is smaller than the battery heat absorption amount Q_{A} (step S3002: YES), the control proceeds to step S3003, and if the battery heat generation amount Q_{BATT} is not smaller than the battery heat absorption amount Q_{A} (step S3002: NO), the control returns to step S1005. In a case w % here it is determined in step S3002 that the battery heat generation amount Q_{BATT} is not smaller than the battery heat absorption amount Q_{A} (step S3002: NO), the following conditions are satisfied that the battery heat generation amount Q_{A}T_{BATT} is not equal to the battery heat absorption amount Q_{A} (step S3001: NO) and the battery heat generation amount Q_{BATT} is not smaller than the battery heat absorption amount Q_{A} (step S3002: NO). Therefore, the battery heat generation amount Q_{BATT} is larger than the battery heat absorption amount Q_{A}.

In step S3003, a new permitted current value I_{NEW} is calculated based on a permitted current value I_{MAP} that has been permitted for the solid-state battery 20 in the related art, and an output current I_{BATT} of the solid-state battery 20 is controlled to become the new permitted current value I_{NEW}. The new permitted current value I_{NEW} is calculated using the following equation (23).

$${I}_{NEW} = {I}_{MAP} \times P 20 \qquad ( 23 )$$

Note that P20 is a predetermined value that satisfies 1<P20.

Subsequently, the control proceeds to step S3004, in which the permitted current value I_{MAP} is updated to the new permitted current value I_{NEW} calculated in step S3003 and stored in the control storage unit 51.

Subsequently, the control proceeds to step S3005, the battery temperature T_{BATT}, the battery inlet refrigerant temperature T_{W_BATT_IN}, the battery outlet refrigerant temperature T_{W_BATT_OUT}, the heat-exhausting device inlet refrigerant temperature T_{W_EX_IN}, the heat-exhausting device outlet refrigerant temperature T_{W_EX_OUT}, the first heat-generating component inlet refrigerant temperature T_{W_B_IN}, the first heat-generating component outlet refrigerant temperature T_{W_B_OUT}, and the second heat-generating component outlet refrigerant temperature T_{W_C_OUT} are acquired again.

Subsequently, the control proceeds to step S3006, in which based on the battery temperature T_{BATT}, the battery inlet refrigerant temperature T_{W_BATT_IN}, the battery outlet refrigerant temperature T_{W_BATT_OUT}, the heat-exhausting device inlet refrigerant temperature T_{W_EX_IN}, the heat-exhausting device outlet refrigerant temperature T_{W_EX_OUT}, the first heat-generating component inlet refrigerant temperature T_{W_B_IN}, the first heat-generating component outlet refrigerant temperature T_{W_B_OUT}, and the second heat-generating component outlet refrigerant temperature T_{W_C_OUT}, which are acquired in step S3005, the battery heat generation amount Q_{BATT}, the battery heat absorption amount Q_{A}, the first heat-generating component heat absorption amount Q_{B}, the second heat-generating component heat absorption amount Q_{C}, and the heat-exhausting device heat exhaust amount Q_{EX} are acquired by calculation, and the battery heat generation amount Q_{BATT}, the battery heat absorption amount Q_{A}, the first heat-generating component heat absorption amount Q_{B}, the second heat-generating component heat absorption amount Q_{C}, and the heat-exhausting device heat exhaust amount Q_{EX} are updated and stored in the control storage unit 51.

Subsequently, the control proceeds to step S3007, in which it is determined whether the battery temperature T_{BATT} acquired in step S3005 exceeds the output limitation starting temperature T_{S}. If the battery temperature T_{BATT} exceeds the output limitation starting temperature T_{S} (step S3007: YES), the control proceeds to step S3008. If the battery temperature T_{BATT} does not exceed the output limitation starting temperature T_{S}, that is, the battery temperature T_{BATT} is equal to or lower than the output limitation starting temperature T_{S} (step S3007: NO), the control proceeds to step S4000 to be described later.

In step S3008, it is determined whether the battery heat generation amount Q_{BATT} calculated in step S3006 is equal to the battery heat absorption amount Q_{A}. If the battery heat generation amount Q_{BATT} is not equal to the battery heat absorption amount Q_{A} (step S3008: NO), the control returns to step S3002 to repeat steps S3002 to S3008. If the battery heat generation amount Q_{BATT} calculated in step S3006 is equal to the battery heat absorption amount Q_{A} (step S3008: YES), the control proceeds to step S3009.

In step S3009, it is determined whether the sum of the battery heat absorption amount Q_{A}, the first heat-generating component heat absorption amount Q_{B}, and the second heat-generating component heat absorption amount Q_{C}, which are calculated in step S3006, is equal to the heat-exhausting device heat exhaust amount Q_{EX}. If the sum of the battery heat absorption amount Q_{A}, the first heat-generating component heat absorption amount Q_{B}, and the second heat-generating component heat absorption amount Q_{C} is not equal to the heat-exhausting device heat exhaust amount Q_{EX} (step S3009: NO), the control returns to step S2001.

In step S3009, if the sum of the battery heat absorption amount Q_{A}, the first heat-generating component heat absorption amount Q_{B}, and the second heat-generating component heat absorption amount Q_{C} is equal to the heat-exhausting device heat exhaust amount Q_{EX} (step S3009: YES), the series of controls ends. The control returns to the start, and the battery control device 50 repeats the series of controls.

In a case where the sum of the battery heat absorption amount Q_{A}, the first heat-generating component heat absorption amount Q_{B}, and the second heat-generating component heat absorption amount Q_{C} is equal to the heat-exhausting device heat exhaust amount Q_{EX} (step S3009: YES) in step S3009, with respect to the battery heat generation amount Q_{BATT}, the battery heat absorption amount Q_{A}, the first heat-generating component heat absorption amount Q_{B}, the second heat-generating component heat absorption amount Q_{C}, and the heat-exhausting device heat exhaust amount Q_{EX}, which are calculated in step S3006, the following conditions are satisfied that the battery heat generation amount Q_{BATT} is equal to the battery heat absorption amount Q_{A} (step S3008: YES), and the sum of the battery heat absorption amount Q_{A}, the first heat-generating component heat absorption amount Q_{B}, and the second heat-generating component heat absorption amount Q_{C} is equal to the heat-exhausting device heat exhaust amount Q_{EX} (step S3009: YES).

As described above, in the series of controls, when the battery temperature T_{BATT} exceeds the predetermined output limitation starting temperature T_{S}, the battery control device 50 controls the output current I_{BATT} of the solid-state battery 20 such that the battery heat generation amount Q_{BATT} and the battery heat absorption amount Q_{A} are equal to each other and the sum of the battery heat absorption amount Q_{A}, the first heat-generating component heat absorption amount Q_{B}, and the second heat-generating component heat absorption amount Q_{C} is equal to the heat-exhausting device heat exhaust amount Q_{EX}.

When the battery heat generation amount Q_{BATT} and the battery heat absorption amount Q_{A} are equal to each other, and the sum of the battery heat absorption amount Q_{A}, the first heat-generating component heat absorption amount Q_{B}, and the second heat-generating component heat absorption amount Q_{C} is equal to the heat-exhausting device heat exhaust amount Q_{EX}, the battery temperature T_{BATT} is kept constant without increasing or decreasing. In this way, the battery control device 50 controls the battery temperature T_{BATT} to be equal to or higher than the output limitation starting temperature T_{S} and lower than a predetermined output permission upper-limit temperature T_{LIM} [° C.] which is an upper-limit temperature at which the solid-state battery 20 is permitted to output power. An output permission upper-limit temperature T_{LIM} is set in advance according to battery characteristics of the solid-state battery 20, and is stored in the control storage unit 51.

Accordingly, even in a case where the battery temperature T_{BATT} of the solid-state battery 20 exceeds the output limitation starting temperature T_{S}, the solid-state battery 20 can be used while the battery temperature T_{BATT} of the solid-state battery 20 is prevented from reaching the output permission upper-limit temperature T_{LIM}. Therefore, it is possible to prevent the output from the solid-state battery 20 from being suddenly limited, and to maintain stable output from the solid-state battery 20.

In the series of controls described above, in a case where the battery heat generation amount Q_{BATT} is larger than the battery heat absorption amount Q_{A} when the battery temperature T_{BATT} of the solid-state battery 20 is equal to or higher than the output limitation starting temperature T_{S}, the output current I_{BATT} of the solid-state battery 20 is limited to the new permitted current value I_{NEW}. Thereafter, the battery heat generation amount Q_{BATT}, the battery heat absorption amount Q_{A}, the first heat-generating component heat absorption amount Q_{B}, the second heat-generating component heat absorption amount Q_{C}, and the heat-exhausting device heat exhaust amount Q_{EX} are updated. Based on the updated the battery heat generation amount Q_{BATT}, the updated battery heat absorption amount Q_{A}, the updated first heat-generating component heat absorption amount Q_{B}, the updated second heat-generating component heat absorption amount Q_{C}, and the updated heat-exhausting device heat exhaust amount Q_{EX}, the output current I_{BATT} and the permitted current value I_{MAP} of the solid-state battery 20 are subjected to feedback control such that the battery heat generation amount Q_{BATT} and the battery heat absorption amount Q_{A} are equal to each other and the sum of the battery heat absorption amount Q_{A}, the first heat-generating component heat absorption amount Q_{B}, and the second heat-generating component heat absorption amount Q_{C} is equal to the heat-exhausting device heat exhaust amount Q_{EX}.

Accordingly, the battery heat generation amount Q_{BATT} and the battery heat absorption amount Q_{A} in an actual use environment can be equal to each other, and the output current I_{BATT} of the solid-state battery 20 can be subjected to feedback control in accordance with the sum of the battery heat absorption amount Q_{A}, the first heat-generating component heat absorption amount Q_{B}, and the second heat-generating component heat absorption amount Q_{C}, and the heat-exhausting device heat exhaust amount Q_{EX}. Therefore, in the actual use environment, the output current I_{BATT} of the solid-state battery 20 can be controlled such that the battery heat generation amount Q_{BATT} is equal to the battery heat absorption amount Q_{A} and the sum of the battery heat absorption amount Q_{A}, the first heat-generating component heat absorption amount Q_{B}, and the second heat-generating component heat absorption amount Q_{C} is equal to the heat-exhausting device heat exhaust amount Q_{EX}, and the battery temperature T_{BATT} can be kept constant.

On the other hand, as described above, in step S1003, S1009, S2015, S2026, and S3007, if the battery temperature T_{BATT} does not exceed the output limitation starting temperature T_{S}, that is, the battery temperature T_{BATT} is equal to or lower than the output limitation starting temperature T_{S}, the control proceeds to step S4000.

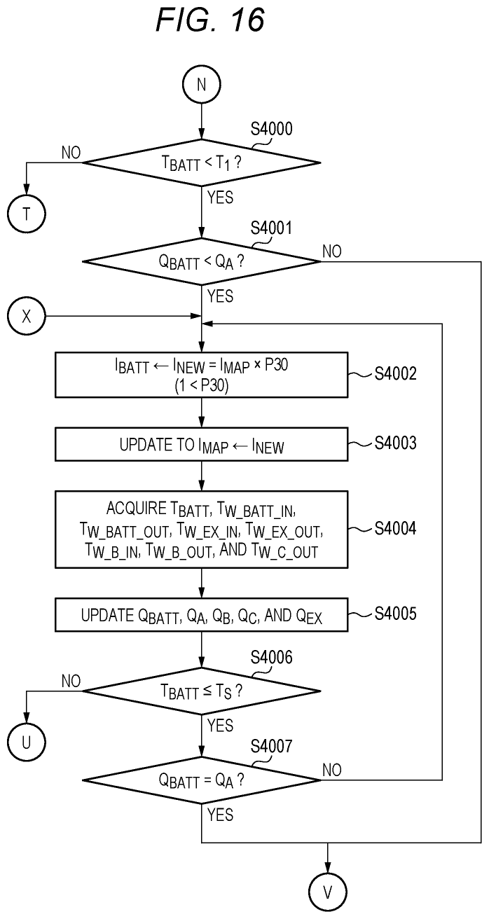

As shown in FIG. 16, in step S4000, it is determined whether the battery temperature T_{BATT} is lower than a predetermined first threshold temperature T₁ [° C.]. The predetermined first threshold temperature T₁ is set to a temperature lower than the output limitation starting temperature T_{S}, and is stored in the control storage unit 51 in advance. If the battery temperature T_{BATT} is lower than the first threshold temperature T₁ (step S4000: YES), the control proceeds to step S4001. If the battery temperature T_{BATT} is not lower than the first threshold temperature T₁, that is, the battery temperature T_{BATT} is equal to or higher than the first threshold temperature T₁ (step S4000: NO), the series of controls ends. The control returns to the start, and the battery control device 50 repeats the series of controls.

In step S4001, it is determined whether the latest battery heat generation amount Q_{BATT} stored in the control storage unit 51 is smaller than the battery heat absorption amount Q_{A}. If the battery heat generation amount Q_{BATT} is smaller than the battery heat absorption amount Q_{A} (step S4001: YES), the control proceeds to step S4002. If the battery heat generation amount Q_{BATT} is not smaller than the battery heat absorption amount Q_{A}, that is, the battery heat generation amount Q_{BATT} is equal to or larger than the battery heat absorption amount Q_{A} (step S4001: NO), the control proceeds to step S5001.

In step S4002, a new permitted current value I_{NEW} is calculated based on a permitted current value I_{MAP} that has been permitted for the solid-state battery 20 in the related art, and an output current I_{BATT} of the solid-state battery 20 is controlled to become the new permitted current value I_{NEW}. The new permitted current value I_{NEW} is calculated using the following equation (24).

$${I}_{NEW} = {I}_{MAP} \times P 30 \qquad ( 24 )$$

Note that P30 is a predetermined value that satisfies 1<P30.

Subsequently, the control proceeds to step S4003, in which the permitted current value I_{MAP} is updated to the new permitted current value I_{NEW} calculated in step S4002 and stored in the control storage unit 51.

Subsequently, the control proceeds to step S4004, the battery temperature Tax-r, the battery inlet refrigerant temperature T_{W_BATT_IN}, the battery outlet refrigerant temperature T_{W_BATT_OUT}, the heat-exhausting device inlet refrigerant temperature T_{W_EX_IN}, the heat-exhausting device outlet refrigerant temperature T_{W_EX_OUT}, the first heat-generating component inlet refrigerant temperature T_{W_B_IN}, the first heat-generating component outlet refrigerant temperature T_{W_B_OUT}, and the second heat-generating component outlet refrigerant temperature T_{W_C_OUT} are acquired again.

Subsequently, the control proceeds to step S4005, in which based on the battery temperature T_{BATT}, the battery inlet refrigerant temperature T_{W_BATT_IN}, the battery outlet refrigerant temperature T_{W_BATT_OUT}, the heat-exhausting device inlet refrigerant temperature T_{W_EX_IN}, the heat-exhausting device outlet refrigerant temperature T_{W_EX_OUT}, the first heat-generating component inlet refrigerant temperature T_{W_B_IN}, the first heat-generating component outlet refrigerant temperature T_{W_B_OUT}, and the second heat-generating component outlet refrigerant temperature T_{W_C_OUT}, which are acquired in step S4004, the battery heat generation amount Q_{BATT}, the battery heat absorption amount Q_{A}, the first heat-generating component heat absorption amount Q_{B}, the second heat-generating component heat absorption amount Q_{C}, and the heat-exhausting device heat exhaust amount Q_{EX} are acquired by calculation, and the battery heat generation amount Q_{BATT}, the battery heat absorption amount Q_{A}, the first heat-generating component heat absorption amount Q_{B}, the second heat-generating component heat absorption amount Q_{C}, and the heat-exhausting device heat exhaust amount Q_{EX} are updated and stored in the control storage unit 51.

Subsequently, the control proceeds to step S4006, in which it is determined whether the battery temperature T_{BATT} acquired in step S4004 is equal to or lower than the preset output limitation starting temperature T_{S}. If the battery temperature T_{BATT} is equal to or lower than the output limitation starting temperature T_{S} (step S4006: YES), the control proceeds to step S4007. If the battery temperature T_{BATT} is not equal to or lower than the output limitation starting temperature T_{S}, that is, the battery temperature T_{BATT} exceeds the output limitation starting temperature T_{S} (step S4006. NO), the control proceeds to step S1004 described above.

In step S4007, it is determined whether the battery heat generation amount Q_{BATT} calculated in step S4005 is equal to the battery heat absorption amount Q_{A}. If the battery heat generation amount Q_{BATT} calculated in step S4005 is not equal to the battery heat absorption amount Q_{A} (step S4005: NO), the control returns to step S4002 to repeat steps S4002 to S4007. If the battery heat generation amount Q_{BATT} calculated in step S4005 is equal to the battery heat absorption amount Q_{A} (step S4007: YES), the control proceeds to step S5001.

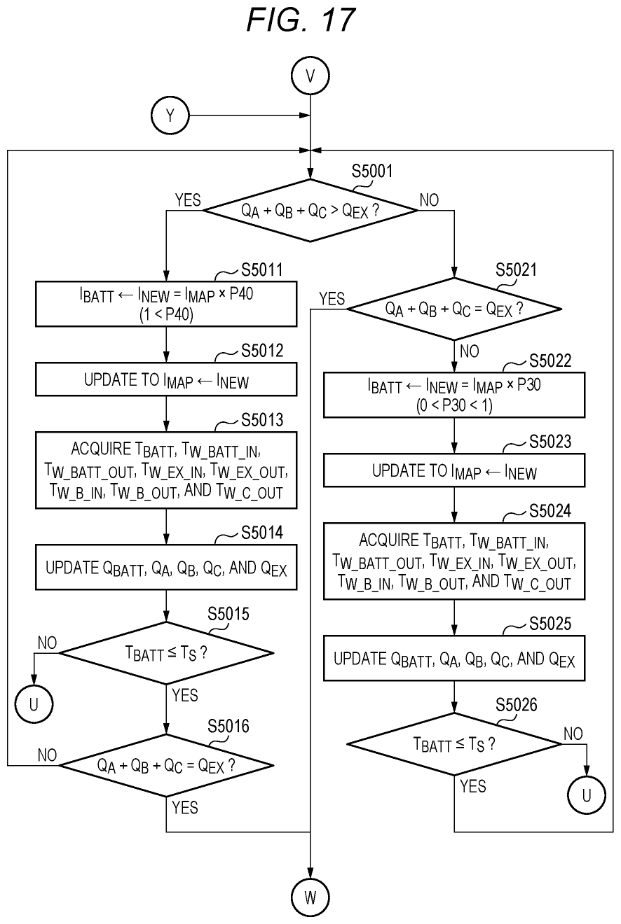

As shown in FIG. 17, in step S5001, based on the latest battery heat generation amount Q_{BATT}, the latest battery heat absorption amount Q_{A}, the latest first heat-generating component heat absorption amount Q_{B}, the latest second heat-generating component heat absorption amount Q_{C}, and the latest heat-exhausting device heat exhaust amount Q_{EX}, which are stored in the control storage unit 51, it is determined whether the sum of the battery heat absorption amount Q_{A}, the first heat-generating component heat absorption amount Q_{B}, and the second heat-generating component heat absorption amount Q_{C} is smaller than the heat-exhausting device heat exhaust amount Q_{EX}. If the sum of the battery heat absorption amount Q_{A}, the first heat-generating component heat absorption amount Q_{B}, and the second heat-generating component heat absorption amount Q_{C} is smaller than the heat-exhausting device heat exhaust amount Q_{EX} (step S5001: YES), the control proceeds to step S5011. If the sum of the battery heat absorption amount Q_{A}, the first heat-generating component heat absorption amount Q_{B}, and the second heat-generating component heat absorption amount Q_{C} is not smaller than the heat-exhausting device heat exhaust amount Q_{EX}, that is, the sum of the battery heat absorption amount Q_{A}, the first heat-generating component heat absorption amount Q_{B}, and the second heat-generating component heat absorption amount Q_{C} is equal to or larger than the heat-exhausting device heat exhaust amount Q_{EX} (step S5001: NO), the control proceeds to step S5021.

In step S5011, a new permitted current value I_{NEW} is calculated based on a permitted current value I_{MAP} that has been permitted for the solid-state battery 20 in the related art, and an output current I_{BATT} of the solid-state battery 20 is controlled to become the new permitted current value I_{NEW}. The new permitted current value I_{NEW} is calculated using the following equation (25).

$${I}_{NEW} = {I}_{MAP} \times P 40 \qquad ( 25 )$$

Note that 600 is a predetermined value that satisfies 1<P40.

Subsequently, the control proceeds to step S5012, in which the permitted current value I_{MAP} is updated to the new permitted current value I_{NEW} calculated in step S5011 and stored in the control storage unit 51.

Subsequently, the control proceeds to step S5013, the battery temperature T_{BATT}, the battery inlet refrigerant temperature T_{W_BATT_IN}, the battery outlet refrigerant temperature T_{W_BATT_OUT}, the heat-exhausting device inlet refrigerant temperature T_{W_EX_IN}, the heat-exhausting device outlet refrigerant temperature T_{W_EX_OUT}, the first heat-generating component inlet refrigerant temperature T_{W_B_IN}, the first heat-generating component outlet refrigerant temperature T_{W_B_OUT}, and the second heat-generating component outlet refrigerant temperature T_{W_C_OUT} are acquired again.

Subsequently, the control proceeds to step S5014, in which based on the battery temperature T_{BATT}, the battery inlet refrigerant temperature T_{W_BATT_IN}, the battery outlet refrigerant temperature T_{W_BATT_OUT}, the heat-exhausting device inlet refrigerant temperature T_{W_EX_IN}, the heat-exhausting device outlet refrigerant temperature T_{W_EX_OUT}, the first heat-generating component inlet refrigerant temperature T_{W_B_IN}, the first heat-generating component outlet refrigerant temperature T_{W_B_OUT}, and the second heat-generating component outlet refrigerant temperature T_{W_C_OUT}, which are acquired in step S5013, the battery heat generation amount Q_{BATT}, the battery heat absorption amount Q_{A}, the first heat-generating component heat absorption amount Q_{B}, the second heat-generating component heat absorption amount Q_{C}, and the heat-exhausting device heat exhaust amount Q_{EX} are acquired by calculation, and the battery heat generation amount Q_{BATT}, the battery heat absorption amount Q_{A}, the first heat-generating component heat absorption amount Q_{B}, the second heat-generating component heat absorption amount Q_{C}, and the heat-exhausting device heat exhaust amount Q_{EX} are updated and stored in the control storage unit 51.

Subsequently, the control proceeds to step S5015, in which it is determined whether the battery temperature T_{BATT} acquired in step S5013 is equal to or lower than the output limitation starting temperature T_{S}. If the battery temperature T_{BATT} is equal to or lower than the output limitation starting temperature T_{S} (step S5015: YES), the control proceeds to step S5016. If the battery temperature T_{BATT} is not equal to or lower than the output limitation starting temperature T_{S}, that is, the battery temperature T_{BATT} exceeds the output limitation starting temperature T_{S} (step S5015: NO), the control proceeds to step S1004 described above.

In step S5016, it is determined whether the sum of the battery heat absorption amount Q_{A}, the first heat-generating component heat absorption amount Q_{B}, and the second heat-generating component heat absorption amount Q_{C}, which are calculated in step S5014, is equal to the heat-exhausting device heat exhaust amount Q_{EX}. If the sum of the battery heat absorption amount Q_{A}, the first heat-generating component heat absorption amount Q_{B}, and the second heat-generating component heat absorption amount Q_{C} is not equal to the heat-exhausting device heat exhaust amount Q_{EX} (step S5016: NO), the control returns to step S5001 to repeat the processing of step S5001 and the subsequent steps. If the sum of the battery heat absorption amount Q_{A}, the first heat-generating component heat absorption amount Q_{B}, and the second heat-generating component heat absorption amount Q_{C}, which are calculated in step S5014, is equal to the heat-exhausting device heat exhaust amount Q_{EX} (step S5016: YES), the control proceeds to step S6001.

On the other hand, in step S5021, based on the latest battery heat generation amount Q_{BATT}, the latest battery heat absorption amount Q_{A}, the latest first heat-generating component heat absorption amount Q_{B}, the latest second heat-generating component heat absorption amount Q_{C}, and the latest heat-exhausting device heat exhaust amount Q_{EX}, which are stored in the control storage unit 51, it is determined whether the sum of the battery heat absorption amount Q_{A}, the first heat-generating component heat absorption amount Q_{B}, and the second heat-generating component heat absorption amount Q_{C} is equal to the heat-exhausting device heat exhaust amount Q_{EX}. If the sum of the battery heat absorption amount Q_{A}, the first heat-generating component heat absorption amount Q_{B}, and the second heat-generating component heat absorption amount Q_{C} is equal to the heat-exhausting device heat exhaust amount Q_{EX} (step S5021: YES), the control proceeds to step S6001. If the sum of the battery heat absorption amount Q_{A}, the first heat-generating component heat absorption amount Q_{B}, and the second heat-generating component heat absorption amount Q_{C} is not equal to the heat-exhausting device heat exhaust amount Q_{EX} (step S5021: NO), the control proceeds to step S5022. In step S5021, in a case where it is determined that the sum of the battery heat absorption amount Q_{A}, the first heat-generating component heat absorption amount Q_{B}, and the second heat-generating component heat absorption amount Q_{C} is not equal to the heat-exhausting device heat exhaust amount Q_{EX} (step S5021: NO), the following conditions are satisfied that the sum of the battery heat absorption amount Q_{A}, the first heat-generating component heat absorption amount Q_{B}, and the second heat-generating component heat absorption amount Q_{C} is equal to or larger than the heat-exhausting device heat exhaust amount Q_{EX} (step S2001: NO), and the sum of the battery heat absorption amount Q_{A}, the first heat-generating component heat absorption amount Q_{B}, and the second heat-generating component heat absorption amount Q_{C} is not equal to the heat-exhausting device heat exhaust amount Q_{EX} (step S2021: NO). Therefore, the sum of the battery heat absorption amount Q_{A}, the first heat-generating component heat absorption amount Q_{B}, and the second heat-generating component heat absorption amount Q_{C} is larger than the heat-exhausting device heat exhaust amount Q_{EX}.

In step S5022, a new permitted current value I_{NEW} is calculated based on a permitted current value I_{MAP} that has been permitted for the solid-state battery 20 in the related art, and an output current I_{BATT} of the solid-state battery 20 is controlled to become the new permitted current value I_{NEW}. The new permitted current value I_{NEW} is calculated using the following equation (26).

$${I}_{NEW} = {I}_{MAP} \times P 30 \qquad ( 26 )$$

Note that P30 is a predetermined value that satisfies 0<P30<1.

Subsequently, the control proceeds to step S5023, in which the permitted current value I_{MAP} is updated to the new permitted current value I_{NEW} calculated in step S5022 and stored in the control storage unit 51.

Subsequently, the control proceeds to step S5024, the battery temperature T_{BATT}, the battery inlet refrigerant temperature T_{W_BATT_IN}, the battery outlet refrigerant temperature T_{W_BATT_OUT}, the heat-exhausting device inlet refrigerant temperature T_{W_EX_IN}, the heat-exhausting device outlet refrigerant temperature T_{W_EX_OUT}, the first heat-generating component inlet refrigerant temperature T_{W_B_IN}, the first heat-generating component outlet refrigerant temperature T_{W_B_OUT}, and the second heat-generating component outlet refrigerant temperature T_{W_C_OUT} are acquired again.

Subsequently, the control proceeds to step S5025, in which based on the battery temperature T_{BATT}, the battery inlet refrigerant temperature T_{W_BATT_IN}, the battery outlet refrigerant temperature T_{W_BATT_OUT}, the heat-exhausting device inlet refrigerant temperature T_{W_EX_IN}, the heat-exhausting device outlet refrigerant temperature T_{W_EX_OUT}, the first heat-generating component inlet refrigerant temperature T_{W_B_IN}, the first heat-generating component outlet refrigerant temperature T_{W_B_OUT}, and the second heat-generating component outlet refrigerant temperature T_{W_C_OUT}, which are acquired in step S5024, the battery heat generation amount Q_{BATT}, the battery heat absorption amount Q_{A}, the first heat-generating component heat absorption amount Q_{B}, the second heat-generating component heat absorption amount Q_{C}, and the heat-exhausting device heat exhaust amount Q_{EX} are acquired by calculation, and the battery heat generation amount Q_{BATT}, the battery heat absorption amount Q_{A}, the first heat-generating component heat absorption amount Q_{B}, the second heat-generating component heat absorption amount Q_{C}, and the heat-exhausting device heat exhaust amount Q_{EX} are updated and stored in the control storage unit 51.

Subsequently, the control proceeds to step S5026, in which it is determined whether the battery temperature T_{BATT} acquired in step S5024 is equal to or lower than the output limitation starting temperature T_{S}. If the battery temperature T_{BATT} is equal to or lower than the output limitation starting temperature T_{S} (step S5026: YES), the control returns to step S5001, and the processing of step S5001 and the subsequent steps is repeated until the sum of the battery heat absorption amount Q_{A}, the first heat-generating component heat absorption amount Q_{B}, and the second heat-generating component heat absorption amount Q_{C} is equal to the heat-exhausting device heat exhaust amount Q_{EX}. In step S5026, if the battery temperature T_{BATT} is not equal to or lower than the output limitation starting temperature T_{S}, that is, the battery temperature T_{BATT} exceeds the output limitation starting temperature T_{S} (step S5026: NO), the control proceeds to step S1004 described above.

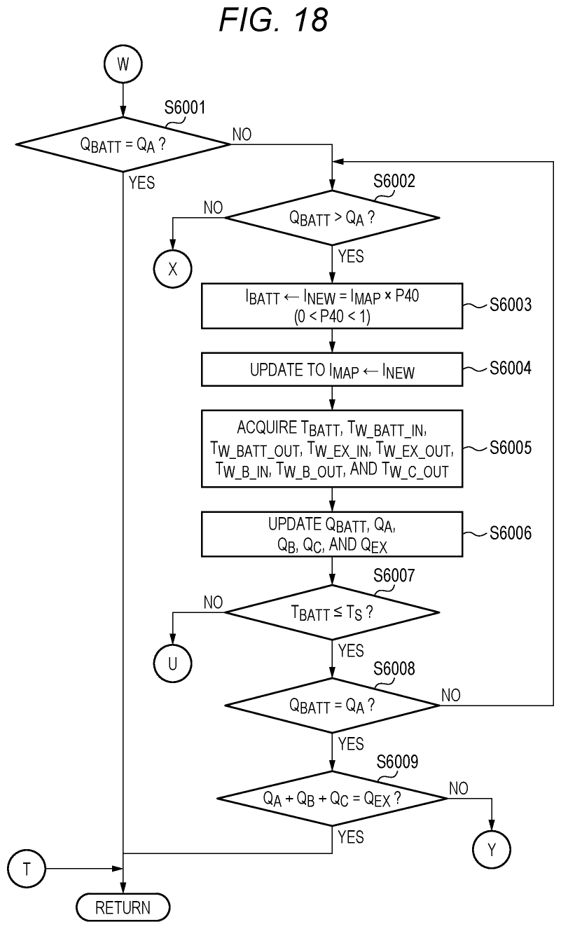

As shown in FIG. 18, in step S6001, it is determined whether the battery heat generation amount Q_{BATT} is equal to the battery heat absorption amount Q_{A} based on the latest battery heat generation amount Q_{BATT}, the latest battery heat absorption amount Q_{A}, the latest first heat-generating component heat absorption amount Q_{B}, the latest second heat-generating component heat absorption amount Q_{C}, and the latest heat-exhausting device heat exhaust amount Q_{EX} which are stored in the control storage unit 51.

In step S6001, if the battery heat generation amount Q_{BATT} is equal to the battery heat absorption amount Q_{A} (step S6001: YES), a series of controls ends. The control returns to the start, and the battery control device 50 repeats the series of controls.

In a case where the battery heat generation amount Q_{BATT} is equal to the battery heat absorption amount Q_{A} in step S6001 (step S6001: YES), with respect to the latest battery heat generation amount Q_{BATT}, the latest battery heat absorption amount Q_{A}, the latest first heat-generating component heat absorption amount Q_{B}, the latest second heat-generating component heat absorption amount Q_{C}, and the latest heat-exhausting device heat exhaust amount Q_{EX}, which are stored in the control storage unit 51 and acquired by calculation in any of step S1002, S4005, S5014, and S5025, the following conditions are satisfied that the sum of the battery heat absorption amount Q_{A}, the first heat-generating component heat absorption amount Q_{B}, and the second heat-generating component heat absorption amount Q_{C} is equal to the heat-exhausting device heat exhaust amount Q_{EX} (step S5016: YES, step S5021: YES), and the battery heat generation amount Q_{BATT} is equal to the battery heat absorption amount Q_{A}, (step S6001: YES).

On the other hand, in step S6001, if the battery heat generation amount Q_{BATT} is not equal to the battery heat absorption amount Q_{A} (step S6001: NO), the control proceeds to step S6002.

In step S6002, it is determined whether the battery heat generation amount Q_{BATT} is larger than the battery heat absorption amount Q_{A} based on the latest battery heat generation amount Q_{BATT}, the latest battery heat absorption amount Q_{A}, the latest first heat-generating component heat absorption amount Q_{B}, the latest second heat-generating component heat absorption amount Q_{C}, and the latest heat-exhausting device heat exhaust amount Q_{EX}, which are stored in the control storage unit 51 and acquired by calculation in any of step S1002, S4005, S5014, and S5025. If the battery heat generation amount Q_{BATT} is larger than the battery heat absorption amount Q_{A} (step S6002: YES), the control proceeds to step S6003, and if the battery heat generation amount Q_{BATT} is not larger than the battery heat absorption amount Q_{A} (step S6002: NO), the control returns to step S4002. In a case where it is determined in step S6002 that the battery heat generation amount Q_{BATT} is not larger than the battery heat absorption amount Q_{A} (step S6002: NO), the following condition is satisfied that the battery heat generation amount Q_{BATT} is not equal to the battery heat absorption amount Q_{A} (step S6001: NO) and the battery heat generation amount Q_{BATT} is not larger than the battery heat absorption amount Q_{A} (step S6002: NO). Therefore, the battery heat generation amount Q_{BATT} is smaller than the battery heat absorption amount Q_{A}.

In step S6003, a new permitted current value I_{NEW} is calculated based on a permitted current value I_{MAP} that has been permitted for the solid-state battery 20 in the related art, and an output current I_{BATT} of the solid-state battery 20 is controlled to become the new permitted current value I_{NEW}. The new permitted current value I_{NEW} is calculated using the following equation (27).

$${I}_{NEW} = {I}_{MAP} \times P 40 \qquad ( 27 )$$

Note that P40 is a predetermined value that satisfies 0<P40<1.

Subsequently, the control proceeds to step S6004, in which the permitted current value I_{MAP} is updated to the new permitted current value I_{NEW} calculated in step S6003 and stored in the control storage unit 51.

Subsequently, the control proceeds to step S6005, the battery temperature T_{BATT}, the battery inlet refrigerant temperature T_{W_BATT_IN}, the battery outlet refrigerant temperature T_{W_BATT_OUT}, the heat-exhausting device inlet refrigerant temperature T_{W_EX_IN}, the heat-exhausting device outlet refrigerant temperature T_{W_EX_OUT}, the first heat-generating component inlet refrigerant temperature T_{W_B_IN}, the first heat-generating component outlet refrigerant temperature T_{W_B_OUT}, and the second heat-generating component outlet refrigerant temperature T_{W_C_OUT} are acquired again.

Subsequently, the control proceeds to step S6006, in which based on the battery temperature T_{BATT}, the battery inlet refrigerant temperature T_{W_BATT_IN}, the battery outlet refrigerant temperature T_{W_BATT_OUT}, the heat-exhausting device inlet refrigerant temperature T_{W_EX_IN}, the heat-exhausting device outlet refrigerant temperature T_{W_EX_OUT}, the first heat-generating component inlet refrigerant temperature T_{W_B_IN}, the first heat-generating component outlet refrigerant temperature T_{W_B_OUT}, and the second heat-generating component outlet refrigerant temperature T_{W_C_OUT}, which are acquired in step S6005, the battery heat generation amount Q_{BATT}, the battery heat absorption amount Q_{A}, the first heat-generating component heat absorption amount Q_{B}, the second heat-generating component heat absorption amount Q_{C}, and the heat-exhausting device heat exhaust amount Q_{EX} are acquired by calculation, and the battery heat generation amount Q_{BATT}, the battery heat absorption amount Q_{A}, the first heat-generating component heat absorption amount Q_{B}, the second heat-generating component heat absorption amount Q_{C}, and the heat-exhausting device heat exhaust amount Q_{EX} are updated and stored in the control storage unit 51.

Subsequently, the control proceeds to step S6007, in which it is determined whether the battery temperature T_{BATT} acquired in step S6005 is equal to or lower than the output limitation starting temperature T_{S}. If the battery temperature T_{BATT} is equal to or lower than the output limitation starting temperature T_{S} (step S6007: YES), the control proceeds to step S6008. If the battery temperature T_{BATT} is not equal to or lower than the output limitation starting temperature T_{S}, that is, the battery temperature T_{BATT} exceeds the output limitation starting temperature T_{S} (step S6007: NO), the control proceeds to step S1004 described above.

In step S6008, it is determined whether the battery heat generation amount Q_{BATT} calculated in step S6006 is equal to the battery heat absorption amount Q_{A}. If the battery heat generation amount Q_{BATT} is not equal to the battery heat absorption amount Q_{A} (step S6008: NO), the control returns to step S6002 to repeat steps S6002 to S6008. If the battery heat generation amount Q_{BATT} calculated in step S6006 is equal to the battery heat absorption amount Q_{A} (step S6008: YES), the control proceeds to step S6009.

In step S6009, it is determined whether the sum of the battery heat absorption amount Q_{A}, the first heat-generating component heat absorption amount Q_{B}, and the second heat-generating component heat absorption amount Q_{C}, which are calculated in step S6006, is equal to the heat-exhausting device heat exhaust amount Q_{EX}. If the sum of the battery heat absorption amount Q_{A}, the first heat-generating component heat absorption amount Q_{B}, and the second heat-generating component heat absorption amount Q_{C} is not equal to the heat-exhausting device heat exhaust amount Q_{EX} (step S6009: NO), the control returns to step S5001.

In step S6009, if the sum of the battery heat absorption amount Q_{A}, the first heat-generating component heat absorption amount Q_{B}, and the second heat-generating component heat absorption amount Q_{C} is equal to the heat-exhausting device heat exhaust amount Q_{EX} (step S6009: YES), the series of controls ends. The control returns to the start, and the battery control device 50 repeats the series of controls.

In a case where the sum of the battery heat absorption amount Q_{A}, the first heat-generating component heat absorption amount Q_{B}, and the second heat-generating component heat absorption amount Q_{C} is equal to the heat-exhausting device heat exhaust amount Q_{EX} (step S6009: YES) in step S6009, with respect to the battery heat generation amount Q_{BATT}, the battery heat absorption amount Q_{A}, the first heat-generating component heat absorption amount Q_{B}, the second heat-generating component heat absorption amount Q_{C}, and the heat-exhausting device heat exhaust amount Q_{EX}, which are calculated in step S6006, the following conditions are satisfied that the battery heat generation amount Q_{BATT} is equal to the battery heat absorption amount Q_{A} (step S6008: YES), and the sum of the battery heat absorption amount Q_{A}, the first heat-generating component heat absorption amount Q_{B}, and the second heat-generating component heat absorption amount Q_{C} is equal to the heat-exhausting device heat exhaust amount Q_{EX} (step S6009: YES).

As described above, in the series of controls, when the battery temperature T_{BATT} is lower than the first threshold temperature T₁ and the sum of the battery heat absorption amount Q_{A}, the first heat-generating component heat absorption amount Q_{B}, and the second heat-generating component heat absorption amount Q_{C} is smaller than the heat-exhausting device heat exhaust amount Q_{EX}, the battery control device 50 performs control to increase the output current I_{BATT} of the solid-state battery 20 such that the battery heat generation amount Q_{BATT} is equal to the battery heat absorption amount Q_{A} and the sum of the battery heat absorption amount Q_{A}, the first heat-generating component heat absorption amount Q_{B}, and the second heat-generating component heat absorption amount Q_{C} is equal to the heat-exhausting device heat exhaust amount Q_{EX}.

When the battery heat generation amount Q_{BATT} and the battery heat absorption amount Q_{A} are equal to each other, and the sum of the battery heat absorption amount Q_{A}, the first heat-generating component heat absorption amount Q_{B}, and the second heat-generating component heat absorption amount Q_{C} is equal to the heat-exhausting device heat exhaust amount Q_{EX}, the battery temperature T_{BATT} is kept constant without increasing or decreasing.

Accordingly, when the battery temperature T_{BATT} is lower than the first threshold temperature T₁ and the battery heat generation amount Q_{BATT} is smaller than the heat-exhausting device heat exhaust amount Q_{EX}, the output current I_{BATT} of the solid-state battery 20 can be increased while maintaining the battery temperature T_{BATT} at a constant temperature to effectively utilize output performance of the solid-state battery 20. For example, in a case where the vehicle on which the battery cooling system 10 is mounted is a hybrid vehicle that includes an engine and can travel by using both power of the engine and electric power of the solid-state battery 20 as a drive source, a load on the engine can be reduced and fuel efficiency will be improved by utilizing the increased output current I_{BATT} of the solid-state battery 20 as a drive source. In addition, the increased output current I_{BATT} of the solid-state battery 20 may be charged into a low-voltage battery for an accessory mounted on the vehicle, or may be utilized as operating power of an air conditioner mounted on the vehicle.

### <Second Example of Control Flow in Battery Control Device>

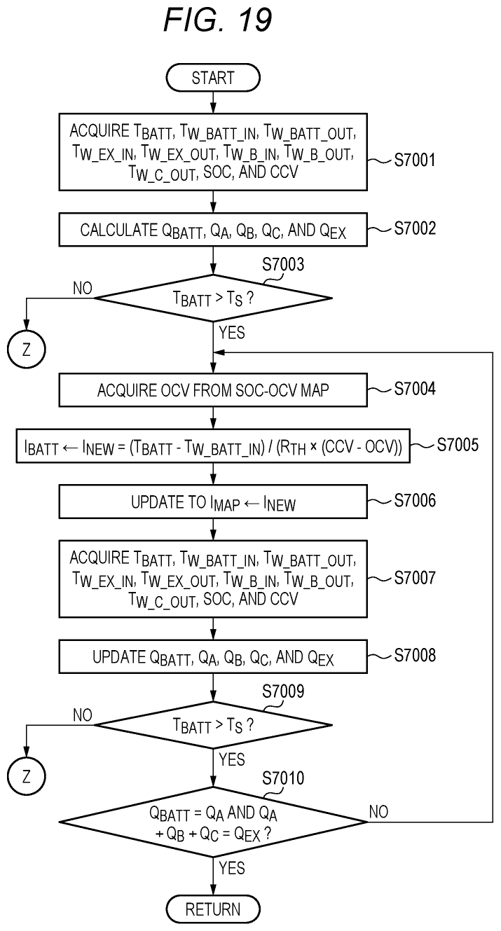

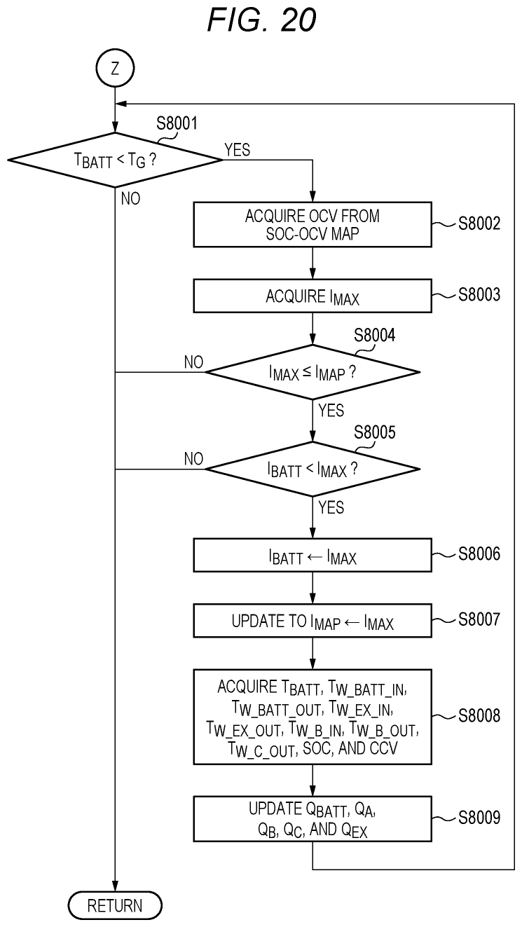

Next, a second example of a control flow of the input-output power of the solid-state battery 20 in the battery control device 50 will be described with reference to FIGS. 19 and 20.

As shown in FIG. 19, the battery control device 50 first acquires a battery temperature T_{BATT}, a battery inlet refrigerant temperature T_{W_BATT_IN}, a battery outlet refrigerant temperature T_{W_BATT_OUT}, a heat-exhausting device inlet refrigerant temperature T_{W_EX_IN}, a heat-exhausting device outlet refrigerant temperature T_{W_EX_OUT}, a first heat-generating component inlet refrigerant temperature T_{W_B_IN}, a first heat-generating component outlet refrigerant temperature T_{W_B_OUT}, a second heat-generating component outlet refrigerant temperature T_{W_C_OUT}, a remaining battery capacity SOC of the solid-state battery 20, and a battery voltage CCV of the solid-state battery 20 (step S7001). In the present embodiment, the battery temperature T_{BATT}, the battery inlet refrigerant temperature T_{W_BATT_IN}, the battery outlet refrigerant temperature T_{W_BATT_OUT}, the heat-exhausting device inlet refrigerant temperature T_{W_EX_IN}, the heat-exhausting device outlet refrigerant temperature T_{W_EX_OUT}, the first heat-generating component inlet refrigerant temperature T_{W_B_IN}, the first heat-generating component outlet refrigerant temperature T_{W_B_OUT}, and the second heat-generating component outlet refrigerant temperature T_{W_C_OUT} are acquired by detection of the battery temperature sensor 41, the battery inlet refrigerant temperature sensor 42, the battery outlet refrigerant temperature sensor 43, the heat-exhausting device inlet refrigerant temperature sensor 44, the heat-exhausting device outlet refrigerant temperature sensor 45, the first heat-generating component inlet refrigerant temperature sensor 46, the first heat-generating component outlet refrigerant temperature sensor 47, and the second heat-generating component outlet refrigerant temperature sensor 48. The battery voltage CCV is acquired by, for example, detection by a voltage sensor (not shown) provided in the solid-state battery 20. The remaining battery capacity SOC is acquired by calculation based on the acquired battery voltage CCV, for example.

Subsequently, the control proceeds to step S7002, in which a battery heat generation amount Q_{BATT} which is a heat generation amount of the solid-state battery 20, a battery heat absorption amount Q_{A} which is a heat absorption amount of the refrigerant W from the solid-state battery 20, a first heat-generating component heat absorption amount Q_{B} which is a heat absorption amount of the refrigerant W from the first heat-generating component 81, a second heat-generating component heat absorption amount Q_{C} which is a heat absorption amount of the refrigerant W from the second heat-generating component 82, and a heat-exhausting device heat exhaust amount Q_{EX} of the refrigerant W in the heat-exhausting device 30 are acquired by calculation.

The battery heat generation amount Q_{BATT} is calculated using the above-described equation (13) as in the second example of the control flow of the battery control device according to the first embodiment.

The battery heat absorption amount Q_{A} is calculated using the above-described equation (2) as in the second example of the control flow of the battery control device according to the first embodiment.

The first heat-generating component heat absorption amount Q_{B} is calculated using the above-described equation (18) as in the first example of the control flow of the battery control device according to the second embodiment.

The second heat-generating component heat absorption amount Q_{C} [J] is calculated using the above-described equation (19) as in the first example of the control flow of the battery control device according to the second embodiment.

The heat-exhausting device heat exhaust amount Q_{EX} [J] is calculated using the above-described equation (4) as in the second example of the control flow of the battery control device according to the first embodiment.

Subsequently, the control proceeds to step S7003, in which it is determined whether the battery temperature T_{BATT} acquired in step S7001 exceeds the preset output limitation starting temperature T_{S}. If the battery temperature T_{BATT} exceeds the output limitation starting temperature T_{S} (step S7003: YES), the control proceeds to step S7004. If the battery temperature T_{BATT} does not exceed the output limitation starting temperature T_{S}, that is, the battery temperature T_{BATT} is equal to or lower than the output limitation starting temperature T_{S} (step S7003: NO), the control proceeds to step S8001 to be described later.

In step S7004, a battery open-circuit voltage OCV is acquired from an SOC-OCV map based on the acquired latest remaining battery capacity SOC.

The control proceeds to step S7005, in which a new permitted current value I_{NEW} at which the battery heat generation amount Q_{BATT} is equal to the battery heat absorption amount Q_{A} is calculated, and the output current I_{BATT} of the solid-state battery 20 is controlled to become the new permitted current value I_{NEW}. The new permitted current value I_{NEW} is calculated using the above-described equation (15) as in the second example of the control flow in the battery control device according to the first embodiment.

Subsequently, the control proceeds to step S7006, in which the permitted current value I_{MAP} is updated to the new permitted current value I_{NEW} calculated in step S7005 and stored in the control storage unit 51.

Subsequently, the control proceeds to step S7007, the battery temperature T_{BATT}, the battery inlet refrigerant temperature T_{W_BATT_IN}, the battery outlet refrigerant temperature T_{W_BATT_OUT}, the heat-exhausting device inlet refrigerant temperature T_{W_EX_IN}, the heat-exhausting device outlet refrigerant temperature T_{W_EX_OUT}, the first heat-generating component inlet refrigerant temperature T_{W_B_IN}, the first heat-generating component outlet refrigerant temperature T_{W_B_OUT}, the second heat-generating component outlet refrigerant temperature T_{W_C_OUT}, the remaining battery capacity SOC of the solid-state battery 20, and the battery voltage CCV of the solid-state battery 20 are acquired again.

Subsequently, the control proceeds to step S7008, in which based on the battery temperature T_{BATT}, the battery inlet refrigerant temperature T_{W_BATT_IN}, the battery outlet refrigerant temperature T_{W_BATT_OUT}, the heat-exhausting device inlet refrigerant temperature T_{W_EX_IN}, the heat-exhausting device outlet refrigerant temperature T_{W_EX_OUT}, the first heat-generating component inlet refrigerant temperature T_{W_B_IN}, the first heat-generating component outlet refrigerant temperature T_{W_B_OUT} the second heat-generating component outlet refrigerant temperature T_{W_C_OUT}, the remaining battery capacity SOC of the solid-state battery 20, and the battery voltage CCV of the solid-state battery 20, which are acquired in step S7007, the battery heat generation amount Q_{BATT}, the battery heat absorption amount Q_{A}, the first heat-generating component heat absorption amount Q_{B}, the second heat-generating component heat absorption amount Q_{C}, and the heat-exhausting device heat exhaust amount Q_{EX} are acquired by calculation, and the battery heat generation amount Q_{BATT}, the battery heat absorption amount Q_{A}, the first heat-generating component heat absorption amount Q_{B}, the second heat-generating component heat absorption amount Q_{C}, and the heat-exhausting device heat exhaust amount Q_{EX} are updated and stored in the control storage unit 51.

Subsequently, the control proceeds to step S7009, in which it is determined whether the battery temperature T_{BATT} acquired in step S7007 exceeds the preset output limitation starting temperature T_{S}. If the battery temperature T_{BATT} exceeds the output limitation starting temperature T_{S} (step S7009: YES), the control proceeds to step S7010. If the battery temperature T_{BATT} does not exceed the output limitation starting temperature T_{S} [° C.], that is, the battery temperature T_{BATT} is equal to or lower than the output limitation starting temperature T_{S} [° C.] (step S7009: NO), the control proceeds to step S8001 to be described later.

In step S7010, it is determined whether the battery heat generation amount Q_{BATT} is equal to the battery heat absorption amount Q_{A}, and the sum of the battery heat absorption amount Q_{A}, the first heat-generating component heat absorption amount Q_{B}, and the second heat-generating component heat absorption amount Q_{C} is equal to the heat-exhausting device heat exhaust amount Q_{EX}. If the battery heat generation amount Q_{BATT} is equal to the battery heat absorption amount Q_{A}, and the sum of the battery heat absorption amount Q_{A}, the first heat-generating component heat absorption amount Q_{B}, and the second heat-generating component heat absorption amount Q_{C} is not equal to the heat-exhausting device heat exhaust amount Q_{EX} (step S7010: NO), the control returns to step S7004, and steps S7004 to S7010 are repeated. If the battery heat generation amount Q_{BATT} is equal to the battery heat absorption amount Q_{A}, and the sum of the battery heat absorption amount Q_{A}, the first heat-generating component heat absorption amount Q_{B}, and the second heat-generating component heat absorption amount Q_{C} is equal to the heat-exhausting device heat exhaust amount Q_{EX} (step S7010: YES), the series of controls ends. The control returns to the start, and the battery control device 50 repeats the series of controls.

As described above, in the series of controls, when the battery temperature T_{BATT} exceeds the predetermined output limitation starting temperature T_{S}, the battery control device 50 controls the output current I_{BATT} of the solid-state battery 20 such that the battery heat generation amount Q_{BATT} and the battery heat absorption amount Q_{A} are equal to each other and the sum of the battery heat absorption amount Q_{A}, the first heat-generating component heat absorption amount Q_{B}, and the second heat-generating component heat absorption amount Q_{C} is equal to the heat-exhausting device heat exhaust amount Q_{EX}.

When the battery heat generation amount Q_{BATT} and the battery heat absorption amount Q_{A} are equal to each other, and the sum of the battery heat absorption amount Q_{A}, the first heat-generating component heat absorption amount Q_{B}, and the second heat-generating component heat absorption amount Q_{C} is equal to the heat-exhausting device heat exhaust amount Q_{EX}, the battery temperature T_{BATT} is kept constant without increasing or decreasing. In this way, the battery control device 50 controls the battery temperature T_{BATT} to be equal to or higher than the output limitation starting temperature T_{S} and lower than a predetermined output permission upper-limit temperature T_{LIM} [° C.] which is an upper-limit temperature at which the solid-state battery 20 is permitted to output power. An output permission upper-limit temperature T_{LIM} is set in advance according to battery characteristics of the solid-state battery 20, and is stored in the control storage unit 51.

Accordingly, even in a case where the battery temperature T_{BATT} of the solid-state battery 20 exceeds the output limitation starting temperature T_{S}, the output of the solid-state battery 20 can be maintained while the battery temperature T_{BATT} of the solid-state battery 20 is prevented from reaching the output permission upper-limit temperature T_{LIM}. Therefore, it is possible to prevent the output from the solid-state battery 20 from being suddenly limited, and to maintain stable output from the solid-state battery 20.

In addition, in the series of controls, the thermal resistance value R-TH between the solid-state battery 20 and the refrigerant W is stored in the control storage unit 51, and the battery control device 50 calculates, based on the thermal resistance value R_{T}m, a new permitted current value I_{NEW} of the solid-state battery 20 at which the battery heat generation amount Q_{BATT} and the battery heat absorption amount Q_{A} are equal to each other, and controls the output current I_{BATT} of the solid-state battery 20 to become the new permitted current value I_{NEW}.

Accordingly, it is possible to prevent hunting of the output current I_{BATT} of the solid-state battery 20, and control the output current I_{BATT} of the solid-state battery 20 such that the battery heat generation amount Q_{BATT} and the battery heat absorption amount Q_{A} are equal to each other, and the sum of the battery heat absorption amount Q_{A}, the first heat-generating component heat absorption amount Q_{B}, and the second heat-generating component heat absorption amount Q_{C} is equal to the heat-exhausting device heat exhaust amount Q_{EX} in a short time.

On the other hand, as described above, in steps S7003 and S7009, if the battery temperature T_{BATT} does not exceed the output limitation starting temperature T_{S}, that is, the battery temperature T_{BATT} is equal to or lower than the output limitation starting temperature T_{S}, the control proceeds to step S8001.

As shown in FIG. 20, in step S8001, it is determined whether the battery temperature T_{BATT} is lower than a control target temperature T_{G} [° C.]. The control target temperature T_{G} is a predetermined temperature equal to or lower than the output limitation starting temperature T_{S}, and is stored in the control storage unit 51 in advance. The control target temperature T_{G} may be the same temperature as the output limitation starting temperature T_{S}.

In step S8001, if the battery temperature T_{BATT} is not lower than the control target temperature T_{G}, that is, the battery temperature T_{BATT} is equal to or higher than the control target temperature T_{G} (step S8001: NO), the series of controls ends. The control returns to the start, and the battery control device 50 repeats the series of controls.

In step S8001, if the battery temperature T_{BATT} is lower than the control target temperature T_{G} (step S8001: YES), the control proceeds to step S8002.

In step S8002, the battery open-circuit voltage OCV is acquired from the SOC-OCV map based on the latest remaining battery capacity SOC stored in the control storage unit 51.

The control proceeds to step S8003, in which a maximum allowable current value I_{MAX} is acquired by calculation. The maximum allowable current value I_{MAX} is a current value required to increase the battery temperature T_{BATT} to the control target temperature T_{G}. The maximum allowable current value I_{MAX} is calculated using the above-described equation (17) as in the second example of the control flow in the battery control device according to the first embodiment.

Subsequently, the control proceeds to step S8004, in which it is determined whether the maximum allowable current value I_{MAX} acquired in step S8003 is equal to or smaller than the permitted current value I_{MAP} stored in the control storage unit 51. If the maximum allowable current value I_{MAX} acquired in step S8003 is equal to or smaller than the permitted current value I_{MAP} stored in the control storage unit 51 (step S8004: YES), the control proceeds to step S8005. If the maximum allowable current value I_{MAX} acquired in step S8003 is larger than the permitted current value I_{A}p stored in the control storage unit 51 (step S8004: NO), the series of controls ends. The control returns to the start, and the battery control device 50 repeats the series of controls.

In step S8005, it is determined whether the output current I_{BATT} of the solid-state battery 20 is smaller than the maximum allowable current value I_{MAX} acquired in step S8003. If the output current I_{BATT} of the solid-state battery 20 is smaller than the maximum allowable current value I_{MAX} acquired in step S8003 (step S8005: YES), the control proceeds to step S8006. If the output current I_{BATT} of the solid-state battery 20 is not smaller than the maximum allowable current value I_{MAX} acquired in step S8003, that is, the output current I_{BATT} of the solid-state battery 20 is equal to or larger than the maximum allowable current value I_{MAX} acquired in step S8003 (step S8005: NO), the series of controls ends. The control returns to the start, and the battery control device 50 repeats the series of controls.

In step S8006, the output current I_{BATT} of the solid-state battery 20 is controlled to be the maximum allowable current value I_{MAX}.

Subsequently, the control proceeds to step S8007, in which the permitted current value I_{MAP} is updated to the maximum allowable current value I_{MAX} calculated in step S8003 and stored in the control storage unit 51.

Subsequently, the control proceeds to step S8008, the battery temperature T_{BATT}, the battery inlet refrigerant temperature T_{W_BATT_IN}, the battery outlet refrigerant temperature T_{W_BATT_OUT}, the heat-exhausting device inlet refrigerant temperature T_{W_EX_IN}, the heat-exhausting device outlet refrigerant temperature T_{W_EX_OUT}, the first heat-generating component inlet refrigerant temperature T_{W_B_IN}, the first heat-generating component outlet refrigerant temperature T_{W_B_OUT}, the second heat-generating component outlet refrigerant temperature T_{W_C_OUT}, the remaining battery capacity SOC of the solid-state battery 20, and the battery voltage CCV of the solid-state battery 20 are acquired again.

Subsequently, the control proceeds to step S8009, in which based on the battery temperature T_{BATT}, the battery inlet refrigerant temperature T_{W_BATT_IN}, the battery outlet refrigerant temperature T_{W_BATT_OUT}, the heat-exhausting device inlet refrigerant temperature T_{W_EX_IN}, the heat-exhausting device outlet refrigerant temperature T_{W_EX_OUT}, the first heat-generating component inlet refrigerant temperature T_{W_B_IN}, the first heat-generating component outlet refrigerant temperature T_{W_B_OUT}, the second heat-generating component outlet refrigerant temperature T_{W_C_OUT}, the remaining battery capacity SOC of the solid-state battery 20, and the battery voltage CCV of the solid-state battery 20, which are acquired in step S8008, the battery heat generation amount Q_{BATT}, the battery heat absorption amount Q_{A}, the first heat-generating component heat absorption amount Q_{B}, the second heat-generating component heat absorption amount Q_{C}, and the heat-exhausting device heat exhaust amount Q_{EX} are acquired by calculation, and the battery heat generation amount Q_{BATT}, the battery heat absorption amount Q_{A}, the first heat-generating component heat absorption amount Q_{B}, the second heat-generating component heat absorption amount Q_{C}, and the heat-exhausting device heat exhaust amount Q_{EX} are updated and stored in the control storage unit 51.

The control returns to S8001, and when the battery temperature T_{BATT} is lower than the control target temperature T_{G}, steps S8001 to S8009 are repeated until the battery temperature T_{BATT} reaches the control target temperature T_{G}.

As described above, when the battery temperature T_{BATT} is lower than the control target temperature T_{G} and the output current I_{BATT} of the solid-state battery 20 is smaller than the maximum allowable current value I_{MAX} that is a current value required to increase the battery temperature T_{BATT} to the control target temperature T_{G}, the battery control device 50 performs control to increase the output current I_{BATT} of the solid-state battery 20. However, in the present embodiment, when the maximum allowable current value I_{MAX} is larger than the permitted current value I_{MAP} stored in the control storage unit 51, the permitted current value I_{MAP} stored in the control storage unit 51 is prioritized. In this way, “control to increase the output current” means that there is control to increase the output current, and other control related to the output current may be used together. For example, when the maximum allowable current value I_{MAX} is larger than the permitted current value I_{MAP}, the permitted current value I_{MAX} may be prioritized and the output current may not increase.

The control can be referred to as output current release control of the solid-state battery 20 according to the cooling capacity of the solid-state battery 20 of the battery cooling system 10. Accordingly, when the battery temperature T_{BATT} is lower than the control target temperature T_{G}, the output current I_{BATT} of the solid-state battery 20 is increased in accordance with the cooling capacity of the solid-state battery 20 in the battery cooling system 10, so that the output performance of the solid-state battery 20 can be effectively utilized. For example, in a case where the vehicle on which the battery cooling system 10 is mounted is a hybrid vehicle that includes an engine and can travel by using both power of the engine and electric power of the solid-state battery 20 as a drive source, a load on the engine can be reduced and fuel efficiency will be improved by utilizing the increased output current I_{BATT} of the solid-state battery 20 as a drive source. In addition, the increased output current I_{BATT} of the solid-state battery 20 may be charged into a low-voltage battery for an accessory mounted on the vehicle, or may be utilized as operating power of an air conditioner mounted on the vehicle.

Although the embodiments of the present disclosure have been described above with reference to the accompanying drawings, it is needless to say that the present invention is not limited to the embodiments. It is apparent that those skilled in the art can conceive of various modifications and changes within the scope described in the claims, and it is understood that such modifications and changes naturally fall within the technical scope of the present invention. In addition, components in the above embodiment may be freely combined without departing from the gist of the invention.

For example, in the second embodiment, the battery cooling system 100 includes two heat-generating components, that is, the first heat-generating component 81 and the second heat-generating component 82, as heat-generating components other than the solid-state battery 20 and the heat-exhausting device 30, but the number of heat-generating components other than the solid-state battery 20 and the heat-exhausting device 30 included in the battery cooling system 100 may be one or three or more.

In addition, in the first embodiment and the second embodiment, the battery temperature T_{BATT}, the battery inlet refrigerant temperature T_{W_BATT_IN}, the battery outlet refrigerant temperature T_{W_BATT_OUT}, the heat-exhausting device inlet refrigerant temperature T_{W_EX_IN}, the heat-exhausting device outlet refrigerant temperature T_{W_EX_OUT}, the first heat-generating component inlet refrigerant temperature T_{W_B_IN}, the first heat-generating component outlet refrigerant temperature T_{W_B_OUT}, the second heat-generating component outlet refrigerant temperature T_{W_C_OUT} are acquired by detection of the battery temperature sensor 41, the battery inlet refrigerant temperature sensor 42, the battery outlet refrigerant temperature sensor 43, the heat-exhausting device inlet refrigerant temperature sensor 44, the heat-exhausting device outlet refrigerant temperature sensor 45, the first heat-generating component inlet refrigerant temperature sensor 46, the first heat-generating component outlet refrigerant temperature sensor 47, and the second heat-generating component outlet refrigerant temperature sensor 48. However, the battery temperature T_{BATT}, the battery inlet refrigerant temperature T_{W_BATT_IN}, the battery outlet refrigerant temperature T_{W_BATT_OUT}, the heat-exhausting device inlet refrigerant temperature T_{W_EX_IN}, the heat-exhausting device outlet refrigerant temperature T_{W_EX_OUT}, the first heat-generating component inlet refrigerant temperature T_{W_B_IN}, the first heat-generating component outlet refrigerant temperature T_{W_B_OUT}, and the second heat-generating component outlet refrigerant temperature T_{W_C_OUT} may be acquired by calculation based on other detection values.

In the present description, at least the following matters are described. In the parentheses, the corresponding constituent elements and the like in the above embodiments are shown as an example, but the present invention is not limited thereto.
(1) A battery cooling system (battery cooling system 10) including:
a solid-state battery (solid-state battery 20);
a heat-exhausting device (heat-exhausting device 30);
a cooling circuit (cooling circuit 40) through which a refrigerant (refrigerant W) circulates between the solid-state battery and the heat-exhausting device; and
a battery control device (battery control device 50) configured to control input-output power of the solid-state battery,
in which the refrigerant absorbs heat from the solid-state battery to cool the solid-state battery, and the heat-exhausting device exhausts heat absorbed from the solid-state battery, and
in a case where a battery temperature (battery temperature T_{BATT}), which is a temperature of the solid-state battery, exceeds a predetermined output limitation starting temperature (output limitation starting temperature T_{S}),
the battery control device
controls an output current (output current I_{BATT}) of the solid-state battery such that a heat generation amount (battery heat generation amount Q_{BATT}) of the solid-state battery, a heat absorption amount (battery heat absorption amount Q_{A}) of the refrigerant from the solid-state battery, and a heat exhaust amount (heat-exhausting device heat exhaust amount Q_{EX}) of the refrigerant in the heat-exhausting device are equal to each other, and
controls the battery temperature such that the battery temperature is equal to or higher than the output limitation starting temperature, and is lower than a predetermined output permission upper-limit temperature (output permission upper-limit temperature Tim) which is an upper-limit temperature at which the solid-state battery is permitted to output power.

According to (1), even in the case where the battery temperature of the solid-state battery exceeds the output limitation starting temperature, the solid-state battery can be used while preventing the battery temperature of the solid-state battery from reaching the output permission upper-limit temperature. Therefore, it is possible to prevent the output from the solid-state battery from being suddenly limited, and to maintain stable output from the solid-state battery.
(2) The battery cooling system according to (1),
in which the battery control device
   acquires the heat generation amount of the solid-state battery by detection or calculation,
   acquires, by detection or calculation, a battery inlet temperature (battery inlet refrigerant temperature T_{W_BATT_IN}) which is a temperature of the refrigerant introduced into the solid-state battery, and a battery outlet temperature (battery outlet refrigerant temperature T_{W_BATT_OUT}) which is a temperature of the refrigerant discharged from the solid-state battery.
   acquires the heat absorption amount of the refrigerant from the solid-state battery by calculation based on the battery inlet temperature and the battery outlet temperature,
   acquires, by detection or calculation, a heat-exhausting device inlet temperature (heat-exhausting device inlet refrigerant temperature T_{W_EX_IN}) which is a temperature of the refrigerant introduced into the heat-exhausting device, and a heat-exhausting device outlet temperature (heat-exhausting device outlet refrigerant temperature T_{W_EX_OUT}) which is a temperature of the refrigerant discharged from the heat-exhausting device, and
   acquires the heat exhaust amount of the refrigerant in the heat-exhausting device by calculation based on the heat-exhausting device inlet temperature and the heat-exhausting device outlet temperature, and
in a case where the heat generation amount of the solid-state battery is larger than the heat absorption amount of the refrigerant from the solid-state battery when the battery temperature is equal to or higher than the output limitation starting temperature,
the battery control device limits the output current of the solid-state battery to a first limited current value (permitted current value I_{NEW}), and thereafter performs feedback control on the output current of the solid-state battery based on the heat generation amount of the solid-state battery, the heat absorption amount of the refrigerant from the solid-state battery, and the heat exhaust amount of the refrigerant in the heat-exhausting device, which are respectively acquired, such that the heat generation amount of the solid-state battery, the heat absorption amount of the refrigerant from the solid-state battery, and the heat exhaust amount of the refrigerant in the heat-exhausting device are equal to each other.

According to (2), the output current of the solid-state battery can be subjected to feedback control in accordance with the heat generation amount of the solid-state battery, the heat absorption amount of the refrigerant from the solid-state battery, and the heat exhaust amount of the refrigerant in the heat-exhausting device in an actual use environment. Therefore, in the actual use environment, the output current of the solid-state battery can be controlled such that the heat generation amount of the solid-state battery, the heat absorption amount of the refrigerant from the solid-state battery, and the heat exhaust amount of the refrigerant in the heat-exhausting device are equal to each other, and the battery temperature can be kept constant.
(3) The battery cooling system according to (1) or (2).
in which the battery control device
   refers to a thermal resistance value (thermal resistance value R_{TH}) between the solid-state battery and the refrigerant, the thermal resistance value being stored,
   calculates a current value of the solid-state battery at which the heat generation amount of the solid-state battery and the heat absorption amount of the refrigerant from the solid-state battery are equal to each other, based on the thermal resistance value, and
   controls the output current of the solid-state battery to the current value.

According to (3), it is possible to control the output current of the solid-state battery such that the heat generation amount of the solid-state battery, the heat absorption amount of the refrigerant from the solid-state battery, and the heat exhaust amount of the refrigerant in the heat-exhausting device are equal to each other in a short time while preventing hunting of the output current of the solid-state battery.
(4) The battery cooling system according to (1),
in which in a case where the battery temperature is lower than a control target temperature (control target temperature T_{G}) which is a temperature equal to or lower than the output limitation starting temperature, and the output current of the solid-state battery is smaller than a current value (maximum allowable current value I_{MAX}) required to increase the battery temperature to the control target temperature,
the battery control device performs control to increase the output current of the solid-state battery.

According to (4), in the case where the battery temperature is lower than the control target temperature, the output current of the solid-state battery is increased in accordance with the cooling capacity of the solid-state battery in the battery cooling system, so that the output performance of the solid-state battery can be effectively utilized. Here, “control to increase the output current” means that there is control to increase the output current, and other control related to the output current may be used together. For example, when the maximum allowable current value I_{MAX} is larger than the permitted current value I_{MAP}, the permitted current value IM may be prioritized and the output current may not increase.
(5) The battery cooling system according to (1),
in which in a case where the battery temperature is lower than a predetermined first threshold temperature (first threshold temperature T₁), and the heat absorption amount of the refrigerant from the solid-state battery is smaller than the heat exhaust amount of the refrigerant in the heat-exhausting device,
the battery control device performs control to increase the output current of the solid-state battery.

According to (5), in the case where the battery temperature is lower than the predetermined first threshold temperature and the heat absorption amount of the refrigerant from the solid-state battery is smaller than the heat exhaust amount of the refrigerant in the heat-exhausting device, the output current of the solid-state battery can be increased to effectively utilize the output performance of the solid-state battery.
(6) The battery cooling system according to (1),
in which the battery control device
   acquires, by detection or calculation, a battery inlet temperature (battery inlet refrigerant temperature T_{W_BATT_IN}) which is a temperature of the refrigerant introduced into the solid-state battery, and a battery outlet temperature (battery outlet refrigerant temperature T_{W_BATT_OUT}) which is a temperature of the refrigerant discharged from the solid-state battery.
   calculates the heat absorption amount of the refrigerant from the solid-state battery based on the battery inlet temperature, the battery outlet temperature, a mass flow rate (mass flow rate qₘ) of the refrigerant, and a specific heat (specific heat c_{L}) of the refrigerant,
   acquires, by detection or calculation, a heat-exhausting device inlet temperature (heat-exhausting device inlet refrigerant temperature T_{W_EX_IN}) which is a temperature of the refrigerant introduced into the heat-exhausting device, and a heat-exhausting device outlet temperature (heat-exhausting device outlet refrigerant temperature T_{W_EX_OUT}) which is a temperature of the refrigerant discharged from the heat-exhausting device, and
   calculates the heat exhaust amount of the refrigerant in the heat-exhausting device based on the heat-exhausting device inlet temperature, the heat-exhausting device outlet temperature, the mass flow rate (mass flow rate qₘ) of the refrigerant, and the specific heat (specific heat c_{L}) of the refrigerant.

According to (6), by detecting the temperature of the refrigerant at each position in the cooling circuit, the heat absorption amount of the refrigerant from the solid-state battery and the heat exhaust amount of the refrigerant in the heat-exhausting device can be accurately acquired by calculation with a simple method.
(7) The battery cooling system (battery cooling system 100) according to (1), further including:
a heat-generating component (first heat-generating component 81 and second heat-generating component 82) other than the solid-state battery and the heat-exhausting device.
in which the cooling circuit allows the refrigerant to circulate through the solid-state battery, the heat-exhausting device, and the heat-generating component,
the refrigerant absorbs heat from the solid-state battery to cool the solid-state battery, and absorbs heat from the heat-generating component to cool the heat-generating component, and the heat-exhausting device exhausts heat absorbed from the solid-state battery and the heat-generating component, and
in a case where the battery temperature exceeds the output limitation starting temperature,
the battery control device controls the output current of the solid-state battery, instead of the heat generation amount of the solid-state battery, the heat absorption amount of the refrigerant from the solid-state battery, and the heat exhaust amount of the refrigerant in the heat-exhausting device being equal to each other, such that the heat generation amount of the solid-state battery is equal to the heat absorption amount of the refrigerant from the solid-state battery and a sum of the heat absorption amount of the refrigerant from the solid-state battery and a heat absorption amount of the refrigerant from the heat-generating component (first heat-generating component heat absorption amount Q_{B} and second heat-generating component heat absorption amount Q_{C}) is equal to the heat exhaust amount of the refrigerant in the heat-exhausting device.

According to (7), the battery cooling system further includes the heat-generating component other than the solid-state battery and the heat-exhausting device, the cooling circuit allows the refrigerant to circulate through the heat-generating component in addition to the solid-state battery and the heat-exhausting device, and the refrigerant also cools the heat-generating component. In addition, according to (7), the output current of the solid-state battery is controlled such that the heat generation amount of the solid-state battery is equal to the heat absorption amount of the refrigerant from the solid-state battery, and the sum of the heat absorption amount of the refrigerant from the solid-state battery and the heat absorption amount of the refrigerant from the heat-generating component is equal to the heat exhaust amount of the refrigerant in the heat-exhausting device. Therefore, even in the case where the battery temperature of the solid-state battery exceeds the output limitation starting temperature, the solid-state battery can be used while preventing the battery temperature of the solid-state battery from reaching the output permission upper-limit temperature. Therefore, it is possible to prevent the output from the solid-state battery from being suddenly limited, and to maintain stable output from the solid-state battery.
(8) The battery cooling system according to (7),
in which the battery control device
   acquires, by detection or calculation, a battery inlet temperature (battery inlet refrigerant temperature T_{W_BATT_IN}) which is a temperature of the refrigerant introduced into the solid-state battery, and a battery outlet temperature (battery outlet refrigerant temperature T_{W_BATT_OUT}) which is a temperature of the refrigerant discharged from the solid-state battery.
   calculates the heat absorption amount of the refrigerant from the solid-state battery based on the battery inlet temperature, the battery outlet temperature, a mass flow rate (mass flow rate qₘ) of the refrigerant, and a specific heat (specific heat c_{L}) of the refrigerant,
   acquires, by detection or calculation, a heat-exhausting device inlet temperature (heat-exhausting device inlet refrigerant temperature T_{W_EX_IN}) which is a temperature of the refrigerant introduced into the heat-exhausting device, and a heat-exhausting device outlet temperature (heat-exhausting device outlet refrigerant temperature T_{W_EX_OUT}) which is a temperature of the refrigerant discharged from the heat-exhausting device,
   calculates the heat exhaust amount of the refrigerant in the heat-exhausting device based on the heat-exhausting device inlet temperature, the heat-exhausting device outlet temperature, the mass flow rate (mass flow rate q.) of the refrigerant, and the specific heat (specific heat c_{L}) of the refrigerant,
   acquires, by detection or calculation, a heat-generating component inlet temperature (first heat-generating component inlet refrigerant temperature T_{W_B_IN} and first heat-generating component outlet refrigerant temperature T_{W_B_OUT}) which is a temperature of the refrigerant introduced into the heat-generating component, and a heat-generating component outlet temperature (first heat-generating component outlet refrigerant temperature T_{W_B_OUT} and second heat-generating component outlet refrigerant temperature T_{W_C_OUT}) which is a temperature of the refrigerant discharged from the heat-generating component, and
   calculates the heat absorption amount of the refrigerant from the heat-generating component based on the heat-generating component inlet temperature, the heat-generating component outlet temperature, the mass flow rate (mass flow rate qₘ) of the refrigerant, and the specific heat (specific heat c_{L}) of the refrigerant.

According to (8), by detecting the temperature of the refrigerant at each position in the cooling circuit, the heat absorption amount of the refrigerant from the solid-state battery,
the heat exhaust amount of the refrigerant in the heat-exhausting device, and the heat absorption amount of the refrigerant from the heat-generating component can be accurately acquired by calculation with a simple method.

What is claimed is:

1. A battery cooling system comprising:
a solid-state battery;
a heat-exhausting device;
a cooling circuit through which a refrigerant circulates between the solid-state battery and the heat-exhausting device; and
a battery control device configured to control input-output power of the solid-state battery,
wherein the refrigerant absorbs heat from the solid-state battery to cool the solid-state battery, and the heat-exhausting device exhausts heat absorbed from the solid-state battery, and
in a case where a battery temperature, which is a temperature of the solid-state battery, exceeds a predetermined output limitation starting temperature,
the battery control device
controls an output current of the solid-state battery such that a heat generation amount of the solid-state battery, a heat absorption amount of the refrigerant from the solid-state battery, and a heat exhaust amount of the refrigerant in the heat-exhausting device are equal to each other, and
controls the battery temperature such that the battery temperature is equal to or higher than the output limitation starting temperature, and is lower than a predetermined output permission upper-limit temperature which is an upper-limit temperature at which the solid-state battery is permitted to output power.

2. The battery cooling system according to claim 1,
wherein the battery control device
acquires the heat generation amount of the solid-state battery by detection or calculation,
acquires, by detection or calculation, a battery inlet temperature which is a temperature of the refrigerant introduced into the solid-state battery, and a battery outlet temperature which is a temperature of the refrigerant discharged from the solid-state battery,
acquires the heat absorption amount of the refrigerant from the solid-state battery by calculation based on the battery inlet temperature and the battery outlet temperature,
acquires, by detection or calculation, a heat-exhausting device inlet temperature which is a temperature of the refrigerant introduced into the heat-exhausting device, and a heat-exhausting device outlet temperature which is a temperature of the refrigerant discharged from the heat-exhausting device, and
acquires the heat exhaust amount of the refrigerant in the heat-exhausting device by calculation based on the heat-exhausting device inlet temperature and the heat-exhausting device outlet temperature, and
in a case where the heat generation amount of the solid-state battery is larger than the heat absorption amount of the refrigerant from the solid-state battery when the battery temperature is equal to or higher than the output limitation starting temperature,
the battery control device limits the output current of the solid-state battery to a first limited current value, and thereafter performs feedback control on the output current of the solid-state battery based on the heat generation amount of the solid-state battery, the heat absorption amount of the refrigerant from the solid-state battery, and the heat exhaust amount of the refrigerant in the heat-exhausting device, which are respectively acquired, such that the heat generation amount of the solid-state battery, the heat absorption amount of the refrigerant from the solid-state battery, and the heat exhaust amount of the refrigerant in the heat-exhausting device are equal to each other.

3. The battery cooling system according to claim 1,
wherein the battery control device
refers to a thermal resistance value between the solid-state battery and the refrigerant, the terminal resistance value being stored,
calculates a current value of the solid-state battery at which the heat generation amount of the solid-state battery and the heat absorption amount of the refrigerant from the solid-state battery are equal to each other, based on the thermal resistance value, and
controls the output current of the solid-state battery to the current value.

4. The battery cooling system according to claim 1,
wherein in a case where the battery temperature is lower than a control target temperature which is a temperature equal to or lower than the output limitation starting temperature, and the output current of the solid-state battery is smaller than a current value required to increase the battery temperature to the control target temperature,
the battery control device performs control to increase the output current of the solid-state battery.

5. The battery cooling system according to claim 1,
wherein in a case where the battery temperature is lower than a predetermined first threshold temperature, and the heat absorption amount of the refrigerant from the solid-state battery is smaller than the heat exhaust amount of the refrigerant in the heat-exhausting device,
the battery control device performs control to increase the output current of the solid-state battery.

6. The battery cooling system according to claim 1,
wherein the battery control device
acquires, by detection or calculation, a battery inlet temperature which is a temperature of the refrigerant introduced into the solid-state battery, and a battery outlet temperature which is a temperature of the refrigerant discharged from the solid-state battery,
calculates the heat absorption amount of the refrigerant from the solid-state battery based on the battery inlet temperature, the battery outlet temperature, a mass flow rate of the refrigerant, and a specific heat of the refrigerant,
acquires, by detection or calculation, a heat-exhausting device inlet temperature which is a temperature of the refrigerant introduced into the heat-exhausting device, and a heat-exhausting device outlet temperature which is a temperature of the refrigerant discharged from the heat-exhausting device, and
calculates the heat exhaust amount of the refrigerant in the heat-exhausting device based on the heat-exhausting device inlet temperature, the heat-exhausting device outlet temperature, the mass flow rate of the refrigerant, and the specific heat of the refrigerant.

7. The battery cooling system according to claim 1, further comprising:
a heat-generating component other than the solid-state battery and the heat-exhausting device,
wherein the cooling circuit allows the refrigerant to circulate through the solid-state battery, the heat-exhausting device, and the heat-generating component,
the refrigerant absorbs heat from the solid-state battery to cool the solid-state battery, and absorbs heat from the heat-generating component to cool the heat-generating component, and the heat-exhausting device exhausts heat absorbed from the solid-state battery and the heat-generating component, and
in a case where the battery temperature exceeds the output limitation starting temperature, the battery control device controls the output current of the solid-state battery,
instead of the heat generation amount of the solid-state battery, the heat absorption amount of the refrigerant from the solid-state battery, and the heat exhaust amount of the refrigerant in the heat-exhausting device being equal to each other, such that the heat generation amount of the solid-state battery is equal to the heat absorption amount of the refrigerant from the solid-state battery, and a sum of the heat absorption amount of the refrigerant from the solid-state battery and a heat absorption amount of the refrigerant from the heat-generating component is equal to the heat exhaust amount of the refrigerant in the heat-exhausting device.

8. The battery cooling system according to claim 7,
wherein the battery control device
acquires, by detection or calculation, a battery inlet temperature which is a temperature of the refrigerant introduced into the solid-state battery, and a battery outlet temperature which is a temperature of the refrigerant discharged from the solid-state battery,
calculates the heat absorption amount of the refrigerant from the solid-state battery based on the battery inlet temperature, the battery outlet temperature, a mass flow rate of the refrigerant, and a specific heat of the refrigerant,
acquires, by detection or calculation, a heat-exhausting device inlet temperature which is a temperature of the refrigerant introduced into the heat-exhausting device, and a heat-exhausting device outlet temperature which is a temperature of the refrigerant discharged from the heat-exhausting device,
calculates the heat exhaust amount of the refrigerant in the heat-exhausting device based on the heat-exhausting device inlet temperature, the heat-exhausting device outlet temperature, the mass flow rate of the refrigerant, and the specific heat of the refrigerant,
acquires, by detection or calculation, a heat-generating component inlet temperature which is a temperature of the refrigerant introduced into the heat-generating component, and a heat-generating component outlet temperature which is a temperature of the refrigerant discharged from the heat-generating component, and
calculates the heat absorption amount of the refrigerant from the heat-generating component based on the heat-generating component inlet temperature, the heat-generating component outlet temperature, the mass flow rate of the refrigerant, and the specific heat of the refrigerant.
